(19) United States
(12) Patent Application Publication
(10) Pub. No.: US 2018/0014476 A1
(43) Pub. Date: Jan. 18, 2018

(54) REDUCING WATER EVAPORATION AND ENHANCING PLANT GROWTH USING A HYDROPHBIC CAPILLARY LAYER FORMED WITH HYDROPHOBIC SOIL

(71) Applicant: Dinesh O. SHAH, Gainesville, FL (US)

(72) Inventor: Dinesh O. SHAH, Gainesville, FL (US)

(21) Appl. No.: 15/548,367

(22) PCT Filed: Feb. 3, 2016
(86) PCT No.: PCT/US16/16465

§ 371 Date: Aug. 2, 2017

Related U.S. Application Data
(60) Provisional application No. 62/112,100, filed on Feb. 4, 2015.

(51) Int. Cl. A01G 25/00; C09K 17/46

(52) U.S. Cl. CPC A01G 25/00; C09K 17/46; A01G 2025/003

(57) ABSTRACT

Techniques for reducing water evaporation from soil and other fresh water mediums, such as open bodies of water are provided that include forming a hydrophobic capillary layer thereon. The hydrophobic capillary layer includes a plurality of hydrophobic capillaries configured to push or otherwise direct water provided in the soil or the fresh water medium downward or back into the soil or the fresh water medium while allowing water vapor, oxygen and other gases to pass. This increases the diffusion resistance for the water molecules to pass through the hydrophobic capillary layer and thereby reduces the rate of evaporation of water from the underlying soil or fresh water medium. In an aspect, the hydrophobic capillary layer is formed via soil particles respectively coated with a hydrophobic coating. The reduction to water evaporation from a soil layer covered with the hydrophobic capillary layer results in an increased amount of water retention in the soil layer, which in turn enhances plant growth while conserving water.

### RELATED APPLICATION

This application claims priority to U.S. Provisional Patent Application No. 62/112,100 filed on Feb. 4, 2015, and entitled “EFFECT OF TOP SOIL WETTABILITY ON WATER EVAPORATION AND PLANT GROWTH.” The entirety of the aforementioned application is incorporated by reference herein.

### TECHNICAL FIELD

This application generally relates to techniques for reducing water evaporation using a hydrophobic capillary layer and, for example, to reducing water evaporation from soil and open bodies of water by applying a hydrophobic capillary layer thereon.

### BACKGROUND

Fresh water conservation plays an important role in many facets of human life. Agriculture places some of the greatest demands on fresh water supplies around the world. For example, according to a recent geological survey, farmers in the United States use 138.92 billion of gallons of water a day for irrigation, livestock care and aquaculture. Accordingly, conservation of fresh water is vital to the sustainability of agriculture. In farming, evaporation of water from soil is the main mechanism by which a substantial fraction of water is lost from the soil. Therefore, techniques for reducing water evaporation from soil and other fresh water mediums susceptible to water evaporation due to atmospheric conditions such as sunlight, wind current, temperature and relative humidity, are highly valuable.

### BRIEF DESCRIPTION OF THE DRAWINGS

Numerous aspects, embodiments, objects and advantages of the various embodiments of the subject application will be apparent upon consideration of the following detailed description, taken in conjunction with the accompanying drawings, in which like reference characters refer to like parts throughout, and in which:

FIG. 1 presents an example system that facilitates reducing water evaporation from soil in accordance with various aspects and embodiments described herein.

FIG. 2 provides a pictorial demonstration of capillary action associated with hydrophilic capillaries and hydrophobic capillaries as applicable to various aspects and embodiments of the technique for reducing water evaporation described herein.

FIG. 3 provides a comparison of water retention in a system employing a hydrophobic capillary layer over hydrophilic soil with water retention in a conventional system including hydrophilic soil without having a hydrophobic layer formed thereon, in accordance with various aspects and embodiments described herein.

FIG. 4 presents a table including theoretical values for flux of water vapor through hydrophobic capillary layers of different thicknesses formed over saturated hydrophilic soil in accordance with various aspects and embodiments described herein.

FIG. 5 presents an example of chemical structures of normal soil and normal soil coated with a surfactant in accordance with aspects and embodiments described herein.

FIG. 6 presents an example agriculture system employing a hydrophobic capillary layer to facilitate water retention in soil in accordance with various aspects and embodiments described herein.

FIGS. 7 and 8 presents another example agriculture system employing a hydrophobic capillary layer to facilitate water retention in soil in accordance with various aspects and embodiments described herein.

FIG. 9 presents another example agriculture system employing a hydrophobic capillary layer to facilitate water retention in soil in accordance with various aspects and embodiments described herein.

FIG. 10 presents an example irrigation device, for example a funnel with a perforated stem, in accordance with various aspects and embodiments described herein.

FIG. 11 presents another example agriculture system employing a hydrophobic capillary layer to facilitate water retention in soil in accordance with various aspects and embodiments described herein.

FIG. 12 presents another example agriculture system employing a hydrophobic capillary layer to facilitate water retention in soil in accordance with various aspects and embodiments described herein.

FIG. 13 presents another example agriculture system employing a hydrophobic capillary layer to facilitate water retention in soil in accordance with various aspects and embodiments described herein.

FIG. 14-17 respectively present different configurations for agriculture systems that include two or more plants, a hydrophobic capillary layer, and an irrigation device, in accordance with various aspects and embodiments described herein.

FIG. 18 presents another example agriculture system employing a hydrophobic capillary layer to facilitate water retention in soil in accordance with various aspects and embodiments described herein.

FIG. 19 presents is an example system that facilitates reducing the rate of evaporation of water from an open body of water in accordance with various aspects and embodiments described herein.

FIG. 20 presents an example hydrophobic capillary layer sheet in accordance with one or more embodiments described herein.

FIG. 21 presents a pictorial representation of a first experiment designed to measure the effect of hydrophobic soil layer thickness on water loss from hydrophilic soil in accordance with one or more embodiments described herein.

FIG. 22 provides a graph summarizing the effect of hydrophobic soil layer thickness on water loss from hydrophilic soil in accordance with the first experiment.

FIG. 23 presents a pictorial representation of a second experiment designed to measure the effect of hydrophobic soil layer coverage on water loss from hydrophilic soil in accordance with one or more embodiments described herein.

FIG. 24 provides a graph summarizing the effect of hydrophobic soil layer coverage on water loss from hydrophilic soil in accordance with the second experiment.

FIG. 25 provides a table summarizing the effect of hydrophobic soil layer coverage on water loss from hydrophilic soil in accordance with the second experiment

FIG. 26 presents a pictorial representation of a third experiment designed to measure the effect of hydrophobic soil layer coverage on plant growth in accordance with one or more embodiments described herein.

FIG. 27 provides a table summarizing the effect of hydrophobic soil layer coverage on plant growth in accordance with the third experiment.

FIG. 28 provides another table summarizing the effect of hydrophobic soil layer coverage on plant growth in accordance with the third experiment.

FIG. 29 presents a flow diagram of an example method for reducing the rate of water evaporation from soil using a hydrophobic capillary layer in accordance with one or more embodiments described herein.

FIG. 30 presents a flow diagram of another example method for reducing the rate of water evaporation from soil using a hydrophobic capillary layer in accordance with one or more embodiments described herein.

FIG. 31 presents a flow diagram of another example method for reducing the rate of water evaporation from soil using a hydrophobic capillary layer in accordance with one or more embodiments described herein.

FIG. 32 presents a flow diagram of an example method for enhancing plant growth using a hydrophobic capillary layer in accordance with one or more embodiments described herein.

FIG. 33 presents a flow diagram of another example method for enhancing plant growth using a hydrophobic capillary layer in accordance with one or more embodiments described herein.

FIG. 34 presents a flow diagram of an example method for reducing the rate of water evaporation from open bodies of water using a hydrophobic capillary layer in accordance with one or more embodiments described herein.

### DETAILED DESCRIPTION

The various embodiments are described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details. In other instances, well-known structures and components are shown in block diagram form in order to facilitate describing the various embodiments.

By way of introduction, the subject matter described in this disclosure provides techniques for reducing water evaporation from soil and other fresh water mediums, such as open bodies of water, by forming a hydrophobic capillary layer thereon. The hydrophobic capillary layer includes a plurality of hydrophobic capillaries configured to push or otherwise direct water provided in the soil or the fresh water medium downward or back into the soil or the fresh water medium while allowing water vapor, oxygen and other gases to pass. This increases the diffusion resistance for the water molecules to pass through the hydrophobic capillary layer and thereby reduces the rate of evaporation of water from the underlying soil or fresh water medium.

In general, agricultural soil surfaces being hydrophilic in nature get easily wetted by water. A substantial amount of moisture loss from soil occurs by evaporation of moisture from soil through capillary action. For example, a layer of hydrophilic soil includes a plurality of hydrophilic capillaries or channels formed therein due to the natural geometry of the soil particles. The water in hydrophilic soil moves upward through the hydrophilic capillaries as liquid water and reaches to the top of soil through capillary action. Thereafter, the water evaporates due to temperature, humidity, sunlight, and/or wind velocity. Capillary action is related to the surface tension of the air/water interface, wettability of the capillary surface, and contact angle of the capillary surface. The capillary action in soil is similar to the capillary action that happens when a glass capillary is placed in a beaker of water. The water ‘climbs’ up the glass capillary to a higher level than that outside the capillary. When a Plexiglas™ or any other hydrophobic capillary is placed in water, the water is pushed downward. For example, liquid water is not pulled upward through hydrophobic capillaries but rather pushed downward in a reverse direction from the air/water interface. Liquid water cannot go through hydrophobic channels, only water vapor molecules can go through such capillaries.

In various embodiments, in order to enhance retention of water in soil, a hydrophobic capillary layer is formed on the soil. The hydrophobic capillary layer increases the diffusion resistance for liquid water molecules to pass from the hydrophilic soil through the hydrophobic capillary layer, thereby reducing the rate of evaporation of water from the hydrophilic soil. In some implementations, the hydrophobic capillary layer includes a layer of hydrophobic topsoil formed on the soil. The hydrophobic topsoil can include a plurality of hydrophobic particles that when combined (e.g., either in a loose/unbound state or in a bound state) form a plurality of hydrophobic capillaries. The hydrophobic particles can include natural and/or synthetic particles. For example, in one embodiment, the hydrophobic particles include soil particles that are respectively coated with a hydrophobic coating. The soil particles can vary in type and physical properties. For example, the soil particles can include but are not limited to, course sand, fine sand, silt, and/or clay. In another embodiment, the hydrophobic particles can include cellulose based particles (e.g., wood particles, paper particles, etc.) respectively coated with a hydrophobic coating. In another embodiment, the hydrophobic particles can include particles formed via a synthetic polymer based material such as plastic or rubber (e.g., polystyrene, polytetrafluoroethylene (PTFE), polymethyl methacrylate PMMA, nylon, polyethylene terephthalate (PET), etc.). In accordance with this embodiment, a hydrophobic coating over the hydrophobic particles is not needed when the material employed to form the hydrophobic particles is naturally hydrophobic. In another embodiment, the hydrophobic particles can include natural or synthetic fibers (e.g., wool, silk, cotton, flax, jute, asbestos, glass fibre, nylon, polyester acrylic, etc.) woven into a textile or fabric. When the fibers employed are not naturally hydrophobic, the woven textile or fabric can be coated with a hydrophobic coating.

The hydrophobic coating can include various types of chemicals and compounds that facilitate formation of a thin homogenous hydrophobic layer on the respective particles (e.g., soil particles, cellulose based particles, and/or textile fibers). In one aspect, the hydrophobic coating includes an organosilane based compound. In other aspects, the hydrophobic coating includes a biodegradable compound configured to biodegrade within a defined period of time (e.g., two weeks, three weeks, six weeks, twelve weeks, sixteen weeks, etc.).

The hydrophobic particles can be dispersed or deposited onto the soil (with or without packing) to form a layer of a suitable thickness (e.g., about 3 millimeters (mm) to about 30 mm) that covers or substantially cover the soil to form a hydrophobic capillary layer on the soil. The rate of evaporation of liquid water from soil over which the hydrophobic capillary layer is applied can be controlled based on the thickness of the hydrophobic capillary layer, wherein the rate is decreased as the thickness is increased. The rate of evaporation can also be controlled based on a diameter of the respective hydrophobic particles, wherein the rate is decreased as the diameter is decreased.

The hydrophobic particles can have a geometry that facilitates the natural formation of open spaces or channels between respective surfaces of adjacent particles when deposited or formed as a layer of stacked or combined particles. These spaces or channels respectively establish hydrophobic capillaries. For example, hydrophobic particles including soil particles respectively coated with a hydrophobic coating can respectively have an irregular and non-uniform three-dimensional geometric shape. When the hydrophobic soil particles are loosely dispersed onto a layer of natural soil to a thickness greater than or equal to about 3.0 mm, the irregular, three-dimensional, hydrophobic soil particles create a non-uniform mesh of hydrophobic channels or capillaries formed between surfaces of adjacent hydrophobic soil particles.

In some, embodiments, rather than spreading a layer of hydrophobic particles (e.g., particles coated with a homogenous hydrophobic coating) over natural soil, a hydrophobic capillary layer can be formed on the natural soil by means of spraying or otherwise applying a liquid surfactant (also referred to as a de-wetting agent) onto the natural soil. The liquid surfactant can include various suitable chemical compounds including bi-functional molecules with a polar group and a hydrocarbon chain, wherein the polar group is configured to attach to a surface of a hydrophilic particle, such as a natural soil particle, via physical adsorption or chemisorption. For example, when such surfactant molecules contact a hydrophilic particle, the polar groups attach to the surface of the hydrophilic particle and the hydrocarbon chain extends away from the surface of the hydrophilic particle, thereby forming a hydrophobic coating or monolayer on the surface of the hydrophilic particle. In one embodiment, the liquid surfactant includes an organosilane based compound. In another embodiment, the liquid surfactant includes a biodegradable compound. For example, the liquid surfactant compound can be modulated to biodegrade after a defined period (e.g., two to sixteen weeks) under natural conditions of temperature, humidity and sunlight and microorganisms in the soil. This approach will regenerate the soil surface to its original condition after passage of the defined period of time.

When such a liquid surfactant is applied to the surface of normal, hydrophilic soil, the liquid surfactant seeps into the soil and attaches to respective surfaces of the soil particles via physical adsorption or chemisorption coats respective surfaces of the soil particles with a hydrophobic coating when dried. The coated soil particles form a hydrophobic capillary layer over the underlying non-coated particles in a same or similar manner as the aforementioned dispersed/deposited layer of hydrophobic particles. The amount of liquid surfactant applied can vary to reach soil particles at a desired depth below the soil/air interface, thereby controlling the resulting thickness of the hydrophobic capillary layer formed via the coated particles.

Formation of a hydrophobic capillary layer as described herein on a layer of hydrophilic soil substantially reduces the rate of evaporation of liquid water included in the hydrophilic soil. Due to the increased conservation of water within the hydrophilic subsoil, a significantly less amount of water is required for application to the hydrophilic subsoil to facilitate growth of plants planted within the hydrophilic subsoil. For example, an experiment, described in greater detail infra, involving the application of a 2.0 centimeter (cm) thick hydrophobic capillary layer to normal wetted soil demonstrated 90% water retention after 84 hours of exposure to ambient atmospheric conditions. The hydrophobic capillary layer was formed with soil particles respectively coated with an organosilane based hydrophobic coating compound.

The promotion of plant growth by this approach was also confirmed by another experiment, also discussed in greater detail infra, that involved growing chick pea plants (i.e., cicer arietinum plants) planted in normal soil covered with a hydrophobic capillary layer formed via soil particles respectively coated with the organosilane based hydrophobic coating compound. The study found that the length of roots, height of shoots, number of branches, number of leaves, number of secondary roots, biomass etc. was significantly increased upon covering the surface of hydrophilic soil with the hydrophobic topsoil in comparison to uncovered ordinary hydrophilic soil of identical depth. Similar experiments conducted with corn plants also demonstrated similar enhanced plant growth based on usage of the hydrophobic topsoil. Such approach can also decrease the water consumption by the plants particularly grown indoors in residential premises, green houses, poly-houses etc., and also can be very useful to prevent water loss and enhance growth of vegetation in semi-arid regions.

In various additional embodiments, agriculture systems are provided with improved plant growth via usage of the aforementioned hydrophobic capillary layers to increase water retention in soil. In some embodiments, seeds or plants are planted within a layer of normal or hydrophilic subsoil which is further covered with a layer of hydrophobic topsoil. In one implementation, the hydrophobic topsoil can include a plurality of hydrophobic particles that are deposited onto the hydrophilic subsoil. Alternatively, the hydrophobic topsoil can be formed via application of a liquid surfactant to the surface of the hydrophilic subsoil. In one implementation, a biodegradable surfactant can be employed to coat hydrophilic soil particles of the topsoil such that the topsoil is returned to its natural hydrophilic state after biodegradation of the coating. For example, the biodegradable compound can be configured to biodegrade within a defined period of time (e.g., about two weeks to about sixteen weeks).

In certain implementations, in order to facilitate absorption of water into the hydrophilic subsoil, portions of the hydrophilic subsoil can be left uncovered by the hydrophobic topsoil. For example, a region of the subsoil located directly above the seed or around the base of the plant can be left uncovered by the hydrophobic topsoil. This technique also facilitates germination of certain plants that may be unable to sprout through the hydrophobic topsoil. In other implementations, in order to facilitate absorption of water into the hydrophilic subsoil, an irrigation device can be employed that provides water directly to the hydrophilic subsoil. For example, a funnel or other suitable device can be inserted through the hydrophobic topsoil that extends into the hydrophilic subsoil. The funnel or irrigation device is configured such that when water is poured through the funnel or otherwise transferred to the irrigation device, the water goes directly into the hydrophilic subsoil. According to this implementation, the hydrophobic topsoil layer does not pose a barrier for water transport to the seed or plant roots located within the hydrophilic subsoil. In an aspect, a plurality of holes can be provided in the narrow passage of the funnel or irrigation device to facilitate efficient radial distribution of the water. The subject technique is especially suited to facilitate plant growth of potted plants, in-door plants, or green house plants.

In another implementation, the seeds or plants can be planted on a terrain formed of substantially hydrophilic soil and having a non-planar surface topology with regions of high ground separated by regions of low ground having a lower altitude than the regions of high ground. For example, the terrain can have a wavelike topography with peaks and valleys or crests and troughs. In another example, the terrain can include areas of high ground separated by drainage ditches. The seeds or plants can be planted within the hydrophilic soil at or near the regions of high ground and one or more water collection and irrigation devices can be provided at or near the regions of low ground. Hydrophobic topsoil can be employed to cover at least portions of the terrain to facilitate water retention by hydrophilic soil. For example, hydrophobic topsoil can be deposited or formed on the entire top surface of the terrain. In another example, hydrophobic topsoil can be deposited or formed on the high ground regions of the terrain at or near regions where a seed or plant is located. In some implementations, a thickness of the hydrophobic topsoil can taper in a direction away from the location of the seed or plant. For example, the thickness of the hydrophobic topsoil can taper as the altitude of the terrain decreases toward a valley or trough region of the terrain.

The water collection/irrigation devices can be configured to provide water (e.g., run-off water, sprinkler water, rain water, dew, condensation, etc.) to the hydrophilic subsoil located beneath the hydrophobic topsoil. For example, the water collection/irrigation devices can include a funnel that extends into the hydrophilic subsoil. The funnel can include a perforated neck for enhanced radial distribution of the water into the subsoil. In one implementation, the terrain can include at least four regions of high ground respectively arranged in a substantially rectangular configuration (e.g., a square) which respectively slope downward to a region of low ground at or near the center point of the rectangular configuration. Plants can be planted at or near the four regions of high ground (e.g., at or near the four corners of the square) and a water collection device (e.g., a funnel) can be located at or near the center point of the rectangular configuration. The water collection device can be configured to collect run-off water that naturally flows therein from the regions of high ground to the region of low ground due to gravitational force. The water collection device can further distribute the collected water in radial directions to roots of the plants located in the hydrophilic subsoil beneath a layer of hydrophobic topsoil.

A hydrophobic capillary layer can also be employed to decrease water evaporation from open bodies of water, such as pools, reservoirs, lakes, etc. Similar to the effect on soil, when a hydrophobic capillary layer is formed at the water/air interface of a body of water, the water meniscus cannot rise through the hydrophobic channels. As a result, the rate of water evaporation at the water/air interface is reduced. In some embodiments, a layer of hydrophobic particles can be deposited onto the body of water. For example, the hydrophobic particles can include natural and/or synthetic materials that are respectively formed into particles and coated with a hydrophobic coating (e.g., soil particles, cellulose based particles, synthetic polymer based particles such as PTFE, PMMA, etc). The hydrophobic particles can be configured to float on the surface of the water and link or group together to form a plurality of hydrophobic capillaries when deposited on the surface of the water. In another embodiment, a hydrophobic capillary layer can be provided on the surface of the water that includes a sheet of a plurality of joined hydrophobic capillaries. For example, the sheet can include a textile including hydrophobic fibers that form a plurality of hydrophobic capillaries. In another example, the sheet can include a particulate board (e.g. 4 ft×8 ft) of variable thickness of hydrophobic materials with hydrophobic pores that establish hydrophobic capillaries.

In various embodiments, a hydrophobic soil is provided. The hydrophobic soil includes soil particles and hydrophobic monolayer coatings formed on respective surfaces of the soil particles. In an aspect, the hydrophobic monolayer coatings are formed on the respective surfaces of the soil particles via physical adsorption or chemisorption. In one implementation the hydrophobic monolayer coatings include an alkyl silane compound. In another implementation, the hydrophobic monolayer coatings include a biodegradable compound.

In other embodiments, a method for increasing liquid water retention by hydrophilic soil is provided. The method includes wetting the hydrophilic soil with liquid water, and forming a hydrophobic capillary layer over the hydrophilic soil. In an aspect, the hydrophobic capillary layer has a thickness between about 3.0 mm to about 30.0 mm In one implementation, the forming of the hydrophobic capillary layer includes coating respective surfaces of hydrophilic soil particles with a hydrophobic coating to form hydrophobic soil particles, and depositing the hydrophobic soil particles on the hydrophilic soil. In another implementation, the forming the hydrophobic capillary layer includes applying a solution including a surfactant onto a surface of the hydrophilic soil, and forming hydrophobic coatings on respective surfaces of soil particles included in an upper layer of the hydrophilic soil based on the applying. The method can further include exposing the hydrophilic soil and the hydrophobic capillary layer to natural conditions of temperature, humidity and sunlight, and reducing a rate of evaporation of the liquid water from the hydrophilic soil in response to the exposing based on the forming the hydrophobic capillary layer over the hydrophilic soil.

In one or more additional embodiments, an agriculture system is provided. The agriculture system includes a layer of hydrophilic subsoil, a seed or plant planted within the layer of hydrophilic subsoil, and a layer of hydrophobic topsoil formed over the layer of hydrophilic subsoil. In an aspect, a portion of the layer of hydrophilic subsoil is not covered by the layer of the hydrophobic topsoil. For example, the portion of the layer of hydrophilic subsoil that is not covered by the layer of the hydrophobic topsoil can include the seed or the plant planted therein. In some embodiments, the agriculture system also includes an irrigation device formed within the layer of hydrophobic topsoil or a region of the layer of hydrophilic subsoil not covered with the layer of hydrophobic topsoil. The irrigation device reaches the layer of hydrophilic subsoil and allows for passage of liquid water to the layer of hydrophilic subsoil. For example, the irrigation device can include a funnel.

In another embodiment, another agriculture system is provided that includes a terrain having a non-planar surface topology characterized by regions of high ground separated by regions of low ground having a lower altitude than the regions of high ground, wherein the regions of high ground and the regions of low ground are joined by sloping regions. The terrain includes a layer of hydrophilic subsoil, and a layer of hydrophobic topsoil formed over regions of the layer of hydrophilic subsoil located at or near the regions of high ground. The agriculture system further includes seeds or plants planted within the regions of the layer of hydrophilic subsoil located at or near the regions of high ground, and one or more irrigation devices located at or near the regions of low ground and configured to provide liquid water to the regions of the layer of hydrophilic subsoil located at or near the regions of high ground.

In yet another embodiment, a method for reducing water evaporation from an open body of water is provided. The method includes forming a hydrophobic capillary layer on a surface of the open body of water, the hydrophobic capillary layer comprising a plurality of hydrophobic capillaries. In one implementation, the forming of the hydrophobic capillary layer includes depositing a layer of particles on the surface of the open body of water, wherein the particles are respectively coated with a hydrophobic coating. For example, the particles can have a density less than 1.0 g/mL thereby facilitating floatation on the surface of the open body of water. In an aspect, the particles are formed via PTFE or PMMA, wherein the contact angle and the hydrophobicity of the particles make them float provided their mass is small compared to surface tension forces. In another aspect, the forming of the hydrophobic capillary layer includes applying a sheet of material including the plurality of hydrophobic capillaries on the surface of the open body of water.

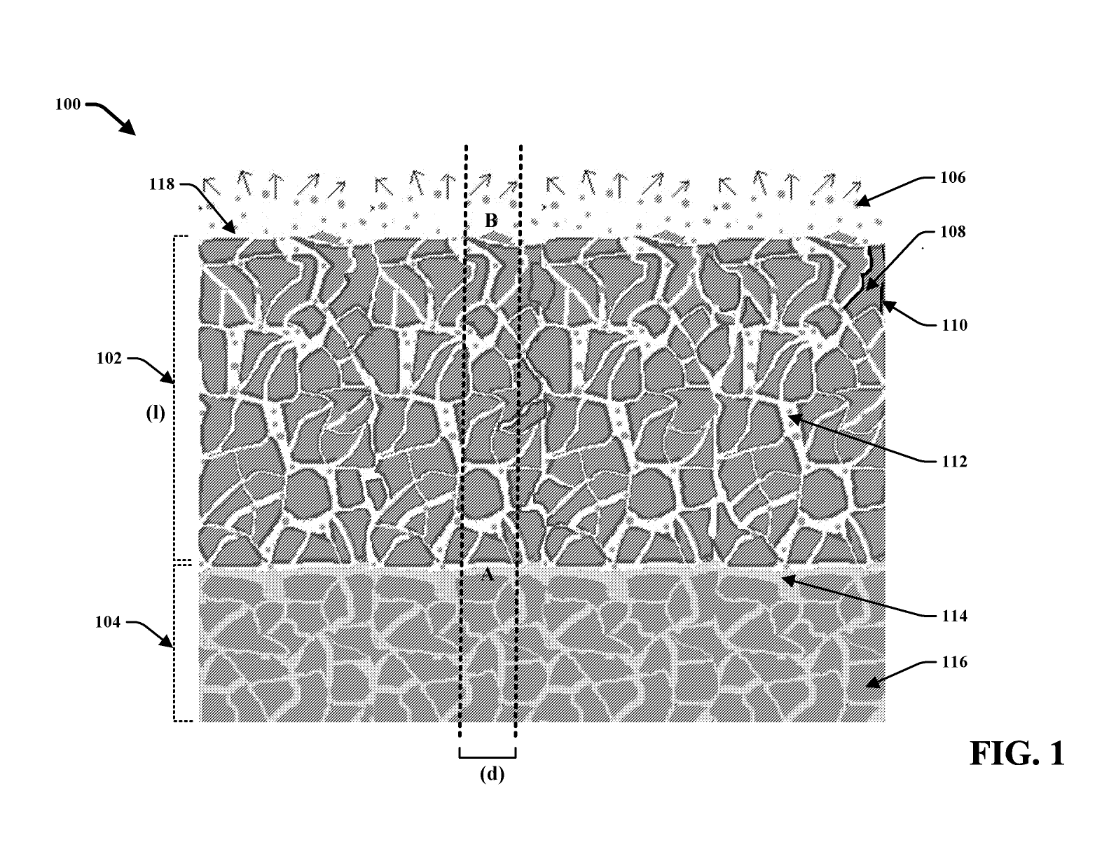

With reference now to FIG. 1, presented is an example system 100 that facilitates reducing water evaporation from soil in accordance with various aspects and embodiments described herein. System 100 includes a hydrophilic soil layer 104 with a hydrophobic capillary layer 102 formed thereon. The hydrophilic soil layer 104 includes a plurality of hydrophilic soil particles 116 that have been wetted or saturated with liquid water 114. The hydrophilic soil particles 116 include at least one of: course sand, find sand, silt or clay. The physical properties (e.g., texture, structure, porosity, density, etc.) of the hydrophilic soil layer 104 can vary so long as it is capable of holding moisture or liquid water 114. For example, the liquid water holding capacity in terms of maximum percentage of water retention by weight of the hydrophilic soil particles 116 can vary from about 5% to about 50%. In another embodiment, the hydrophilic soil particles 116 have a liquid water holding capacity from about 10% to about 45%. Still in another embodiment, the hydrophilic soil particles 116 have a liquid water holding capacity from about 20% to about 40%. In another embodiment, the liquid water holding capacity of the hydrophilic soil layer 104 is about 38%.

The hydrophobic capillary layer 102 is configured to reduce evaporation of the liquid water 114 contained within the hydrophilic soil layer 104. The hydrophobic capillary layer 102 includes a plurality of stacked particles 108 that are either formed with a hydrophilic material and coated with a hydrophobic coating 110 (depicted via the black line around the respective particles 108) or formed with a hydrophobic material. The particles 108 can include natural and/or synthetic particle materials. In an exemplary embodiment, the particles 108 include natural soil particles that have been respectively coated with a hydrophobic coating 110. The aggregate structure of the stacked, coated soil particles can establish the hydrophobic capillary layer 102. Hydrophobic capillaries 112 are formed in the hydrophobic capillary layer 102 via the open spaces or pores (depicted in white) established between surfaces of neighboring particles 108. The hydrophobic capillaries 112 are configured to push or otherwise direct the liquid water 114 provided in the hydrophilic soil layer 104 downward or back into the soil. The hydrophobic capillaries 112 are only permeable to water vapor molecules 106 and other gases (e.g., nitrogen, carbon dioxide). However, the hydrophobic capillaries 112 are only impermeable to liquid water. Accordingly, the liquid water 114 included in the hydrophilic soil layer 104 cannot pass through the hydrophobic capillary layer 102. As a result, the diffusion resistance for the water molecules to pass through the hydrophobic capillary layer 102 is increased.

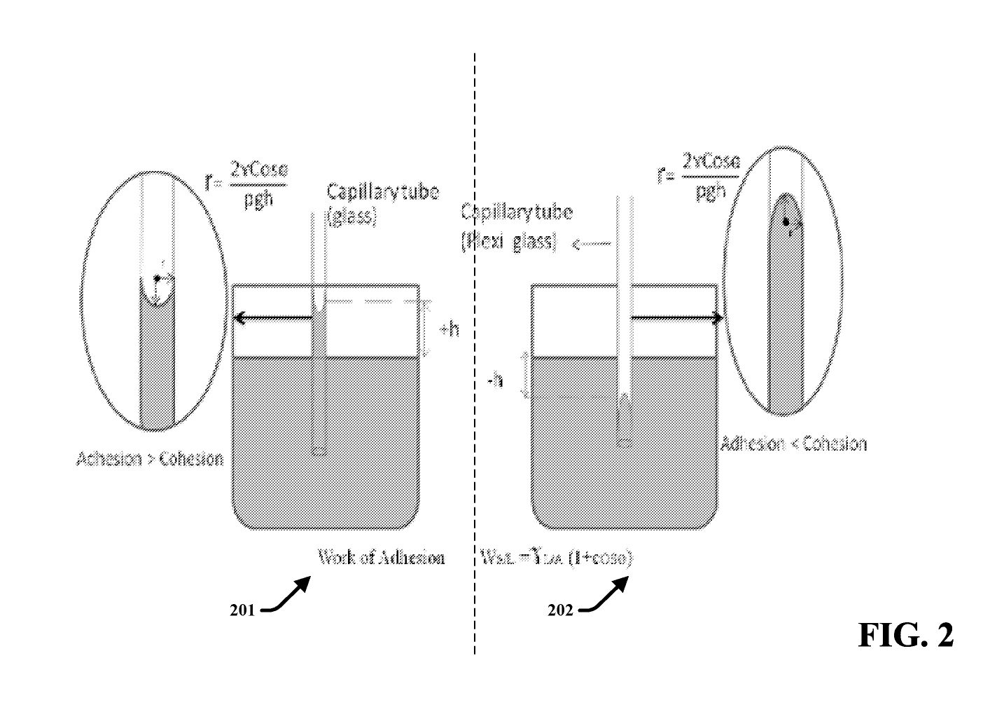

FIG. 2 provides a pictorial demonstration of capillary action associated with hydrophilic capillaries and hydrophobic capillaries as applicable to various aspects and embodiments of the techniques for reducing water evaporation described herein. In general, capillary action is related to the surface tension of the air/water interface, wettability of the capillary surface, and contact angle of the capillary surface. The capillary action in hydrophilic soil, such as hydrophilic soil layer 104, is similar to the capillary action that happens when a glass capillary is placed in a beaker of water, as demonstrated in system 201. As shown in system 201, when a glass capillary tube is placed in a beaker of water, the water ‘climbs’ up the glass capillary tube to a higher level than that outside the capillary tube. As a result, the water within the capillary tube at the air/water interface forms a concave shape. However, as demonstrated in system 202, when a capillary tube formed with PMMA (e.g., Plexiglas™) or another hydrophobic material is placed in water, the water is pushed downward. As a result, in this case, the water within the hydrophobic capillary tube at the air/water interface forms a convex shape.

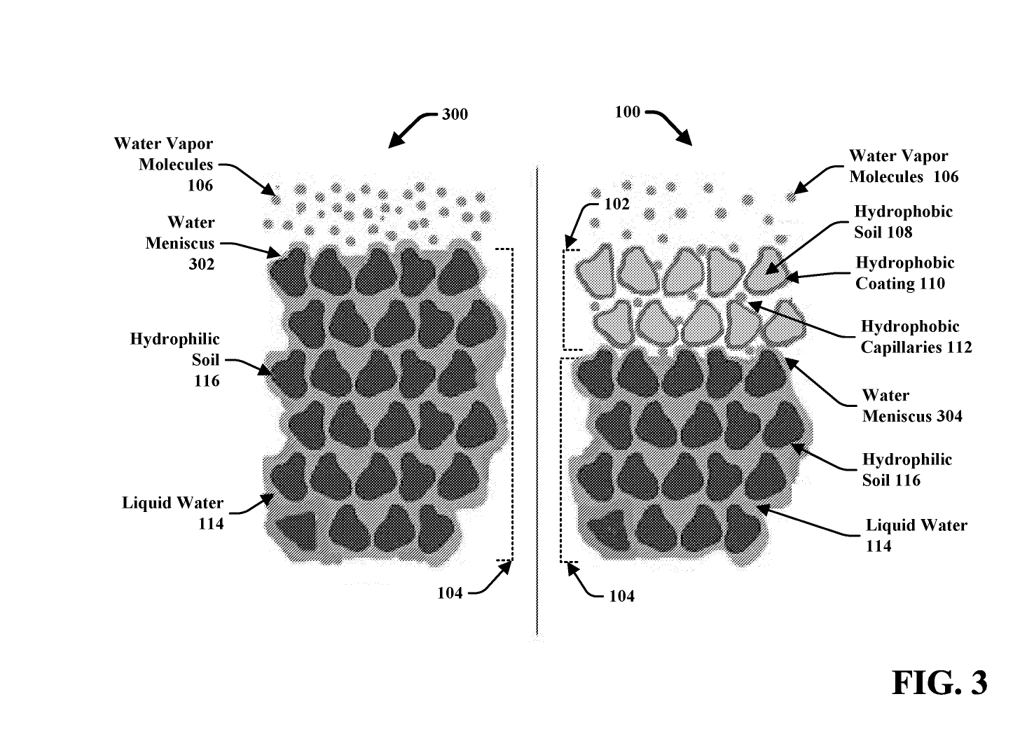

FIG. 3 provides a comparison of water retention in system 100 with water retention in a conventional system 300 including hydrophilic soil without having a hydrophobic layer formed thereon. Repetitive description of like elements employed in respective embodiments described herein is omitted for sake of brevity.

In the evaporation process, water in hydrophilic soil particles 116 moves upward through hydrophilic capillaries of the hydrophilic soil layer 104 as liquid water 114 and reaches to the top of hydrophilic soil layer 104 through capillary action. Thereafter, the liquid water evaporates due to temperature, humidity, sunlight, and wind velocity. As shown in system 300, the water meniscus 302 is pushed upward by the hydrophilic nature of hydrophilic soil particles 116 and thus helps the water to reach to the top surface of the hydrophilic soil layer 104. In contrast, as shown in system 100, the water meniscus 304 is pushed down when a hydrophobic capillary layer 102 is laid over the hydrophilic soil layer 104 that is wetted or saturated with liquid water 114. In the scenario depicted in system 100, water vapor molecules 106 but not liquid water, can go through hydrophobic capillaries 112. This increases the diffusion resistance for the water vapor molecules 106 to pass through the hydrophobic capillary layer 102, thereby reducing the rate of water evaporation from the hydrophilic soil layer 104.

Referring back to FIG. 1, the reduction in evaporation of water vapor molecules 106 from the hydrophilic soil layer 104 based on diffusion resistance created by the hydrophobic capillary layer 102 is theoretically supported by diffusion theory as described below with reference to Equation 1 below. Equation 1 has been scientifically applied to describe the flux (N_{A}) of water vapor molecules through a straight capillary when placed into water at a perpendicular angle relative to the water surface, wherein the capillary has a length (l) and diameter (d).

$${N}_{A} = \frac{{D}_{A , B} * {P}_{t}}{R * T * z * {P}_{B , M}} * ( {p}_{A} - {p}_{B} ) \qquad ( Equ . \text{-} 1 )$$

With Equation 1, N_{A} is moles of water vapor reaching from point A, the first opening of the capillary length located at the capillary/water interface, to point B, the second opening of the capillary length. Equation 1 can be applied to system 100 to estimate the flux of water vapor molecules reaching from point A to point B by assuming that the respective hydrophobic capillaries 112 in hydrophobic capillary layer 102 are cylindrical with diameter (d), and length (l), which should be substantially larger than the diameter of water molecules. In accordance with application of Equation 1 to system 100, the other terms are explained as follows:
D_{A,B}=diffusivity of water vapour=2.58*10⁻⁵ (m²/s),
Pₜ=system pressure which is atmospheric pressure=101325 (N/m²),
p_{A}=partial pressure of water vapor at the lowest point of the hydrophobic soil =3167.730 (N/m²),
p_{B}=partial pressure of water vapour in atmosphere or just above the hydrophobic layer=0.0, (i.e. constant (N/m²)),
R=Gas Constant=8314 (N.m/Kmol.K),
T=System temperature=298 K,
Z=Distance to be travelled by the water vapor=0.001 (m), which is taken as 1.00 mm to 100 mm,
P_{B,M}=p_{B2}−p_{B1}/1n (p_{B2}/p_{B1})=99929.4200, and
p_{B2}=Pₜ−p_{B} and p_{B1}=Pₜ−p_{A}.

Steady state diffusion of water molecules from point A at the interface between the hydrophilic soil layer 104 and the hydrophobic capillary layer 102 to point B at the interface between hydrophobic capillary layer 102 and the air is described by Equation 1. Point A is the location where the liquid water 114 of the hydrophilic soil layer 104 ejects water vapor molecules 106 into the hydrophobic capillary layer 102 (e.g., the hydrophilic soil 104/hydrophobic capillary layer 102 interface). The concentration of water vapor molecules 106 at point A will be the partial pressure p_{A} which is the vapor pressure of water at temperature (T). Point B is where the water molecules leave the hydrophobic capillary layer and enter into the free air space, at the top end of the hydrophobic capillaries 112. The concentration of water vapor molecules 106 at point B is considered to be zero (e.g., p_{B}) as molecules are removed by convective air breeze, and temperature or humidity gradients. From point B onward, the diffusion process stops and convective transport will take water vapor molecules 106 away from the hydrophobic capillary layer 102 surface. One assumption is that once the water vapor molecules 106 reach point B, the water vapor molecules 106 do no counter diffuse back through the hydrophobic capillary layer 102 and back into the hydrophilic soil layer 104. This assumption is accurate because in nature, as water vapor molecules 106 escape from the hydrophobic capillary layer 102, the water molecules are carried away by wind flow or low humidity with convective processes. When applying Equation 1 to system 100, it is also assumed that the ratio of d/λ>20, where, d is the diameter of the hydrophobic capillary, and λ is the mean free path between two successive collisions between water molecules. Under this condition, the ordinary molecular diffusion predominates.

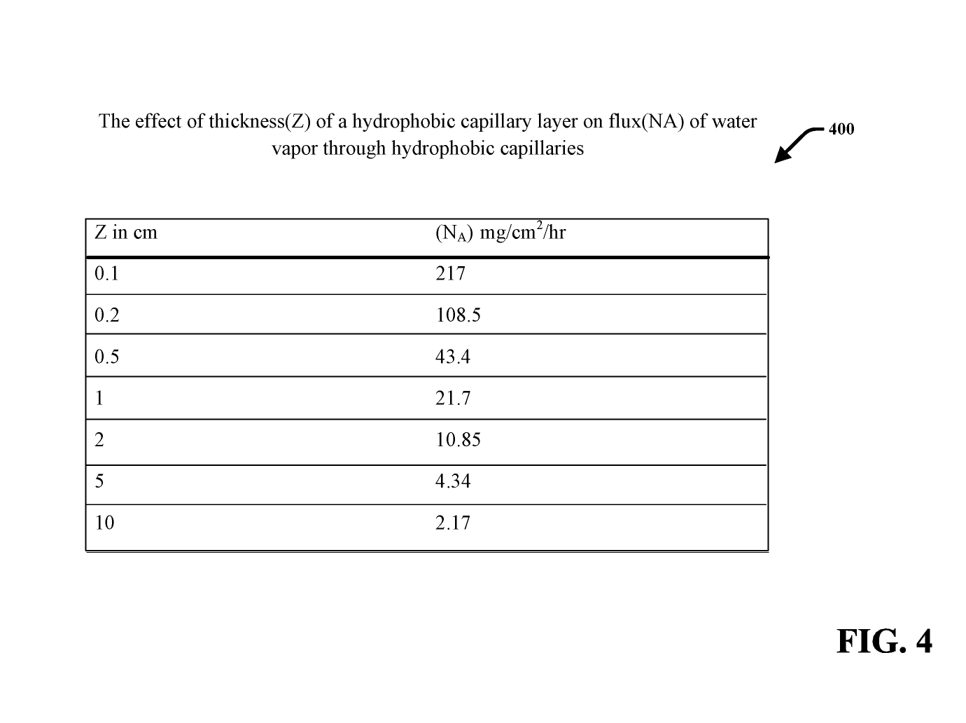

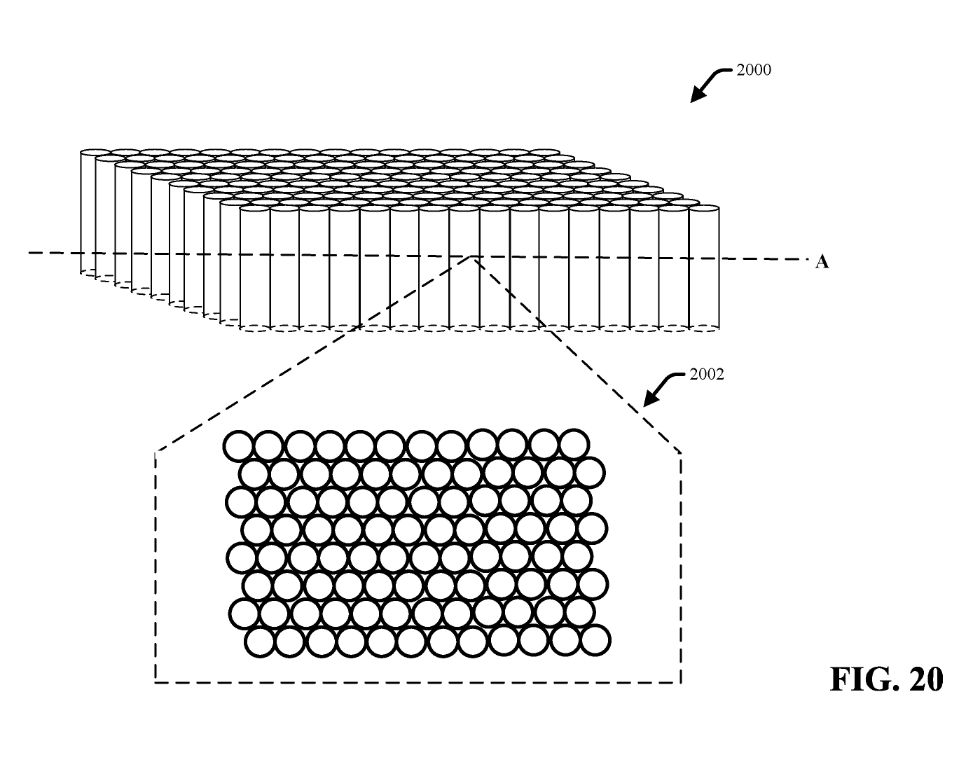

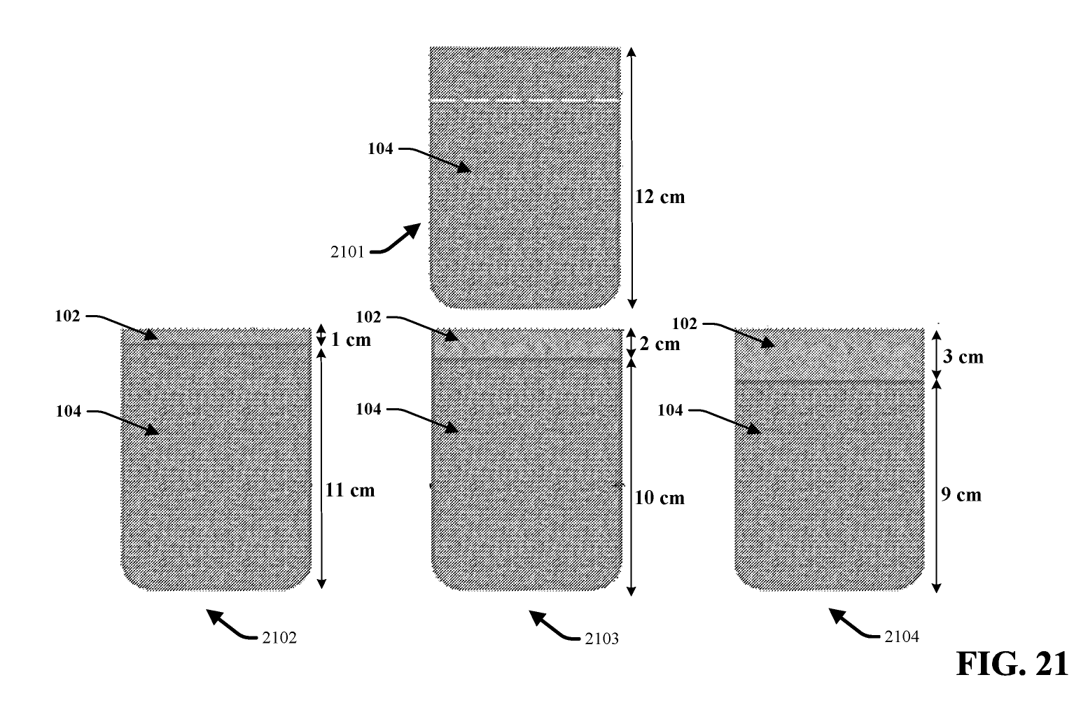

FIG. 4 presents a table 400 including the values of the flux (N_{A}) obtained theoretically for different thicknesses of the hydrophobic capillary layer when Equation 1 is applied to system 100, in accordance with the parameters and assumptions described above. In table 400, the corresponding (Z) values represent the thickness (l) of the hydrophobic capillary layer 102. The values in table 400 correlate an amount of water vapor that will evaporate from a hydrophobic capillary layer under ambient conditions (e.g., T=298 K) as a function of thickness of the hydrophobic capillary layer 102. The theoretically obtained results show a significant decrease in the rate of evaporation of water through the hydrophobic capillary layer 102 with an increase in the thickness of the layer from 0.1 cm to 10 cm. This theoretically prediction was found experimentally accurate, as described infra with reference to FIGS. 20-21.

Referring back to FIG. 1, in an exemplary embodiment, the particles 108 of the hydrophobic capillary layer 102 include a plurality of natural or hydrophilic soil particles that have been respectively coated with a hydrophobic coating 110. According to this embodiment, the hydrophobic capillary layer 102 is also referred to as hydrophobic topsoil. The soil particles can include but are not limited to, course sand, fine sand, silt, and/or clay. In one implementation, the particles 108 include about 2.0% to about 20% course sand particles, about 50% to about 90% fine sand particles, about 3% to about 25% silt particles, and about 1.0% to about 10% clay particles. In another implementation, the particles 108 include about 3.0% to about 10% course sand particles, about 60% to about 80% fine sand particles, about 5% to about 15% silt particles, and about 3.0% to about 8% clay particles. In another implementation, the particles 108 include about 3.0% course sand particles, about 75% fine sand particles, about 10% silt particles, and about 6% clay particles. In some embodiments, the pre-coated hydrophobic soil particles and the hydrophilic soil particles 116 include same physical make-up and properties.

In another embodiment, the particles 108 can include cellulose based particles (e.g., wood particles, paper particles, etc.) that have been coated with a hydrophobic coating 110. For example, the particles 108 can include small wood chips, shavings, or sawdust (e.g., having dimensions less than about 1.0 mm and more preferably less than at least about 0.5 mm). In another embodiment, the particles 108 can include a natural and/or a synthetic material (e.g., wool, silk, cotton, flax, straw, jute, glass fibre, nylon, polyester acrylic, etc.) formed into particles having dimensions less than about 1.0 mm and more preferably less than about 0.5 mm and coated with a hydrophobic coating 110. In some implementations, these particles can be woven into a textile or fabric and coated with a hydrophobic coating 110. Still in other embodiments, the particles 108 can include a mixture of soil, cellulose and/or fiber particles that have respectively been coated with a hydrophobic coating 110 and have dimensions less than about 1.0 mm and more preferably less than about 0.5 mm

In some additional embodiments, the particles 108 are formed with a hydrophobic material. According to these embodiments, the particles 108 are not coated with a hydrophobic coating 110. For example, a the particles 108 can be formed using a synthetic polymer based material that is hydrophobic, such as particles of plastic or rubber (e.g., polyethylene, polystyrene, synthetic rubbers, polyvinyl esters, polyacrylates, PTFE, PMMA, paraffin wax, organic acids, latexes (aqueous polymer dispersions), and other synthetic polymers).

The physical properties of the particles 108, such as the texture, structure, density liquid water holding capacity, particle size, etc., can vary. For example, in one implementation, the particles 108 include soil particles characterized by sandy loam texture, a bulk density of about 1.36 gm/cc and a liquid water holding capacity of about 38.51%. Soil texture refers to the composition of the soil in terms of the proportion of small, medium, and large particles (clay, silt, and sand, respectively) in a specific soil mass. For example, a coarse soil is considered to have a sand or a loamy sand texture, a medium soil is considered to have a loam texture, a silt loam texture, or a silt texture, and a fine soil is considered to have a sandy clay texture, silty clay texture, or a clay texture. Soil structure refers to the arrangement of soil particles (sand, silt, and clay) into stable units called aggregates, which give soil its structure. For example, in some embodiments, the hydrophobic capillary layer 102 can be considered an aggregate of soil particles that have been respectively coated with a hydrophobic coating 110. Aggregates can be loose and friable, or have distinct, uniform patterns. For example, a granular aggregate structure is loose and friable, and a blocky aggregate structure is six-sided and can have angled or rounded sides. In one or more embodiments, the hydrophobic capillary layer 102 has a granular structure. In other embodiments, the hydrophobic capillary layer 102 has a blocky structure.

The dimensions of the particles 108 can also very. For example, soil particles classified as clay have a diameter less than 0.002 mm while course sand particles have a diameter between about 1.00-2.00 mm The diameter of the particles 108 when formed via a material other than soil (e.g., a cellulose based material, a synthetic polymer material, a fibre, etc.) can include same or similar dimensions as natural soil particles (e.g., from about 0.001 mm to about 1.0 mm). In some embodiments, a desired evaporation rate of the underlying liquid water 114 from the hydrophilic soil layer 104 can be controlled based on size of the respective particles 108. For example, as the size of the particles 108 increases, the amount of open air space established between the hydrophobic particles when stacked also increases. Thus the dimensions of the open channels or hydrophobic capillaries 112 increase as the dimensions of the particles 108 increase, thereby allowing a greater amount of water vapor molecules to pass through at a faster rate. Accordingly, the evaporation rate can be decreased as the size or diameter of the particles 108 is decreased. Therefore, the particles 108 preferably have dimensions (e.g., diameter, height, length, width, etc.) less than about 1.0 mm, and more preferably less than bout 0.5 mm

The particles 108 can have a geometry that facilitates the formation of hydrophobic capillaries 112 between neighboring surfaces of adjacent particles 108. For example, soil particles respectively coated with a hydrophobic coating can respectively have an irregular and non-uniform three-dimensional geometric shape (e.g., the particles 108 depicted in system 100). Similar to the manner in which stacked natural soil particles for porous aggregate structures (e.g., hydrophilic soil layer 104), when the hydrophobic soil particles are loosely dispersed (with or without packing) at a thickness of about 3.0 mm to about 30.0 mm onto a layer of natural soil, the irregular, three-dimensional, hydrophobic soil particles create a non-uniform mesh of hydrophobic channels or capillaries (e.g., hydrophobic capillaries 112) formed between surfaces of adjacent hydrophobic soil particles, as depicted in the hydrophobic capillary layer 102 of system 100. In some implementations, the dimensions (e.g., average diameter) and tortuosity of the hydrophobic capillaries 112 can be controlled based on selection of the size and texture of the soil particles used as the particles 108. For example, smaller soil particles are associated with smaller pores or capillaries and capillaries having a greater tortuosity than larger particles. As the tortuosity and dimensions of the hydrophobic capillaries 112 decreases, the rate at which water vapor molecules 106 can pass through the hydrophobic capillaries 112 is also decreased (e.g., due to the increased resistance associated with the smaller air space and high tortuosity of the hydrophobic capillaries). Accordingly, smaller particles (e.g., less than about 1.0 mm) can be employed for the particles 108 of the hydrophobic capillary layer 102 to decrease the dimensions of the hydrophobic capillaries and increase the tortousity of the hydrophobic capillaries, thereby resulting in a decrease in the rate of water evaporation from the hydrophilic soil layer 104.

In another implementation, the particles 108 can be manufactured to have a defined shape that facilitates the formation of highly tortuous and narrow hydrophobic capillaries 112 when combined. For example, soil, cellulose, fiber, and/or synthetic polymer based particles can be processed into a defined uniform or irregular three-dimensional geometric shape that forces the particles to stack and form hydrophobic channels there between when loosely dispersed or compressed. For example, the particles 108 can be processed into three-dimensional blocks (e.g., a rectangular prism or a square prism) with projections (e.g. pegs or small cone shaped pieces) that project from respective surfaces of the blocks (e.g., similar to the game pieces of the game referred to as Jacks or Knucklebones). The pegs or cone shaped pieces can inhibit respective surfaces of the blocks from aligning and lying flush with one another when loosely dispersed as stacked layer of blocks. As a result, channels will be established between adjacent (non-touching) surfaces of the blocks. In another example, a plurality of hydrophobic particles can be formed into small hollow tubes and respectively combined via their side surfaces such that the open ends of the respective tubes are exposed to form a thin uniform sheet of hydrophobic capillaries. Still in other embodiments, after the particles 108 are coated and deposited, an imprinting tool having spikes or needlelike projections (e.g., having a diameter less than about 1.0 mm) can be pressed onto the surface of the particles 108 to form cylindrical capillaries within the hydrophobic particles when removed. In yet another embodiment, the texture of the hydrophobic capillary layer 102 can be adapted to decrease the diameters of the hydrophobic capillaries 112 and/or increase the tortuosity of the hydrophobic capillaries 112 via application of an aqueous chemical solution to the hydrophobic capillary layer 102 that promotes precipitation or crystallization of the particles 108.

When the particles 108 are formed with a hydrophilic material (e.g., natural soil particles, cellulose based particles, and other natural or synthetic hydrophilic material), the particles 108 are made hydrophobic or substantially hydrophobic via coating the surfaces of the respective particles 108 with a hydrophobic coating 110. The hydrophobic coating 110 can include various types of chemicals and compounds that facilitate formation of a thin homogenous hydrophobic (i.e., water repelling) layer on a hydrophilic particle. In various implementations, the hydrophobic coating 110 is formed using a surfactant or de-wetting agent. The surfactant can include a suitable chemical compound including molecules having polar groups and one or more hydrocarbon chains, wherein the polar groups are configured to attach to surfaces of hydrophilic particles, such as natural soil particles, by physical adsorption or chemisorption with the hydrocarbon chains extending outward or away from the surfaces, thereby forming a hydrophobic monolayer or coating on the particle surfaces. In one embodiment, the hydrophobic coating 110 includes a silane based compound which reacts with the silica surface of hydrophilic soil, such as a commercially available organosilane compound known as Zycosil™.

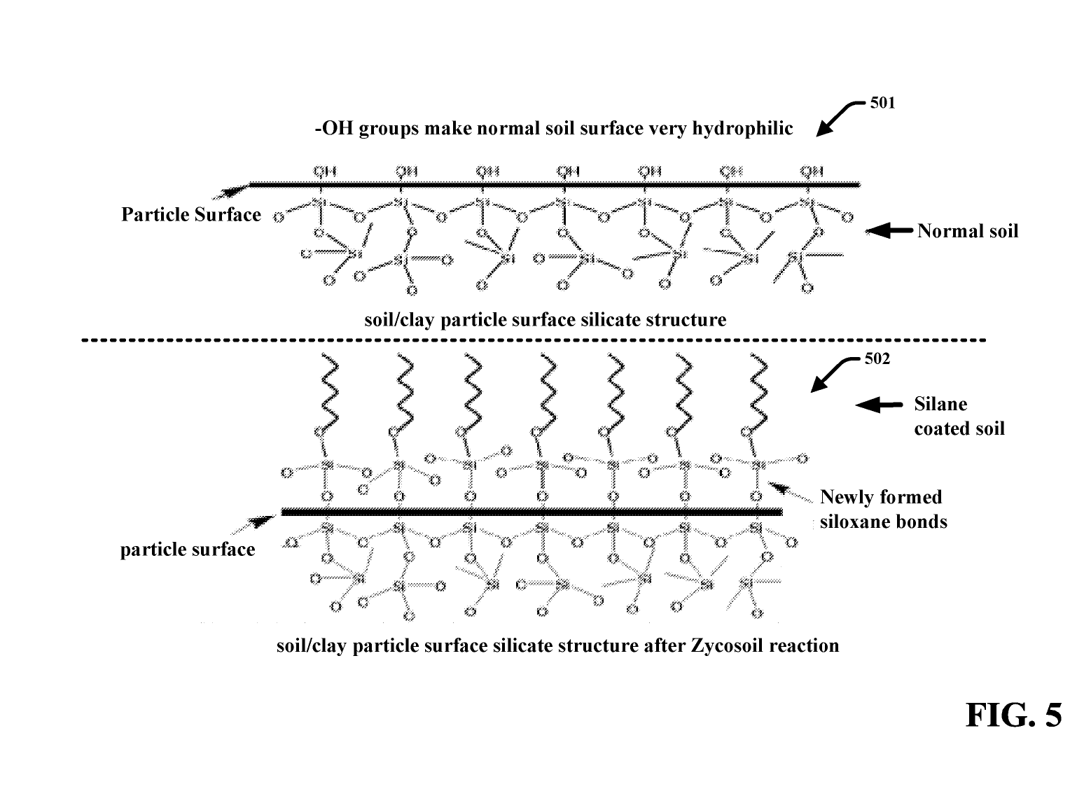

FIG. 5 presents example chemical structures of normal soil 501 and hydrophobic soil 502 in accordance with various aspects and embodiments described herein. The hydrophobic soil 502 was formed via application of a solution including a surfactant to normal soil 501 including silicate particles. The surfactant employed to form the hydrophobic soil 502 included a silane based compound (e.g., Zycosil™). As shown in FIG. 5, the silicate particle surfaces of normal soil 501 include ⁻OH groups which make the normal soil particles hydrophilic. However, when normal soil 501 is treated with a dilute organosilane solution (e.g., a solution including silane based surfactant such as Zycosil™) the normal soil 501 is transformed into hydrophobic soil 502. In particular, the polar groups of the surfactant molecules react with the ⁻OH groups at the normal soil surface to attach to the particle surface (e.g., via formation of siloxane bonds) with the alkyl groups of the surfactant molecules facing the air phase of the soil/air interface, thereby forming a hydrophobic monolayer on the soil particle surface. Thus the surface chemistry of the silicate particles gets reversed and the normal soil 501 is transformed into hydrophobic soil 502. As a result when water is poured on the dry treated hydrophobic soil 502 surface, the water will bead up.

Referring back to FIG. 1, in various additional embodiments, the hydrophobic coating 110 (or the particles 108 alone), includes a superhydrophobic coating material, such as but not limited to: a zinc oxide polystyrene (ZnO/PS) nano-composite, precipitated calcium carbonate, carbon nano-tube structures, or a silica nano-coating. Other suitable materials for the hydrophobic coating 110, (or the particles 108 alone), can include but are not limited to: polyethylene, polystyrene, synthetic rubbers, polyvinyl esters, polyacrylates, PTFE, PMMA, paraffin wax, organic acids, latexes (aqueous polymer dispersions), and synthetic polymers.

In one or more exemplary embodiments, the hydrophobic coating 110 includes a biodegradable compound configured to form a hydrophobic coating 110 on respective surfaces of the particles 108 and biodegrade within a defined period of time (e.g., two weeks, three weeks, four weeks, six weeks, twelve weeks, sixteen weeks, etc.). When applied to hydrophilic soil particles, this approach will return the soil particles to their original hydrophilic prosperities after passage of the defined period of time. For example, usage of an alkyl silane or other non-biodegradable compound to form the hydrophobic coating 110 causes the particles 108 of the hydrophobic capillary layer 102 to be permanently or substantially permanently hydrophobic. This may have an adverse effect on water absorption by the hydrophilic soil layer 104. By using a biodegradable surfactant to coat the respective particles 108 that can impart hydrophobicity for a limited time (e.g., two weeks, three weeks, six weeks, twelve weeks, sixteen weeks, etc.), the hydrophobic coating 110 will undergo biodegradation without leaving residual components on the particles 108. The timing of the biodegradation can be modulated to effectuate dehydrophobization of the particles 108 at a time when a next rain or watering is expected (e.g., based on a region's rainy season) and/or at a time when enhanced retention of water within the hydrophilic soil layer 104 is not critical (e.g., after germination or root development of plants planted within the hydrophilic soil layer 104). For example, the thickness of the hydrophobic coating 110 can be modulated to control the time period for biodegradation of the hydrophobic coating, wherein a thicker coating increases the time period for biodegradation.

One suitable biodegradable material that can be employed to form the hydrophobic coating 110 includes a nano-cellulose based compound commercially referred to as Greencoat™. Another suitable hydrophobic biodegradable coating material includes hydrophobic fumed silica nanoparticles and lycopodium spores (e.g., Mater-Bi™). Another suitable biodegradable material that can be employed to form the hydrophobic coating 110 can include a matrix of hydrophobic derivatives of natural biodegradable polysaccharides. In another embodiment, the hydrophobic coating 110 can be made biodegradable when fabricated with poly(1-lactide) (PLLA) and modified silica nanoparticles (MSNs). Other suitable biodegradable materials that can be employed to form the hydrophobic coating 110 can include but are not limited to: poly-caprolactone (PCL), poly-beta-hydroxyalkanoates (PHA), poly-glycolic acid (PGA), poly-lactic acid (PLA), and poly-lactic-co-glycolic acid (PLGA).

It should be appreciated that a variety of suitable chemicals compounds can be employed to form the hydrophobic coating 110 the compounds noted above are merely exemplary. In addition, the hydrophobic coating 110 and/or the particles 108 can be formed via a combination of two or more of the above noted chemicals and compounds. For example, the hydrophobic coating 110 and/or the particles 108 can be formed via a combination of a polymer and a surfactant.

In various exemplary embodiments, the hydrophobic coating 110 covers entire surfaces of the particles 108. However, depending on the application, in some embodiments, the hydrophobic coating 110 can cover only a portion of the respective surfaces of the particles 108 and still facilitate formation of a hydrophobic capillary layer 102 that sufficiently reduces the rate of water evaporation from normal soil. For example, in some embodiments, the hydrophobic coating 110 covers about 90% of the respective surfaces of the particles 108. In another embodiment, the hydrophobic coating 110 covers about 75% of the respective surfaces of the particles 108. In yet another embodiment, the hydrophobic coating 110 covers about 50% of the respective surfaces of the particles 108. The thickness of the hydrophobic coating 110 can also vary. For example, when the hydrophobic coating 110 is formed via a biodegradable material, the thickness of the hydrophobic coating 110 can be modulated to control the period of time for biodegradation of the coating. In some implementations, the hydrophobic coating 110 has a uniform thickness around respective surfaces of the particles 108. However in other aspects, a thickness of the hydrophobic coating 110 can vary around respective surfaces of a coated particle.

In one or more embodiments, the hydrophobic capillary layer 102 is formed via deposition of particles 108 that are either formed via a hydrophobic material or that have been respectively coated with a hydrophobic coating 110 prior to deposition. In accordance with these embodiments, the particles 108 are deposited or dispersed onto the hydrophilic soil layer 104 (with or without packing) to form a hydrophobic capillary layer 102 of a suitable thickness (e.g., about 3.0 mm to about 30.0 mm) that covers or substantially cover a desired area the hydrophilic soil layer 104. For example, in various implementations the hydrophobic capillary layer 102 can include natural or hydrophilic soil particles (e.g., sand, silt, and/or clay particles) that have been respectively coated with a hydrophobic coating 110 and laid over the hydrophilic soil layer 104 as topsoil. In an aspect, the hydrophobic coating 110 is formed on respective surfaces of hydrophilic particles (e.g., hydrophilic soil particles) via physical adsorption or chemisorption of a solution including a surfactant that includes molecules having a hydrophobic tail (e.g., a hydrocarbon chain) and a polar group (e.g., an organosilane based compound, a biodegradable surfactant etc.,), followed by drying. For example, when the particles 108 include hydrophilic soil particles, the hydrophilic soil particles can be mixed with a solution containing the surfactant. The unadsorbed or unreacted portion of the solution can be drained and discarded, and the coated soil particles can be left to dry, thereby facilitating the formation of a homogeneous hydrophobic coating (e.g., hydrophobic coating 110) or respective surfaces of the soil particles. In some embodiments, heat can be applied to facilitate the drying process.

In other embodiments, rather than spreading a layer of particles 108 that have been coated with a homogenous hydrophobic coating 110, or that are made with a hydrophobic material, over the hydrophilic soil layer 104, the hydrophobic capillary layer 102 can be formed by means of spraying or otherwise applying an aqueous surfactant directly onto a top surface (e.g., at the soil/air interface 118) of natural hydrophilic soil particles. With these embodiments, the particles 108 include natural or hydrophilic soil particles (e.g., soil particles 116). As the hydrophilic soil particles located within the top portion of the soil (e.g., the portion corresponding to the hydrophobic capillary layer 102) become coated with the surfactant, they are transformed into hydrophobic soil particles (e.g., hydrophilic soil particles coated with a hydrophobic coating 110). For example, the liquid surfactant seeps into the soil as a result of the applying and coats respective surfaces of the soil particles with the aqueous hydrophobic coating material. The hydrophobic coating 110 is formed on respective surfaces of the soil particles when the liquid surfactant is dried. The amount of liquid surfactant applied can vary to reach soil particles at a desired depth below the soil/air interface 118, thereby controlling the resulting thickness of the hydrophobic capillary layer 102. In some implementations, prior to spraying or otherwise applying a liquid surfactant onto an existing layer of hydrophilic soil particles, an imprinting tool having spikes or needlelike projections can be pressed onto the soil surface to texture the upper surface of the hydrophilic soil particles to improve the hydrophobicity of the soil particle.

The thickness of the hydrophobic capillary layer 102 can vary. In an exemplary embodiment, the thickness of the hydrophobic capillary layer 102 is between about 3.0 mm and about 30.0 mm and preferably between about 10.0 mm and about 20.0 mm For example, a hydrophobic capillary layer (e.g., hydrophobic capillary layer 102) having a thickness of only 20.0 mm formed via soil particles coated with an organosilane compound proved effective in reducing water evaporation from water saturated soil by 90%, as described in greater detail infra. However, it should be appreciated that a thickness of the hydrophobic capillary layer 102 can be increased or decreased as desired and also modulated by particle size.

As described supra with respect to application of Equation 1 to system 100, in addition to size of the particles 108 and associated diameter and tortuosity of the hydrophobic capillaries 112, the thickness of the hydrophobic capillary layer 102 can also control the resulting amount of reduction in evaporation afforded by the hydrophobic capillary layer 102. For example, as the thickness of the hydrophobic capillary layer 102 is increased, the length (l) of the hydrophobic capillaries is increased. As a result, the rate of evaporation rate of liquid water 114 from the hydrophilic soil layer 104 is decreased due to the increased travel distance for the water vapor molecules 106. The rate of evaporation of liquid water 114 from the hydrophilic soil layer 104 is also a function of various atmospheric or environmental conditions, including temperature, sunlight, wind current, humidity, rainfall, etc. Accordingly, the thickness of the hydrophobic capillary layer 102 and dimensions of the respective particles 108 can be selected based on the type of weather conditions the subsoil (e.g., the hydrophilic soil layer 104) to which the applied hydrophobic capillary layer 102 will be subjected to. The phrase ‘normal or natural atmospheric conditions,’ is used herein to refer to reported average weather conditions with respect to temperature, sunlight, wind current, humidity and rainfall for a particular geographical area at a particular time of year.

In an exemplary embodiment, when the hydrophobic capillary layer 102 of system 100 is between about 3.0 mm and 30.0 mm and exposed to normal or natural conditions of temperature, humidity and sunlight, for about 84 hours, a rate of evaporation of the liquid water 114 from the hydrophilic soil layer 104 without the hydrophobic capillary layer 102 provided thereon is decreased by at least about 80%. For example, the amount of liquid water included in the hydrophilic soil layer 104 that is prevented from evaporation over the 84 hour time period is at least about 80% of the initial liquid water amount included in the hydrophilic soil layer. In one implementation, when the hydrophobic capillary layer 102 of system 100 is about 10.0 mm and exposed to normal or natural conditions of temperature, humidity and sunlight, for about 84 hours, a rate of evaporation of the liquid water 114 from the hydrophilic soil layer 104 without the hydrophobic capillary layer 102 provided thereon is decreased by about 80%. For example, the amount of liquid water included in the hydrophilic soil layer 104 that is prevented from evaporation over the 84 hour time period is about 80% of the initial liquid water amount included in the hydrophilic soil layer. In another implementation, when the hydrophobic capillary layer 102 of system 100 is about 20.0 mm and exposed to normal or natural conditions of temperature, humidity and sunlight, for about 84 hours, a rate of evaporation of the liquid water 114 from the hydrophilic soil layer 104 without the hydrophobic capillary layer 102 provided thereon is decreased by about 90%. For example, the amount of liquid water included in the hydrophilic soil layer 104 that is prevented from evaporation over the 84 hour time period is about 90% of the initial liquid water amount included in the hydrophilic soil layer. In another implementation, when the hydrophobic capillary layer 102 of system 100 is about 30.0 mm and exposed to normal or natural conditions of temperature, humidity and sunlight, for about 84 hours, a rate of evaporation of the liquid water 114 from the hydrophilic soil layer 104 without the hydrophobic capillary layer 102 provided thereon is decreased by about 93%. For example, the amount of liquid water included in the hydrophilic soil layer 104 that is prevented from evaporation over the 84 hour time period is about 93% of the initial liquid water amount included in the hydrophilic soil layer.

The formation of a hydrophobic capillary layer 102 on a hydrophilic soil layer 104 as presented in system 100 substantially reduces the rate of evaporation of liquid water 114 included in the hydrophilic soil layer 104. Due to the increased conservation of water within the hydrophilic subsoil, a significantly less amount of water is required for application to the hydrophilic subsoil to facilitate growth of plants planted within the hydrophilic subsoil. Previous method to reduce water evaporation from soil involved covering the soil with plastic sheets or ribbons. However, plastics have poor degradation characteristics which causes a major disposal issue of after use. In addition, in arid and subtropical areas, application of plastic over soil increases the soil temperature which is unsuitable for vegetable production (e.g., due to burning or scorching of young plants at the high temperature), and thus requires an extra protective net for optimization of temperature for vegetable production. Although some biodegradable plastics have been developed, these biodegradable plastics are costly and not practical for application in large quantities.

Unlike these previous methods, the proposed hydrophobic capillary layer 102 requires usage of little or no plastic materials. The subject techniques provide an efficient, economical, and environmentally friendly method for decreasing water evaporation from soil. The subject hydrophobic capillary layer can be employed to facilitate increasing water retention from potted plants and personal home lawns and gardens to crop fields and pastures spanning thousands of acres. This approach can bring semi-arid land of the world into cultivation by preserving the water in the soil and promoting plant growth.

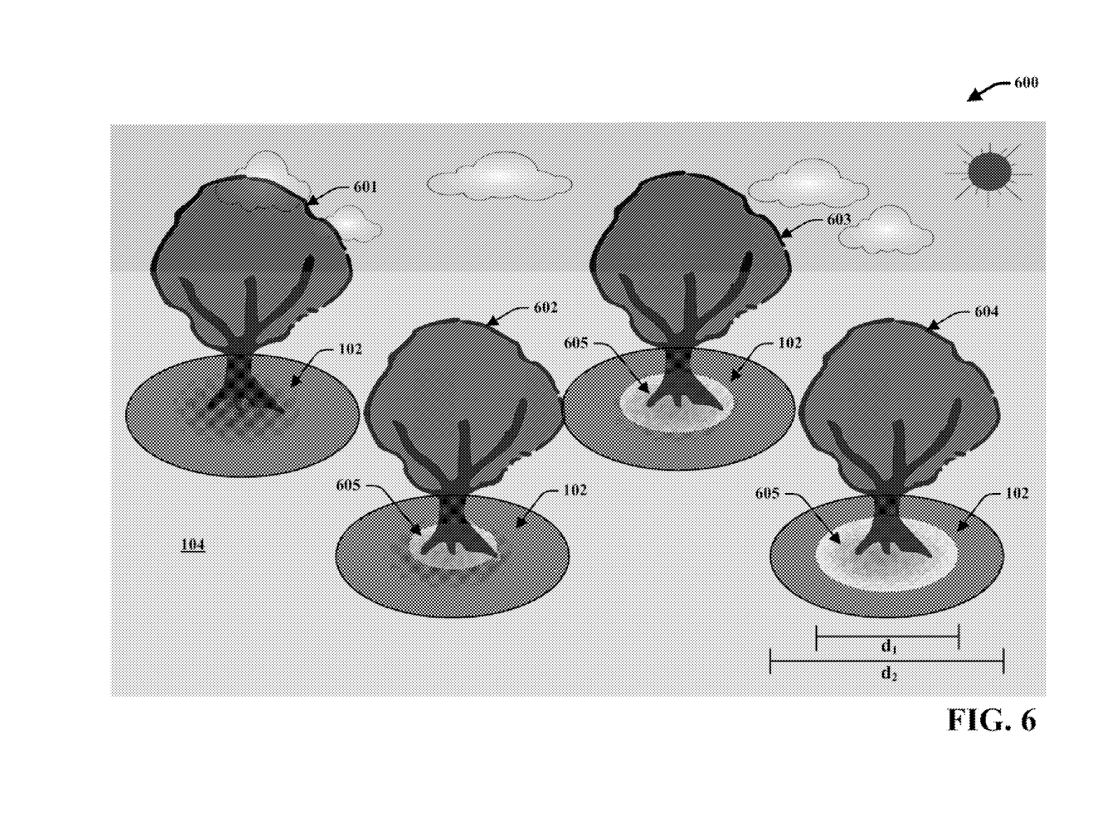

FIG. 6 presents an example agriculture system 600 employing a hydrophobic capillary layer to facilitate water retention in soil in accordance with various aspects and embodiments described herein. System 600 demonstrates various configurations for planting trees 601-604 using a hydrophobic capillary layer 102 (depicted herein using the checkered fill pattern) to cover at least a portion of the hydrophilic soil layer 104 (depicted using light grey) within which the respective trees are planted. The hydrophobic capillary layer 102 can be formed via deposition of particles having a hydrophobic coating (e.g., hydrophobic coating 110) formed thereon (e.g., hydrophobic soil 502) or particles formed via a hydrophobic material (e.g., a synthetic polymer), and/or via spraying of an aqueous surfactant onto the surface the hydrophilic soil layer 104. It should be appreciated that various aspects of system 600 can be applied to a variety of different plants and the usage of trees in system 600 is merely exemplary. The hydrophobic capillary layer 102 and the hydrophilic soil layer 104 can respectively include the various features and functionalities discussed supra with reference to FIGS. 1-5. Repetitive description of like elements employed in respective embodiments described herein is omitted for sake of brevity.

As discussed supra, the hydrophobic capillary layer 102 prevents liquid water from passing through. When the hydrophobic capillary layer 102 is employed to increase water retention in an underlying hydrophilic soil layer 104 to facilitate the growth of plants planted therein (e.g., trees 601-604), various techniques can be employed to facilitate the provision of liquid water to seeds and/or plant root located in the underlying hydrophilic soil layer 104. For example, the hydrophobic capillary layer 102 can be configured to dehydrophobize (e.g., using a biodegradable hydrophobic coating for respective hydrophobic particles of the hydrophobic capillary layer) within a defined time period to return the particles employed for the hydrophobic capillary layer 102 to a hydrophilic state. In another example, an irrigation system (e.g., a drip irrigation system or other suitable system) can be employed that introduces liquid water into the hydrophilic soil layer 104 beneath the hydrophobic capillary layer 102 to provide water at regular intervals of time. In addition, as depicted in system 600, in order to circumvent the issue of water infiltration through the hydrophobic capillary layer 102, at least a portion of the hydrophilic soil layer 104 located around or near the hydrophobic capillary layer 102 can be left uncovered by hydrophobic particles.

The terrain of system 600 includes trees 601-604 planted within a layer of hydrophilic soil (e.g., hydrophilic soil layer 104). A hydrophobic capillary layer 102 is formed on a portion of the surface of hydrophilic soil layer 104 around the bases of the respective trees 601-604. For example, as shown in system 600 a hydrophobic capillary layer 102 is formed in a circular shape around the bases of the respective trees 601-604. The diameter d₂ of the hydrophobic capillary layer 102 formed around the respective trees 601-604 can vary. Similarly, although the shape of the hydrophobic capillary layer 102 is depicted as a circle, it should be appreciated that the shape and dimensions of the hydrophobic capillary layer can vary. For example, the rate of water evaporation from the hydrophilic soil layer 104 is directly proportional to the amount of surface area of the hydrophilic soil layer 104 covered with a hydrophobic capillary layer 102, wherein the greater the amount of surface area of the hydrophilic soil layer 104 covered with a hydrophobic capillary layer 102, the lower the rate of evaporation of water from the hydrophilic soil layer 104. Thus in various embodiments of agriculture systems described herein, a hydrophobic capillary layer 102 is formed on substantially the entire surface area of the hydrophilic soil layer 104 of the terrain.

In one implementation, demonstrated by the hydrophobic capillary layer 102 around the base of tree 601, the hydrophobic capillary layer 102 can cover an entire radial area of diameter d₂ of the hydrophilic soil layer 104 beneath and around the tree 601. For example, when a seed (not shown) for tree 601 is initially planted within the hydrophilic soil layer 104, the hydrophobic capillary layer 102 (e.g., hydrophobic topsoil) can be formed on an entire circular area of the hydrophilic soil layer 104 that directly covers the seed and has diameter d₂ defined by a circle formed around the seed with the seed as the center point. According to this example, when tree 601 germinated, it broke through the hydrophobic capillary layer 102. This implementation is thus suitable for formation of a hydrophobic capillary layer 102 over seeded plants before germination that are capable of breaking through the hydrophobic capillary layer 102 (e.g., corn plants). The arrangement of the hydrophobic capillary layer 102 around tree 601 can also be applied after germination of the tree 601, and thus is applicable (after germination) to plants that are incapable of germinating through the hydrophobic capillary layer 102.

In other implementations, demonstrated by the hydrophobic capillary layers around the bases of trees 602-604, the hydrophobic capillary layer 102 can form a ring around the respective trees with a portion of the hydrophilic soil layer 104 located in the center of the ring and adjacent to the bases of the trees exposed. For example, when seeds (not shown) for trees 602-604 are initially planted within the hydrophilic soil layer 104, a circular area 605 of the hydrophilic soil layer 104 that directly covers the seed can be left uncovered with hydrophobic soil. This circular area 605 is defined by a circle having a diameter d₁ formed around the seed with the seed as the center point and is referred to herein as an ‘island’ of hydrophilic soil. The diameter d₁ of the circular area 605 of hydrophilic soil can vary, as demonstrated by the varying dimensions of 605 around trees 602-604. According to these implementations, the circular area 605 directly above the seeds will not have a hydrophobic capillary layer 102 thereon, thereby facilitating germination of plants that are incapable of geminating through the hydrophobic capillary layer 102. In an aspect, an additional layer or mound of hydrophilic soil (e.g., hydrophilic soil particles 116) having a diameter d₁ can be added to cover the seed in this circular area 605. In some embodiments, this configuration can also be employed to allow for passage of water (e.g., rainwater, sprinkler water, dew, etc.) directly at the base of the tree or other suitable plant (e.g., through the circular area 605 of hydrophilic soil at the center of the hydrophobic capillary layer 102). According to these embodiments, the hydrophobic capillary layer 102 can also be formed as a ring around the base of the tree (or other suitable plant), after germination.

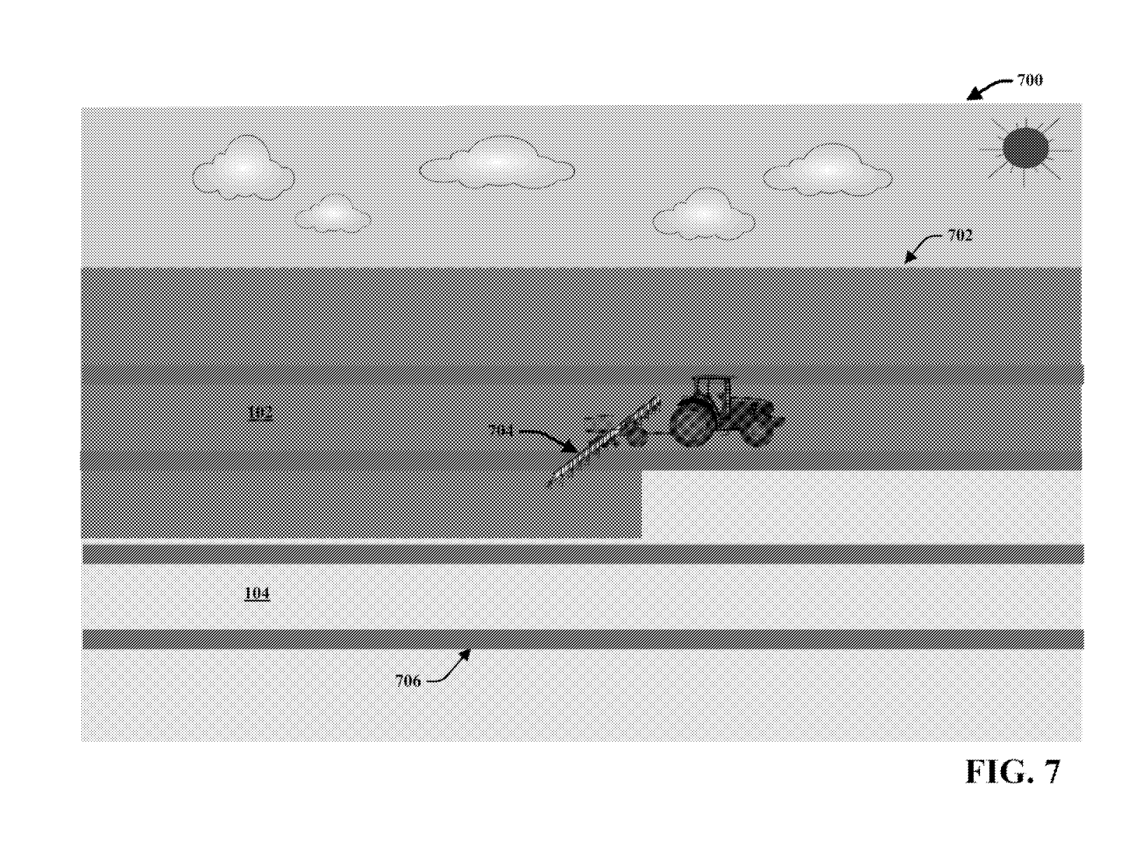

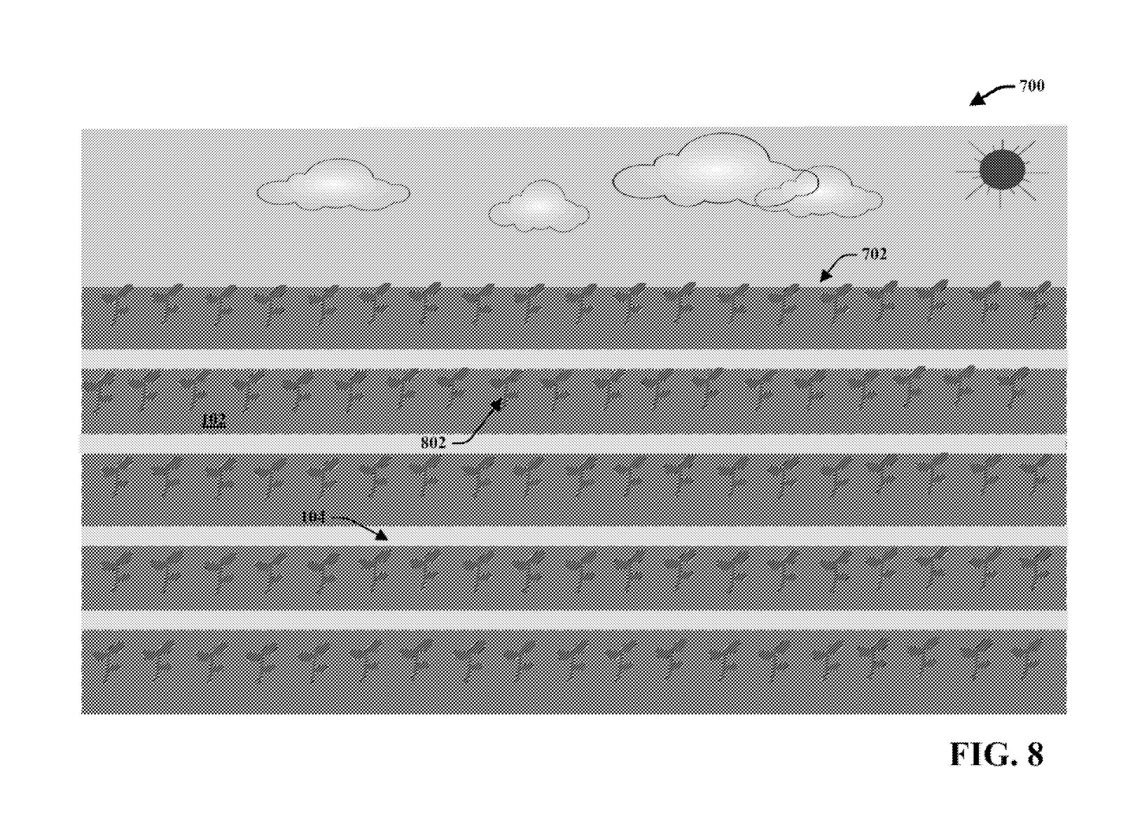

FIGS. 7 and 8 present another example agriculture system 700 employing a hydrophobic capillary layer (e.g., hydrophobic capillary layer 102) to facilitate water retention in soil in accordance with various aspects and embodiments described herein. Agriculture system 700 includes a field 702 including a hydrophilic soil layer 104 (depicted in light grey) having seeds/plants 802 planted therein. FIG. 7 presents a state of the agriculture system 700 when a hydrophobic capillary layer 102 is being formed over the hydrophilic soil layer 104 prior to germination of the seeds/plants 802. FIG. 8 presents another state of agriculture system 700 after the formation of the hydrophobic capillary layer 102 and germination of the seeds/plants 802. Repetitive description of like elements employed in respective embodiments described herein is omitted for sake of brevity.

As demonstrated in FIG. 7, the hydrophobic capillary layer 102 is being formed via spraying of the hydrophilic soil layer 104 with an aqueous solution including a surfactant (e.g., a silane based surfactant, a biodegradable surfactant, or other suitable compound). As described supra, when the aqueous surfactant is applied to the surface of a hydrophilic soil layer 104, the aqueous surfactant will seep into the hydrophilic soil to a depth calibrated based on the amount of compound applied. The depth reached by the surfactant controls the resulting thickness of the hydrophobic capillary layer 102. In various exemplary embodiments, the depth ranges from about 3.0 mm to about 30.0 mm The aqueous surfactant will further coat respective surfaces of hydrophilic soil particles (e.g., hydrophilic soil particles 116) included in the hydrophilic soil layer 104 via physical adsorption or chemisorption. A hydrophobic coating (e.g., hydrophobic coating 110) is formed on the respective surfaces of hydrophilic soil particles following drying of the aqueous solution including the surfactant, thereby establishing the hydrophobic capillary layer 102.

For example, in the embodiment shown, in order to form the hydrophobic capillary layer 102 on the hydrophilic soil layer 104, a tractor including a spraying apparatus 704 is driven over the field while spraying the aqueous surfactant onto the hydrophilic soil layer 104. It should be appreciated however that various alternative mechanisms can be employed to facilitate coating of the field 702 with the surfactant (e g , manual spraying, aerial spraying, traveling spraying systems, etc.). In some embodiments, the top layer of hydrophilic soil can be churned in association with application of the surfactant to the hydrophilic soil to facilitate effective and efficient coating of the various hydrophilic soil particles.

In one embodiment, a mask 706 (e.g., a sheet of plastic or other water suitable mask that does not allow the surfactant to pass through) can be employed to cover portions of hydrophilic soil layer 104 during the spraying process so that the respective portions are not coated with the surfactant. For example, as shown in FIG. 7, a mask 706 (depicted in dark grey) is formed in the shape of four strips spanning across the field 702. After the hydrophobic capillary layer 102 has been formed, as depicted in FIG. 8, the mask 706 can be removed to expose the uncoated regions of the hydrophilic soil layer 104. These uncoated regions can allow for the passage of liquid water (e.g., rain water, sprinkler water, dew, etc.) into the hydrophilic soil layer 104 located beneath the hydrophobic capillary layer 102. As demonstrated in FIG. 8, the mask 706 and corresponding uncoated regions of the hydrophilic soil layer 104 is formed at locations between respective rows of the planted seeds/plants 802. However, it should be appreciated that the size, shape, location and configuration of the mask 706 can vary. In other embodiments, an irrigation system can be employed to facilitate provision of liquid water beneath the hydrophobic capillary layer 102.

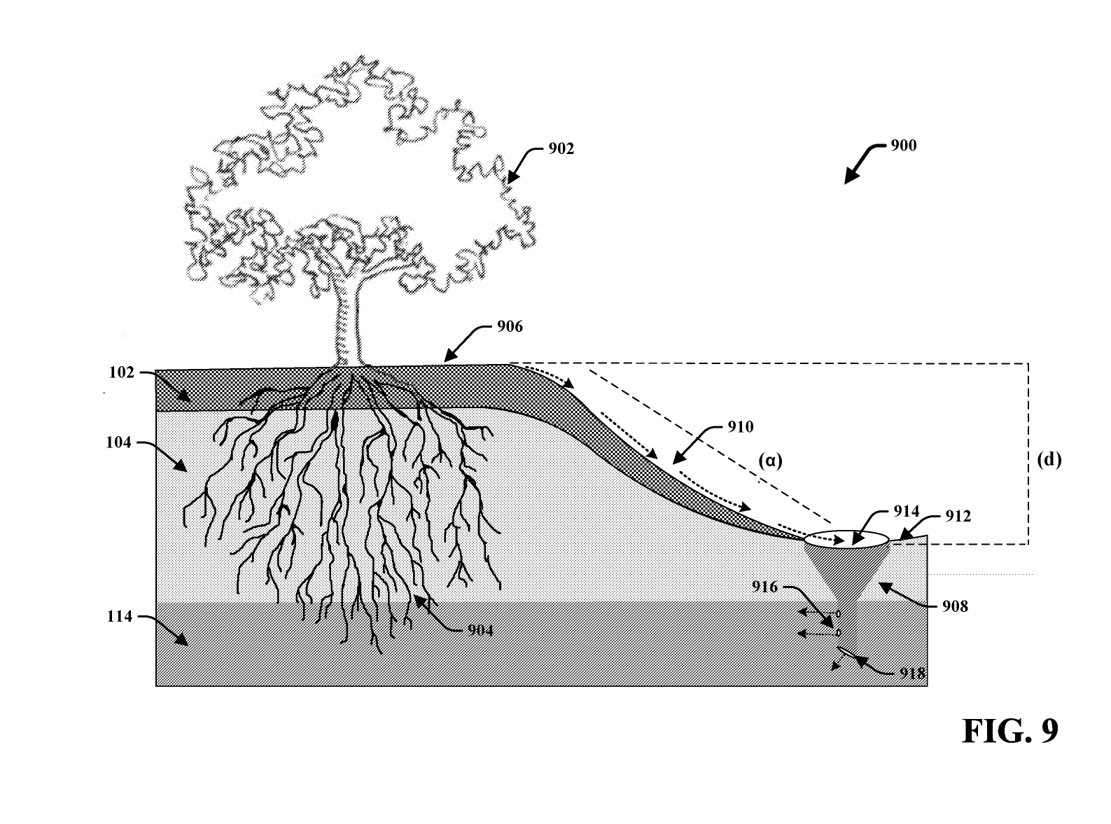

FIG. 9 presents another example agriculture system 900 employing a hydrophobic capillary layer 102 to facilitate water retention in soil in accordance with various aspects and embodiments described herein. Similar to system 600, system 900 includes a tree 902 planted within a hydrophilic soil layer 104 having a hydrophobic capillary layer 102 formed over a portion of the hydrophilic soil layer 104 located beneath the tree 902. The hydrophobic capillary layer 102 can be formed via deposition of particles having a hydrophobic coating (e.g., hydrophobic coating 110) formed thereon (e.g., hydrophobic soil 502) or particles formed via a hydrophobic material (e.g., a synthetic polymer), and/or via spraying of an aqueous surfactant onto the surface the hydrophilic soil layer 104. It should be appreciated that various aspects of system 900 can be applied to a variety of different plants and the usage of a tree 902 in system 900 is merely exemplary. The hydrophobic capillary layer 102 and the hydrophilic soil layer 104 can respectively include the various features and functionalities discussed supra with reference to FIGS. 1-5. Repetitive description of like elements employed in respective embodiments described herein is omitted for sake of brevity.

Soil water is stored in three different forms: gravitational water, capillary water and hygroscopic water. Plants take advantage of capillary action to pull capillary water into their root system and push it to the aerial parts of the plant. Thus the provision of capillary water to the roots enhances growth of the roots as well as the plant (as water which gets pulled through gravitational force is not available for root development during initial stages of plant root development). When little or no capillary water is available during the initial stages of root development, the plant's growth is hindered, resulting in poor development and/or wilting of the plant.

In the embodiment shown, the hydrophobic capillary layer 102 covers the surface of the hydrophilic soil layer 104, including a region of the hydrophilic soil layer 104 that includes the roots 904 of the tree 902. As a result, the hydrophobic capillary layer 102 facilitates retention of capillary water (e.g., liquid water 114) within the hydrophilic soil layer 104 at or near the roots 904. Usage of the subject hydrophobic capillary layer 102 in system 9000 and the like therefore facilitates the efficient use of water for successful growth of plants without sacrificing the yields. This strategy facilitates sustaining moisture in the hydrophilic soil layer above the wilting point for longer periods of time and provides sufficient capillary water to the roots.

In addition to the hydrophobic capillary layer 102, system 9000 also includes an irrigation device 908 configured to facilitate collection of liquid water (e.g., rain water, sprinkler water, run-off water, dew, etc.) and provision of the liquid water 114 to the roots 904 of the tree within the hydrophilic soil layer 104. The surface topology of system 9000 is configured to facilitate collection of liquid water 114 by the irrigation device 908 using gravitational force. For example, in the embodiment shown, the terrain (which collectively includes the hydrophilic soil layer 104, the hydrophobic capillary layer 102, and other plausible geographical features) includes a region of high ground 906 that slopes downward via a sloping region 910 to a region of low ground 912. The distance (d) between the region of high ground 906 and the region of low ground 912 can vary. The angle (a) and/or curvature of the sloping region 910 can also vary. With this non-planar surface topology, rain water (and other sources of water) that is repelled by the hydrophobic capillary layer 102 flows down the sloping region 910 (depicted via the dashed arrows) and into the irrigation device 908 located at based of the sloping region 910. In various implementations, the thickness of the hydrophobic capillary layer 102 can also decrease in a direction away from the base of the tree 902 (away from the roots of the tree, the seed of the plant, etc.). For example, as shown in system 900, the thickness of the hydrophobic capillary layer 102 decreases as the topology of the terrain slopes downward from the region of high ground 906 to the region of low ground 912.

In the embodiment shown, the irrigation device 908 includes a funnel that is inserted into the hydrophilic soil layer 104. The funnel includes a wide opening 914 at the soil/air interface above the hydrophilic soil layer 104 and has a cylindrical tube portion that tapers to a narrow lower opening 918 located within the hydrophilic soil layer 104. In some embodiments, the funnel can also include one or more side openings 916 along the length of the cylindrical tube portion to facilitate radial distribution of liquid water 114 (e.g., in the direction indicated by the dashed arrows). For example, liquid water 114 enters through the wide opening 914 and is provided into the hydrophilic soil layer 104 via the lower opening 918 and/or the side openings 916 of the funnel located within the hydrophilic soil layer 104.

Although a conventional funnel is used in system 900 as an irrigation device, it should be appreciated however that a variety of alternative irrigation devices and/or systems can be employed to facilitate provision of liquid water 114 to regions of the hydrophilic soil layer 104 when liquid water is repelled by the hydrophobic capillary layer 102. For example, an irrigation device and/or system can be employed that includes one or more water channels which pass directly through the hydrophobic capillary layer 102 into the layer of hydrophilic soil 104 there below and provides liquid water 114 to the roots 904 below the hydrophobic capillary layer. In another example, a drip irrigation system can be employed. In addition, the size, shape and number of irrigation devices employed by system 900 and the like can vary. For example, in one implementation, a plurality of irrigation devices (e.g., a funnel or other suitable device) can be dispersed around the tree 902 that facilitate provision of liquid water 114 to the hydrophilic soil layer 104 beneath the tree.

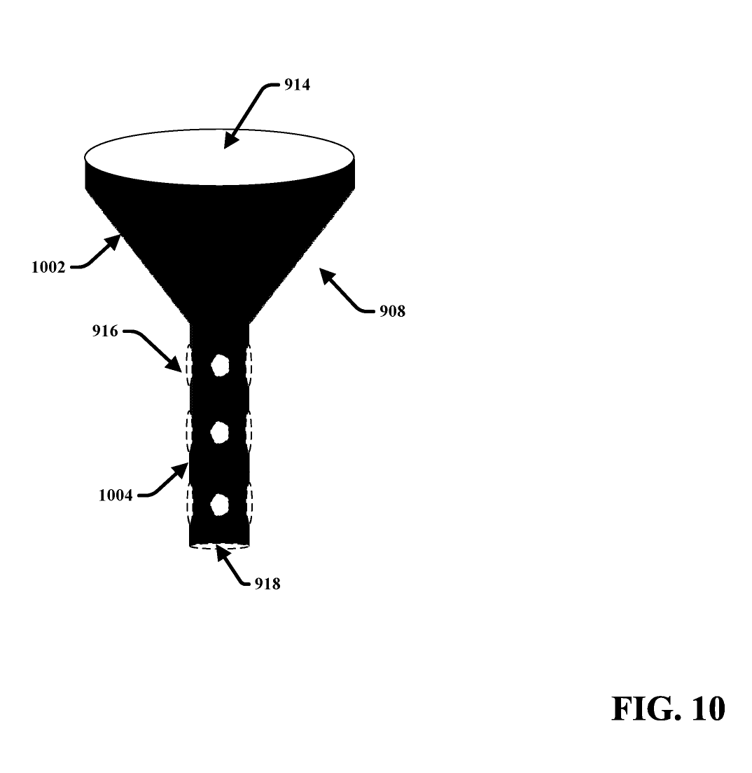

For example, FIG. 10 presents an enlarged perspective of example irrigation device 908 in accordance with various aspects and embodiments described herein. One or more features of irrigation device 908 can be employed with the various agriculture systems described herein (e.g., systems, 600, 700, 900 and the like). In the embodiment shown, the irrigation device 908 includes a wide conical mouth with the wide opening 914 and a narrow stem 1004. The narrow stem 1004 includes a plurality of side openings 916 through which water, which enters through the wide opening 914, is expelled. The narrow stem can also include lower opening 918 via which water can expelled. The side openings 916 facilitate radial distribution of water into the hydrophilic soil layer in which the funnel is inserted. The number, size and arrangement of the side openings 916 can vary. For example, side openings 916 can be provided at different positions along the length of the stem 1004 and around the circumference of the stem 1004. In an aspect, the wide opening 914 is covered with a grating or filter (not shown) that blocks entry of debris. Repetitive description of like elements employed in respective embodiments described herein is omitted for sake of brevity.

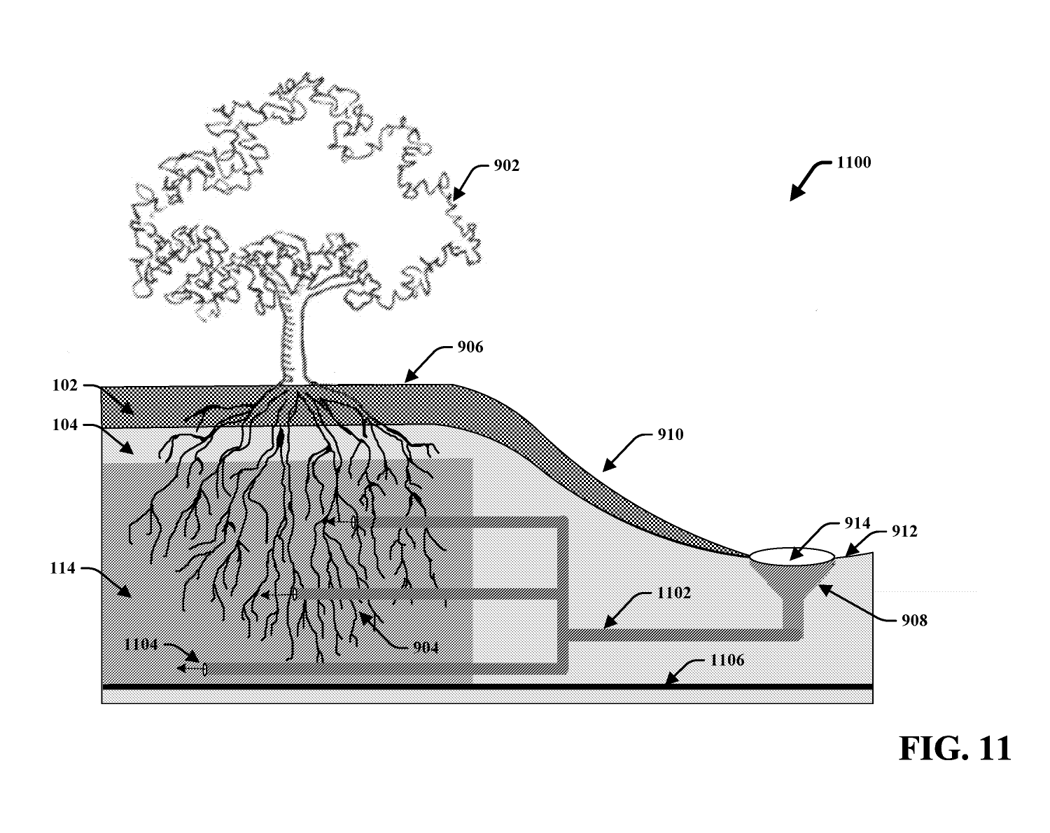

FIG. 11 presents another example agriculture system 1100 employing a hydrophobic capillary layer to facilitate water retention in soil in accordance with various aspects and embodiments described herein. System 1100 includes same or similar features as system 9000 with the addition of water pipes 1102 and barrier layer 1106. Repetitive description of like elements employed in respective embodiments described herein is omitted for sake of brevity.

In order to better facilitate directing liquid water 114 to the roots 904 of the tree 902, system 1100 includes water pipes 1102 that connect to the irrigation device 908 (e.g., the funnel) and extend through the hydrophilic soil layer 104 toward the roots 904 of the tree 902. The water pipes 1102 can be located at various depths below the tree 902 and open via openings 1104 to various regions around the tree roots 904 to provide water (as indicated by the small dashed arrows), collected by the irrigation device 908, to various regions around the tree roots 904. It should be appreciated that the number, size, and position of the water pipes 1102 can vary. For example, in some embodiments, a single water pipe is used. In other embodiments, two or more pipes are used.

System 1100 also includes a barrier layer 1106 located within the hydrophilic soil layer 104 beneath the tree roots 904, the irrigation device 908 and the water pipes 1102. The barrier layer 1106 can include any suitable hydrophobic material that prevents or substantially hiders the passage of liquid water 114, thereby limiting the diffusion of the liquid water 114 to a significant depth. For example the barrier layer 1106 can include a plastic sheet or another suitable hydrophobic synthetic material. In another example, the barrier layer 1106 can be formed with another hydrophobic capillary layer such as hydrophobic capillary layer 102 (e.g., including hydrophobic particles). In another example, the barrier layer can be formed with hydrophobic clay. Agriculture systems (e.g., system 1100 and the like) can employ a barrier layer 1106 to further facilitate retention of capillary water at or near the region of the hydrophilic soil where a plant is located (e.g., near the roots 904). The various techniques described herein are targeted to minimizing an amount of liquid water need for plant cultivation. The barrier layer 1106 in combination with the hydrophobic capillary layer 1102 further facilitates achieving this objective. The hydrophobic capillary layer 102 reduces water evaporation at the soil/air interface while the barrier layer 1106 prevents diffusion into the underlying hydrophilic soil. The barrier layer 1106 can be located at a suitable depth within the hydrophilic soil layer 104 below the soil/air interface that facilitates cultivation of plants planted therein while limiting the amount of water supply to a minimal amount needed for the cultivation of the plants. For example, when employed in association with corn cultivation, the barrier layer 1106 can be between about 1.0 to 2.0 feet below the soil air interface.

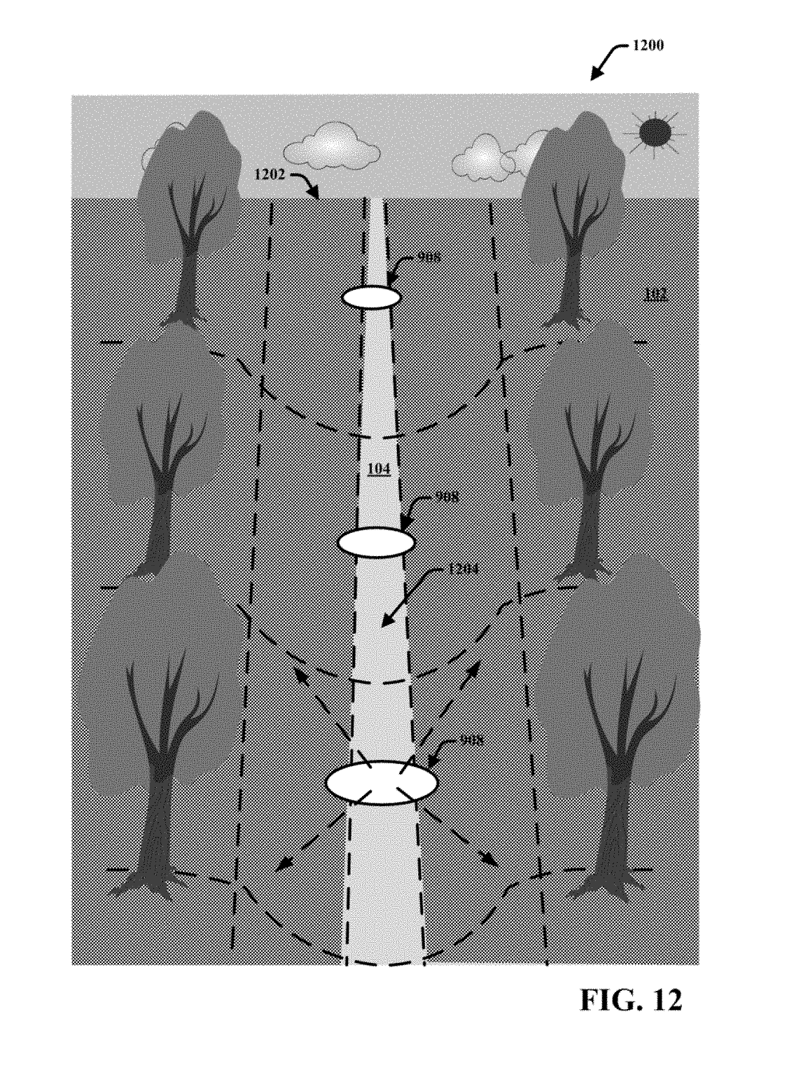

FIG. 12 presents another example agriculture system 1200 employing a hydrophobic capillary layer to facilitate water retention in soil in accordance with various aspects and embodiments described herein. System 1200 can include same or similar features as agriculture systems 600, 700, 900 and 1100. Repetitive description of like elements employed in respective embodiments described herein is omitted for sake of brevity.

Topological engineering of soil can be used for the efficient use of water for the growth of plants. System 1200 demonstrates a mechanism to facilitate minimizing an amount of liquid water needed for plant cultivation by adapting the surface topology of the terrain. System 1200 includes a plurality of trees planted in a field 1202 having a non-planar surface topology. In system 1200, the strip of hydrophilic soil layer 1204 provided in the center of the field 1202 corresponds to a canal, ditch, or channel for liquid water to drain and disperse to the roots of the trees or plants. For example, the terrain of in the center of the field 1202 can have a V-shape or semi-spherical (concave) shape.

In various embodiments, the subject hydrophobic capillary layer 102 can be employed to facilitate water retention in soil having a plurality of plants planted therein within relative proximity to one another, such as plurality of plants (e.g., crops, trees, flowers, etc.) planted in an agriculture field (e.g., as presented in system 700, system 1200, and the like). In order to facilitate provision of liquid water to the respective plants, the terrain of the field can have a non-planar surface topology with regions of high ground separated by regions of low ground having a lower altitude than the regions of high ground. For example, the terrain can have a wavelike topography with peaks and valleys or crests and troughs. In another example, the terrain can include areas of high ground separated by drainage ditches. The seeds or plants can be planted within a hydrophilic soil layer (e.g., hydrophilic soil layer 104) at or near the regions of high ground. Hydrophobic topsoil (e.g., hydrophobic capillary layer 102) can be employed to cover at least portions of the terrain to facilitate water retention by the hydrophilic soil layer in which the plants are planted. For example, hydrophobic topsoil can be deposited or formed on the entire top surface of the terrain. In another example, as shown in system 1200, a portion of the hydrophilic soil layer 104 can be left exposed within the region of low ground to facilitate provision of water to the hydrophilic soil layer 104 beneath the hydrophobic capillary layer 102. In some implementations, one or more water collection and irrigation devices can be provided at or near the regions of low ground to facilitate provision of water to the seeds or plants (e.g., the roots of the plants) within the hydrophilic soil layer 104 beneath the hydrophobic soil (e.g., hydrophobic capillary layer 102).

For example, system 100 includes an agricultural field 1202 with a terrain having a non-planar surface topology. The terrain is formed via a hydrophilic soil layer 104 that includes regions of high ground on either sides of a trench 1204. Trees are planted within the hydrophilic soil layer 104 on either sides of the trench 1204 at or near the regions of high ground. The trees are planted at substantially equal distances away from one another. However, it should be appreciated that the arrangement of the trees can vary. A hydrophobic capillary layer 102 is provided around the trees over the hydrophilic soil layer 104 on either sides of the trench 1204. The trench 1204 includes an exposed portion of the hydrophilic soil layer 104. Irrigation devices 908 are located at various points within the trench at the lowest regions of the trench. In an exemplary embodiment, an irrigation device (e.g., irrigation device 908) is located at a substantially equal distance from the four trees within closest proximity to the irrigation device (e.g., the irrigation device 908 is located within the trench 1204 at or near a center point between two neighboring trees located on a same side of the trench). As described supra, the irrigation device 908 is configured to collect water that is repelled from the hydrophobic capillary layer (e.g., via gravitational force) and deliver the water to the hydrophilic soil layer 104 located beneath the hydrophobic capillary layer 102 around the respective trees.

In one or more embodiments, (as shown in systems 9000 and 1000), the irrigation device 908 includes a funnel that is inserted into the hydrophilic soil layer 104 and has an opening at the soil/air interface. The funnel can also include one or more openings located on side portions of the narrow tube portion of the funnel to facilitate radial distribution of water under the hydrophobic capillary layer 102 to the roots of the respective trees surrounding the funnel (e.g., in the directions of the dashed arrows).

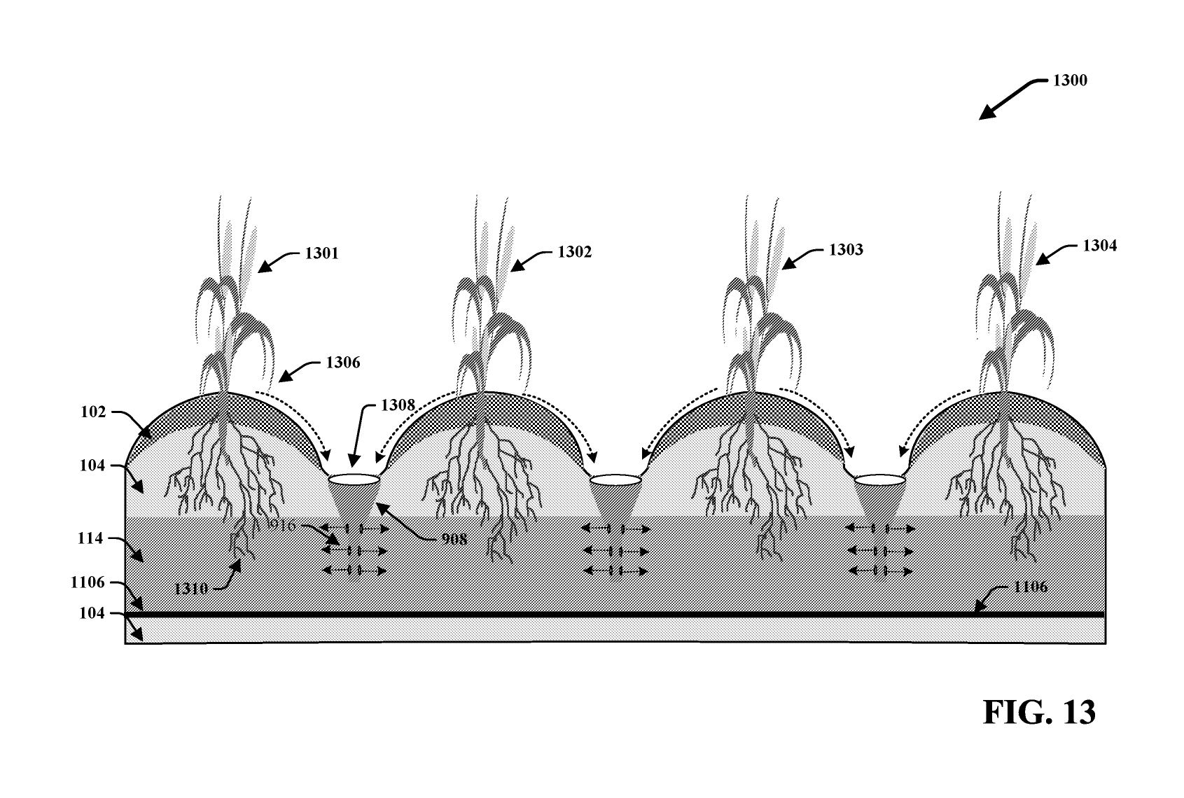

FIG. 13 presents another example agriculture system 1300 employing a hydrophobic capillary layer to facilitate water retention in soil in accordance with various aspects and embodiments described herein. System 1300 can include same or similar features as agriculture systems 600, 700, 900, 1100 and 1200. Repetitive description of like elements employed in respective embodiments described herein is omitted for sake of brevity.

System 1300 demonstrates another view of a non-planar terrain topography that can be employed in association with a hydrophobic capillary layer 102 to facilitate water conservation in association with cultivating crops. System 1300 includes a plurality of corn plants 1301-1304 respectively planted on a terrain including a wavelike surface topography. For example, the terrain includes a plurality of crests 1306 and troughs 1308. The corn plants are located at or near the crests 1306 while irrigation devices 908 (e.g., funnels) are respectively provided within the troughs. The upper surface of the terrain includes a hydrophobic capillary layer 102 that covers or substantially covers the underlying hydrophilic soil layer 104 of the terrain (e.g., aside from where the irrigation devices 908 are located). For example, the upper surfaces of the crests 1306 respectively include a hydrophobic capillary layer 102 (e.g., having a thickness between about 3.0 mm to about 30.0 mm).

With this configuration, liquid water (e.g., rain water, dew, sprinkler water etc.), is repelled by the hydrophobic capillary layer 102 on the crests 1306 and flows down the crests of the terrain toward the troughs 1308, (as indicated by the dashed curved arrows), where it is collected by the respective irrigation devices 908. The liquid water 114 that is collected by the respective irrigation devices 908, which include funnels, is then expelled via side openings 916 on opposite sides of the funnels (as indicated by the dashed arrows), and radially dispersed into the hydrophilic soil layer 104 to roosts 1310 of the corn plants on either sides of the respective funnels. System 1300 also includes a barrier layer 1106 to prevent diffusion of the liquid water 114 past a desired depth within hydrophilic soil layer 104. For example, when employed to facilitate cultivation of corn plants, the barrier layer 1106 can be located less than 3.0 ft below the wide mouth opening of the irrigation devices 908 (e.g., wide opening 914).

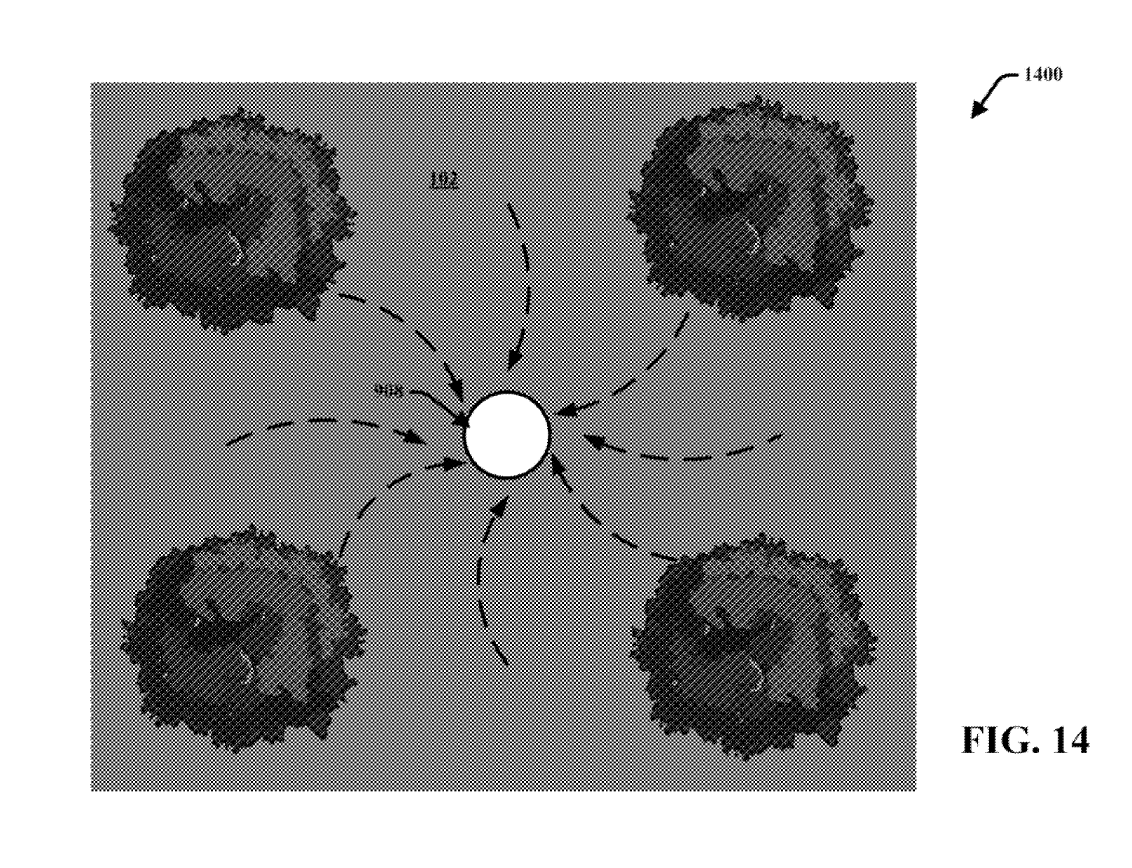

FIG. 14-17 respectively present aerial perspectives of different configurations 1400-1700 of agriculture systems in accordance with various aspects and embodiments described herein. Each of the respective configurations 1400-1700 are exemplified with four trees located in respective corners of a square area and at least one irrigation device located at or near the center of the square area. The trees are respectively planted within in a hydrophilic soil layer 104. A hydrophobic capillary layer 102 is formed around the respective trees above at least a portion the hydrophilic soil layer 104. The terrain of the respective agricultural systems presented in FIGS. 14-17 has a non-planar surface topology with regions of high ground where the trees are located which slopes to a region of low ground at the center of the square area where the irrigation device 908 is located.

It should be appreciated however that above described features of agricultural system configurations 1400-1700 are merely exemplary. For example, any number of trees or other plants can be employed and provided in various arrangements around an irrigation device (e.g., irrigation device 908). For example, four, five, six, seven, etc., plants can be arranged around a single irrigation device at various distances from the irrigation device and one another, and the irrigation device can be configured to distribute water to each of the respective plants. The number, size and type of irrigation devices employed can also vary. In some embodiments, an irrigation device is not employed and water provided to the roots of the respective plants solely via absorption through an exposed region of the hydrophilic soil layer 104. In addition, the portion of the terrain covered with the hydrophobic capillary layer 102 can also vary. As discussed supra, the rate of water evaporation from the hydrophilic soil layer 104 is decreased as the proportion of the hydrophilic soil layer 104 covered with a hydrophobic capillary layer 102 is increased. Accordingly, in various implementations the entire surface area or substantially the entire surface area of the hydrophilic soil layer 104 is covered with a hydrophobic capillary layer 102. In other implementations, a portion of the hydrophilic soil layer 104 can be exposed, (e.g., not covered with the hydrophobic capillary layer 102), to facilitate absorption of water into the hydrophilic soil layer 104. Furthermore, the surface topology of the terrain can vary. For example, in some embodiments, a plurality of ditches or trenches can be provided between respective plants or trees. In another embodiment, the surface topology can be planar or substantially planar. Repetitive description of like elements employed in respective embodiments described herein is omitted for sake of brevity.

With reference now to FIG. 14, presented is an aerial view of an example agriculture system configuration 1400 in accordance with an embodiment. Configuration 1400 is referred to herein as a “5-spot” configuration because it includes five elements located at substantially equal distances from one another in square area. The five elements include four trees located at respective corners of the square area and an irrigation device 908 located at the center point of the square area. The dashed, curved arrows indicate the surface topology of the terrain is non-planner and slopes downward in the direction of the dashed, curved arrows towards the irrigation device 908. For example, the terrain around the irrigation device 908 can slope downward in a reverse conical or pyramid shape with the irrigation device 908 being at the lowest point/altitude of the terrain. The respective trees are located at a higher level or altitude of ground than the irrigation device 908.

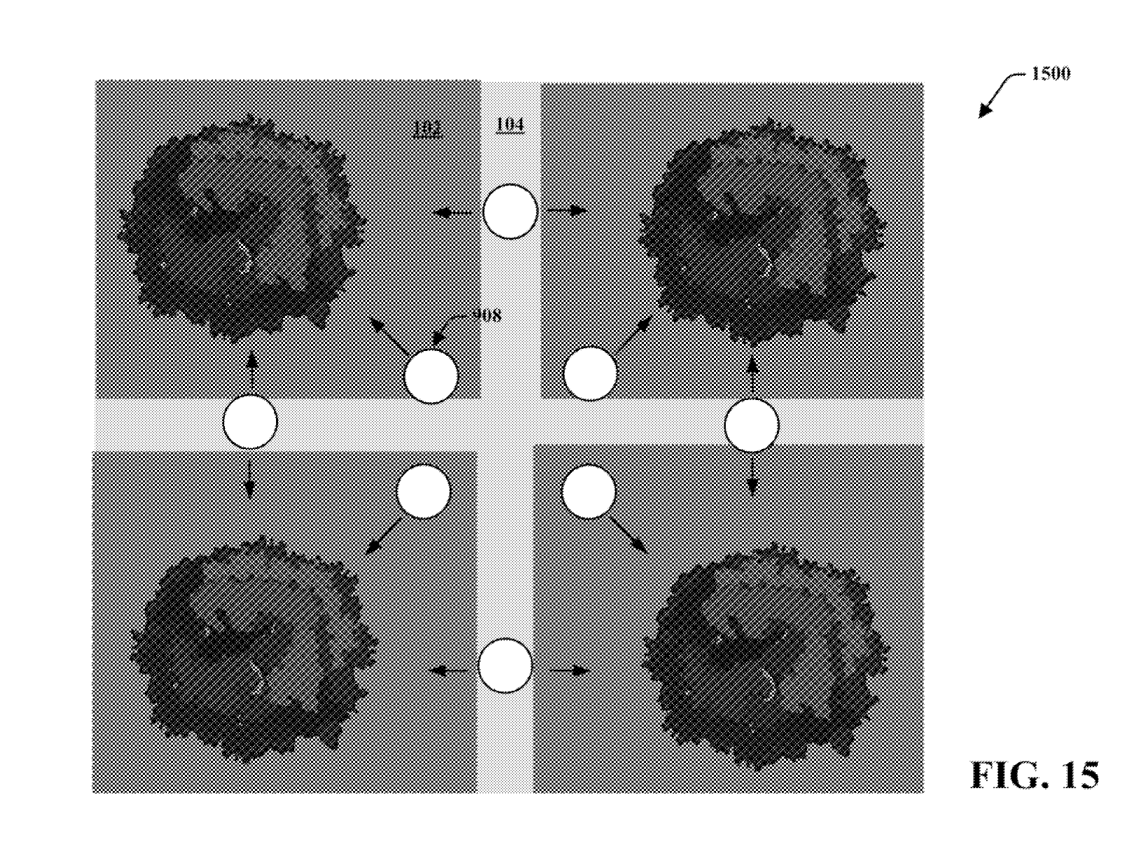

FIG. 15 presents another aerial view of an example agriculture system configuration 1500 in accordance with another embodiment. The surface topology of the terrain is non-planner and slopes downward towards the irrigation devices 908 located within an exposed portion of the hydrophilic soil layer 104. The respective trees are located at a higher level or altitude of ground than the irrigation devices 908. Configuration 1500 is substantially similar to that of configuration 1400 with the difference being the number and arrangement of irrigation devices and exposure of a portion of the hydrophilic soil 104. For example, in the embodiment shown, six irrigation devices 908 are disposed through various low lying regions of the terrain. The respective irrigation devices 908 are configured to distribute collected water under the hydrophobic capillary layer 102 to the roots of the respective trees in the directions represented by the small arrows.

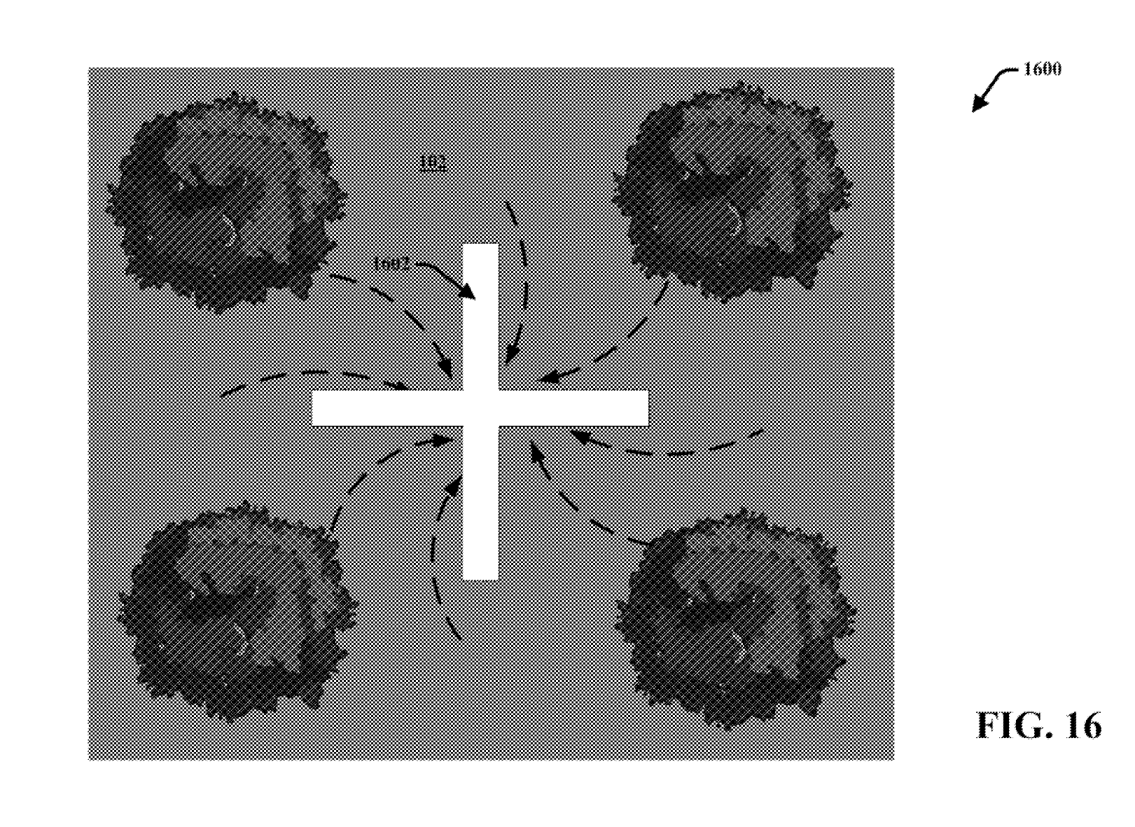

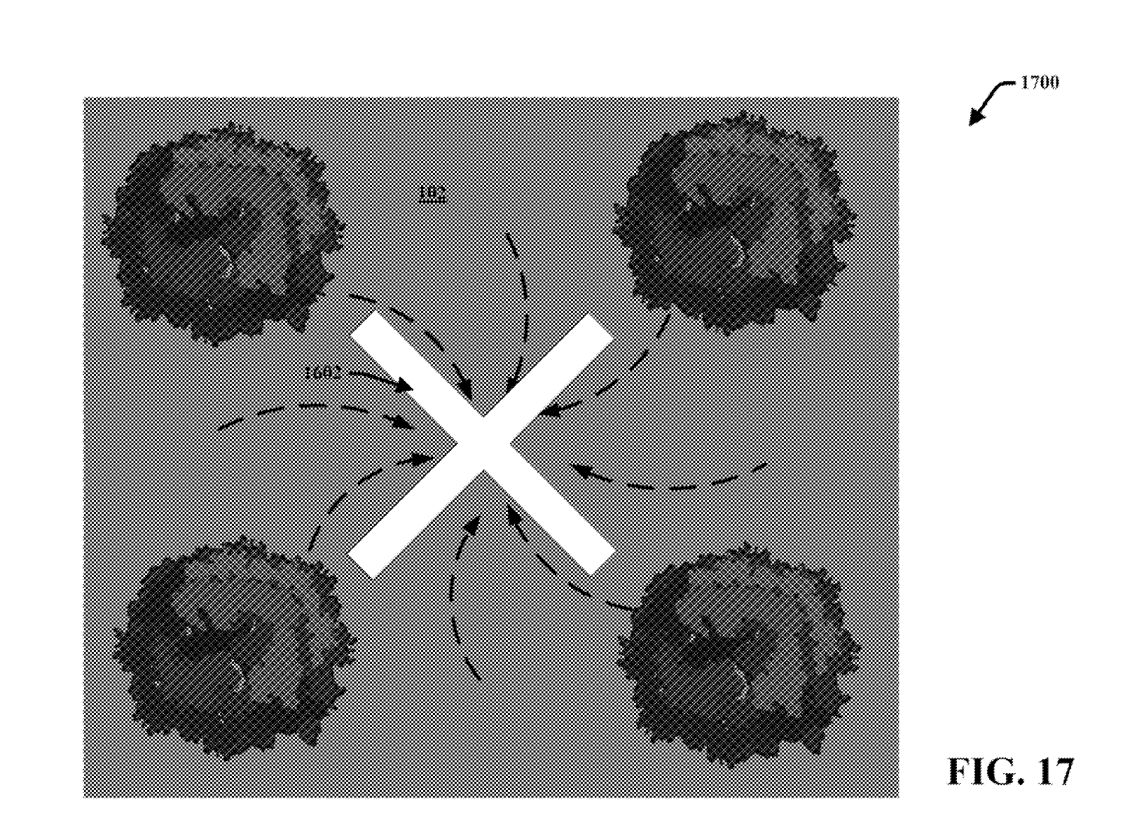

FIG. 16 presents another example agriculture system configuration 1600 in accordance with another embodiment. Configuration 1600 is substantially similar to that of configuration 1400 with the difference being the type and/or shape of the irrigation device employed. For example, in the embodiment shown, the irrigation device 1602 has a cross shape with collection troughs or arms that and span in vertical and horizontal directions relative to the corners of the square area. FIG. 17 presents another example agriculture system configuration 1700 in accordance with a similar embodiment. Configuration 1700 is substantially similar to that of configuration 1400 with the difference being that the irrigation device 1602 is positioned such that the arms of the irrigation device 1602 span in diagonal directions relative to the corners of the square area. The dashed, curved arrows of configurations 1600 and 1700 indicate the surface topology of the terrain is non-planner and slopes downward in the direction of the dashed, curved arrows towards the irrigation device 1602. For example, the terrain around the irrigation device 1602 can slope downward in a reverse conical or pyramid shape with the irrigation device 1602 being at the lowest point/altitude of the terrain. The respective trees are located at a higher level or altitude of ground than the irrigation device 1502.

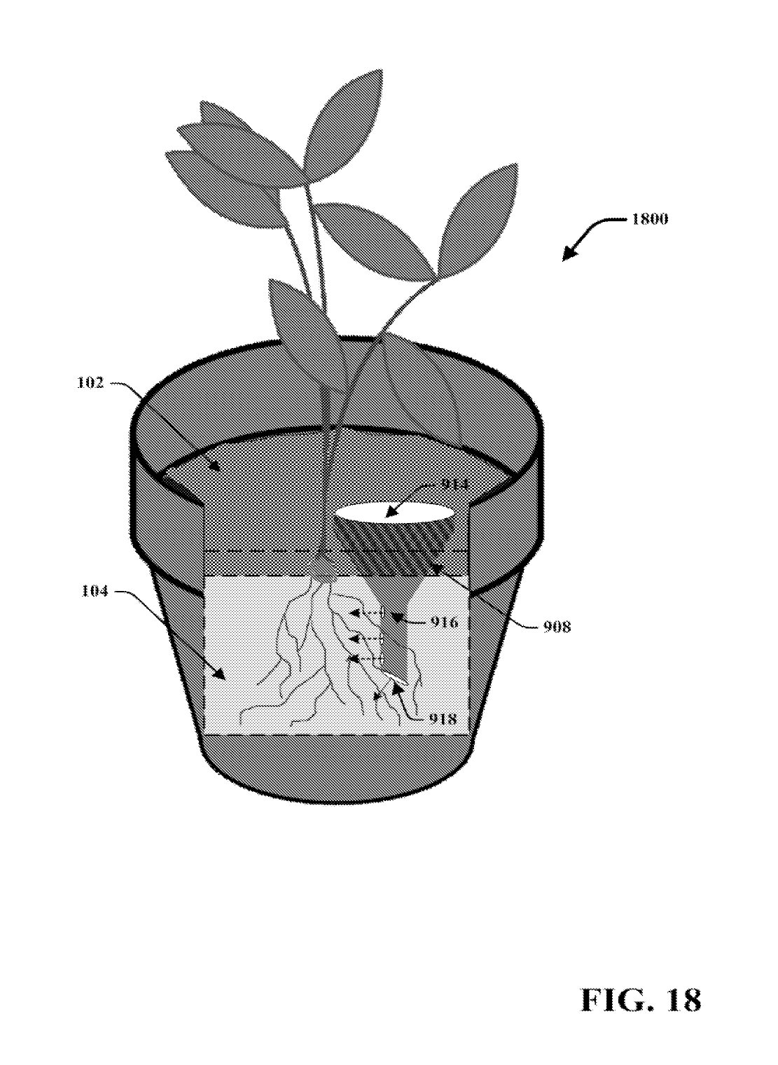

FIG. 18 presents another example agriculture system 1800 employing a hydrophobic capillary layer (e.g., hydrophobic capillary layer 102) to facilitate water retention in soil in accordance with various aspects and embodiments described herein. System 1800 demonstrates application of the subject hydrophobic capillary layer 102 to a potted plant. System 1800 includes a plant planted within a hydrophilic soil layer 104 with a hydrophobic capillary layer 102 formed over the surface of the hydrophilic soil layer 104. An irrigation device 908 is inserted through the hydrophobic capillary layer 102 and into the hydrophilic soil layer 104 to facilitate provision of water, poured through the irrigation device 908, into the hydrophilic soil layer 104. Liquid water 114 enters through the wide opening 914 and is expelled (e.g., as indicated by the dashed arrows) into the hydrophilic soil layer 104 via the side openings 916 and/or the small openings 918) of the funnel located within the hydrophilic soil layer 104. In accordance with this embodiment, the hydrophobic capillary layer 102 can be permanent. The hydrophobic capillary layer 102 inhibits evaporation of water from the hydrophilic soil layer 104 while allowing water vapor, sunlight, oxygen, and other gaseous nutrients to pass. Repetitive description of like elements employed in respective embodiments described herein is omitted for sake of brevity.

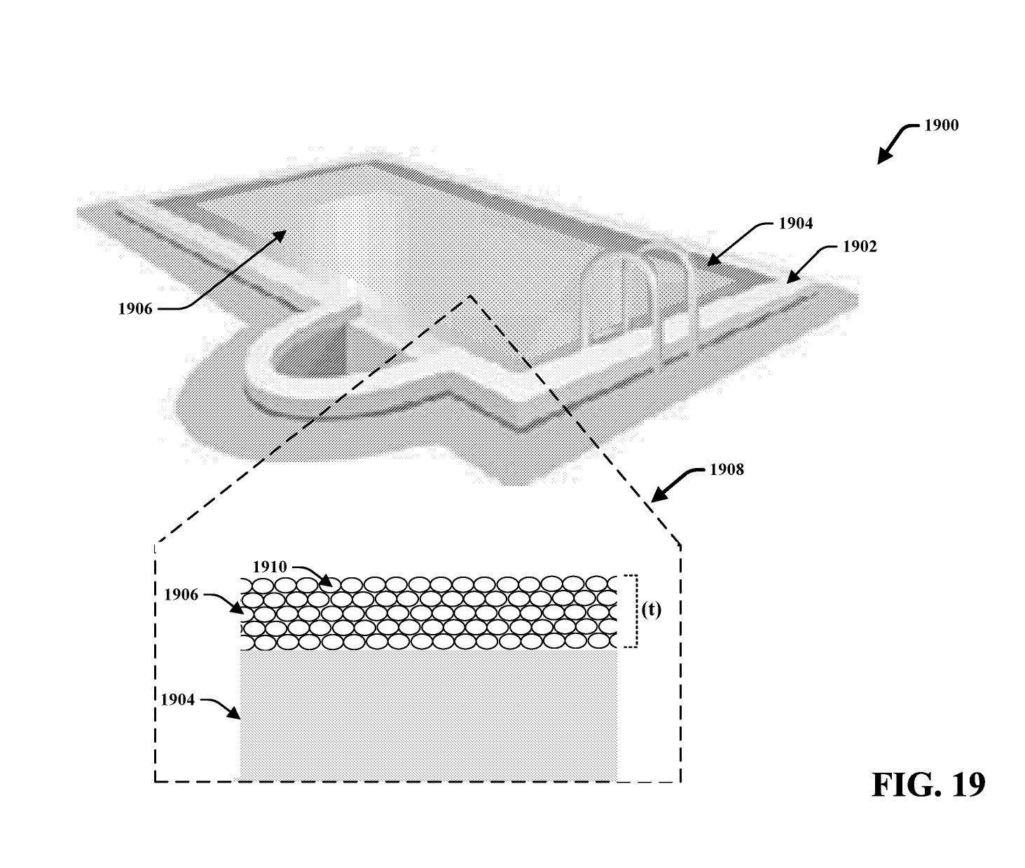

Turning now to FIG. 19, presented is an example system 1900 that facilitates reducing the rate of evaporation of water from an open body of water in accordance with various aspects and embodiments described herein. Repetitive description of like elements employed in respective embodiments described herein is omitted for sake of brevity.

System 1900 includes a pool 1902 filled with water 1904 and having a hydrophobic capillary layer 1906 formed on a surface of the water. In various embodiments, hydrophobic capillary layer 1906 can include or similar features, properties and functionality as hydrophobic capillary layer 102. In should be appreciated that although system 1900 is exemplified using an enclosed pool, hydrophobic capillary layer 1906 can be employed to facilitate increasing water retention by any open body of water (e.g., lakes, ponds, rivers, reservoirs, etc. The word ‘open’ is used in this context to indicate that the body of water is subject to evaporation, and is otherwise not enclosed or sealed. Similar to the effect on soil, when a hydrophobic capillary layer (e.g., hydrophobic capillary layer 1906) is formed at the water/air interface of a body of water, the water meniscus cannot rise through the hydrophobic channels of the hydrophobic capillary layer. This decreases the diffusion resistance for water evaporation from the water at the surface of the water. As a result, the rate of water evaporation at the water/air interface is reduced.

Call out box 1908 presents an enlarged side view perspective of the hydrophobic capillary layer 1906 formed on the body of water 1904 in accordance with one or more embodiments. The hydrophobic capillary layer 1906 includes a layer of hydrophobic particles that are deposited onto the body of water. The hydrophobic particles 1910 are configured to float on the surface of the water 1904 and cluster or group together to form a plurality of hydrophobic capillaries when deposited on the surface of the water. For example, the particles can have a density less than 1.0 g/mL, thereby facilitating floatation on the surface of the open body of water. In other implementations, the hydrophobic particles can have a density higher than water (e.g., PTFE, PMMA, and the like). According to these implementations, the hydrophobicity of the respective particles, surface tension forces, and high contact angle of the respective particles, can overcome the weight of the particles (up to certain size), and the particles will float (e.g., similar to a steel needle floating on water). For example, the hydrophobic particles 1910 can include a natural or hydrophilic material that is formed into particles and coated with a hydrophobic coating (e.g., soil particles, cellulose based particles). In another embodiment, the hydrophobic particles can be formed via a synthetic hydrophobic polymer material (e.g., PTFE, PMMA, or another suitable hydrophobic material).

The size and shape of the hydrophobic particles 1910 can vary. In an exemplary embodiment, the hydrophobic particles are spherical or substantially spherical. The thickness (t) of the hydrophobic capillary layer 1906 can also vary. The thickness of the hydrophobic capillary layer 1906 and the size of the hydrophobic particles 1910 can be adapted to control the rate of evaporation of the water 1904. For example, the rate of evaporation of water from an open body of water having a hydrophobic capillary layer 1906 formed thereon is decreased as the length the hydrophobic capillaries is increased and the tortuosity of the hydrophobic capillaries is increased. The length of the hydrophobic capillaries is increased as the thickness of the hydrophobic layer 1906 is increased and the tortuosity of the hydrophobic capillaries is increased as the size of the hydrophobic particles in decreased. In an exemplary embodiment, the hydrophobic capillary layer 1906 has a thickness between about 3.0 mm to about 30.0 mm, and preferably about 20.0 mm The diameter of the hydrophobic particles 1910 is preferably less than or equal to about 2.0 mm, more preferably less than or equal to about 1.0 mm, and even more preferably less than or equal to about 0.5 mm

In another embodiment, hydrophobic capillary layer 1906 can include a sheet of a plurality of joined hydrophobic capillaries. For example, FIG. 20 presents an example hydrophobic capillary layer sheet 2000 in accordance with one or more embodiments described herein. Call out box 2001 presents a cross-sectional view of the hydrophobic capillary layer sheet 2000 taken along axis A. In various embodiments, the hydrophobic capillary layer sheet 2000 can be employed as the hydrophobic capillary layer 1906. In some embodiments, the hydrophobic capillary layer sheet 2000 can be employed to cover soil to facilitate water retention in the soil. In the embodiment shown, the hydrophobic capillary layer sheet 2000 includes a plurality of attached cylindrical hydrophobic capillaries. The thickness of the sheet and the diameters of the respective capillaries can vary. In an exemplary embodiment, the thickness of the sheet is less than 2 cm and preferably less than or equal to 1 cm. The materials employed to form the hydrophobic capillary layer sheet 2000 can vary. For example, the sheet can include a textile including hydrophobic fibers that form the plurality of hydrophobic capillaries. In another example, the sheet can include a particulate board (e.g. 4 ft×8 ft) of variable thickness of hydrophobic materials with hydrophobic pores that establish hydrophobic capillaries.

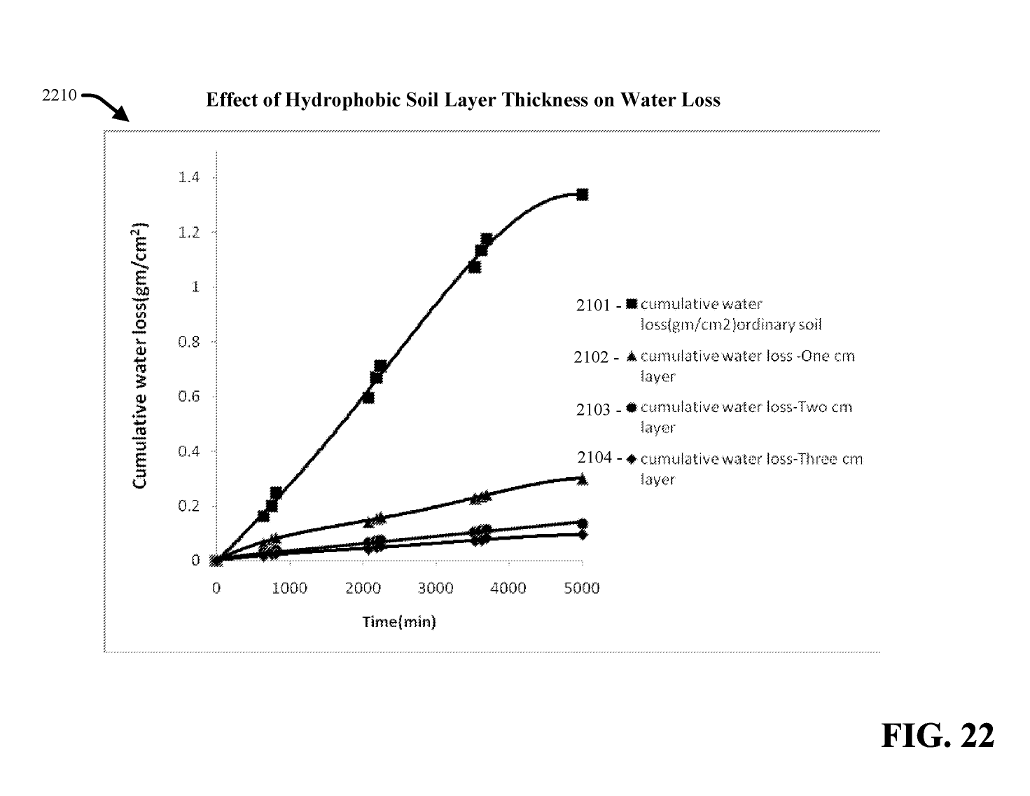

FIGS. 21-22 are related to a first experiment that examined the effect of thickness of a hydrophobic capillary layer (e.g., hydrophobic capillary layer 102) has on water loss from saturated hydrophilic soil when provided over the saturated hydrophilic soil. The first experiment aimed to estimate a minimum quantity of hydrophobic soil needed to achieve an optimal or desired reduction in evaporation rate. The first experiment involved a hydrophobic capillary layer 102 formed via soil particles respectively coated with a hydrophobic coating, also generally referred to herein as hydrophobic soil. The hydrophobic soil was prepared using ordinary soil including 3.35% course sand, 75.50% fine sand, 10.25% silt, 6.75% clay. The ordinary soil had a sandy loam texture, a bulk density of 1.36 gm/cc, and a liquid water holding capacity of 38.51%. A commercially available organosilane compound, Zycosil^{TM} was used to coat the ordinary soil to transform it into hydrophobic soil.

The hydrophobic soil was prepared by diluting the organosilane compound with water at ratio of 1:10 Zycosil to water (i.e., 1.0 mL Zycosi™l to 10.0 mL water) and mixing with soil 25 grams of the ordinary soil. This was followed with drying of the treated soil in an open an atmosphere for 3 days (or 72 hours).

FIG. 21 provides a pictorial representation of the first experiment. The first experiment was conducted by layering the top surface of ordinary soil (e.g., hydrophilic soil layer 104) with hydrophobic soil (e.g., hydrophobic capillary layer 102) of varying thicknesses in separate beakers 2102-2104. A control beaker 2101 was also used that included ordinary soil without a layer of hydrophobic soil formed thereon. The respective beakers 2100-2400 have a diameter of 8 cm and a height of 12.0 cm. Each of the respective beakers included approximately 450 gm of ordinary soil saturated with 190 mL of water resulting in the ordinary soil having 42.2% liquid water content. A 1.0 cm layer of hydrophobic soil (e.g., hydrophobic capillary layer 102) was deposited over the ordinary soil in beaker 2102. A 2.0 cm layer of hydrophobic soil was deposited over beaker 2103, and a 3.0 cm layer of hydrophobic soil was deposited over beaker 2104. The respective beakers 2101-2104 were then subjected to ambient conditions for 3.5 days (i.e., 84 hours). In particular, the respective beakers were located in an external environment over the duration of 84 hours and exposed to natural conditions of sunlight, humidity and temperature (e.g., ranging from about 25° C. to about 30° C.). The cumulative water loss was then measured for each beaker.

FIG. 22 presents graph 2200, entitled “effect of hydrophobic soil layer thickness on water loss,” presenting the results of the first experiment. The cumulative water loss was measured in terms of gm/cm². As seen in graph 2200, beakers 2102-2104, which included a layer of hydrophobic soil thereon, demonstrated a substantial reduction in amount of water loss relative to the control beaker 2101, which did not include a hydrophobic soil layer. For example, the cumulative water loss for beakers 2102-2104 relative to beaker 2101 after 5000 minutes of exposure to ambient conditions demonstrated a comparative reduction in rate of water evaporation by 77.5%, 89.6%, and 92.8% respectively. Graph 2200 also demonstrates that the cumulative water loss decreased as the thickness of the hydrophobic soil layer increased. For example, at 5000 minutes, the cumulative water loss for beaker 2101 including the 1 cm layer of hydrophobic soil was about 0.3 gm/cm². At 5000 minutes, the cumulative water loss for beaker 2103 including the 2 cm layer of hydrophobic soil was about 0.12 gm/cm², and at 5000 minutes, and at 5000 minutes, the cumulative water loss for beaker 2104 including the 3 cm layer of hydrophobic soil was about 0.07 gm/cm².

The effect of hydrophobic soil layer thickness on water evaporation suggests that the cumulative water loss decreases with the increase in thickness of the hydrophobic capillary layer. It is also observed that the diffusion resistance of water molecules with increase of hydrophobic layer thickness from 2.0 cm to 3.0 cm has little significant effect on reduction in cumulative evaporation of water from soil. Hence a hydrophobic soil layer having a thickness from about 1.0 cm to about 2.0 cm is an economical and optimum means for retardation of evaporation of water from soil.

Referring back to FIG. 4, a comparison between values representative of the theoretical effect of hydrophobic capillary layer 102 on water flux N_{A} presented in table 400 and the results of the first experiment provides confirmation that the increase in water retention by wetted soil covered with a hydrophobic capillary layer is attributed to diffusion resistance. In particular, similar to the results of the first experiment, the values included in table 400 obtained using diffusion theory (e.g., Equation 1) demonstrate a clear increase in water retention as a thickness of the hydrophobic capillary layer is increased.

The difference in values of water retention relative to hydrophobic layer thickness found via the first experiment and the theoretical calculation can be attributed to tortuosity of the hydrophobic capillaries of the subject hydrophobic capillary layer. For example, the theoretical values in table 400 were based on an assumption that the hydrophobic capillaries had a cylindrical geometry. In reality, the hydrophobic capillaries of a hydrophobic capillary layer formed via coated soil particles (e.g., hydrophobic capillary layer 102) are not cylindrical by have irregular twists and turns. For example, water evaporation through a hydrophobic soil layer of 1 cm thickness in the first experiment was about 4.0 mg/cm²/hr. In contrast the corresponding theoretical value for a 1 cm thick hydrophobic capillary layer is 21.7 mg/cm²/hr. The apparent reduction in evaporation through hydrophobic capillaries can be accounted for in terms of tortuosity of capillaries. The ratio of the theoretically predicted value to that of experimental value is 5.4:1. This suggests that water vapor diffusion through a 1 cm linear distance of hydrophobic soil is equal to 5.4 cm length of diffusion path due to tortuosity of the soil capillaries. Interestingly this approach of transport of water vapor through hydrophobic capillaries can be used to determine the tortuosity of the hydrophobic capillaries of a hydrophobic capillary layer 102.

In addition, based on the above observation, it can be concluded that the amount of water retention by soil (or open body of water) can be increased as the tortuosity of the hydrophobic capillaries is increased. Accordingly, in various embodiments the thickness of the hydrophobic capillary layer 102 can be decreased while maintaining a same or substantially same degree of water retention in the hydrophilic soil over which the hydrophobic capillary layer 102 is formed by increasing the tortuosity of the hydrophobic capillaries (e.g., the hydrophobic capillaries 112). As discussed supra, one mechanism to increase the tortuosity of the hydrophobic capillaries involves decreasing the dimensions of the hydrophobic particles employed to form the hydrophobic capillary layer 102.

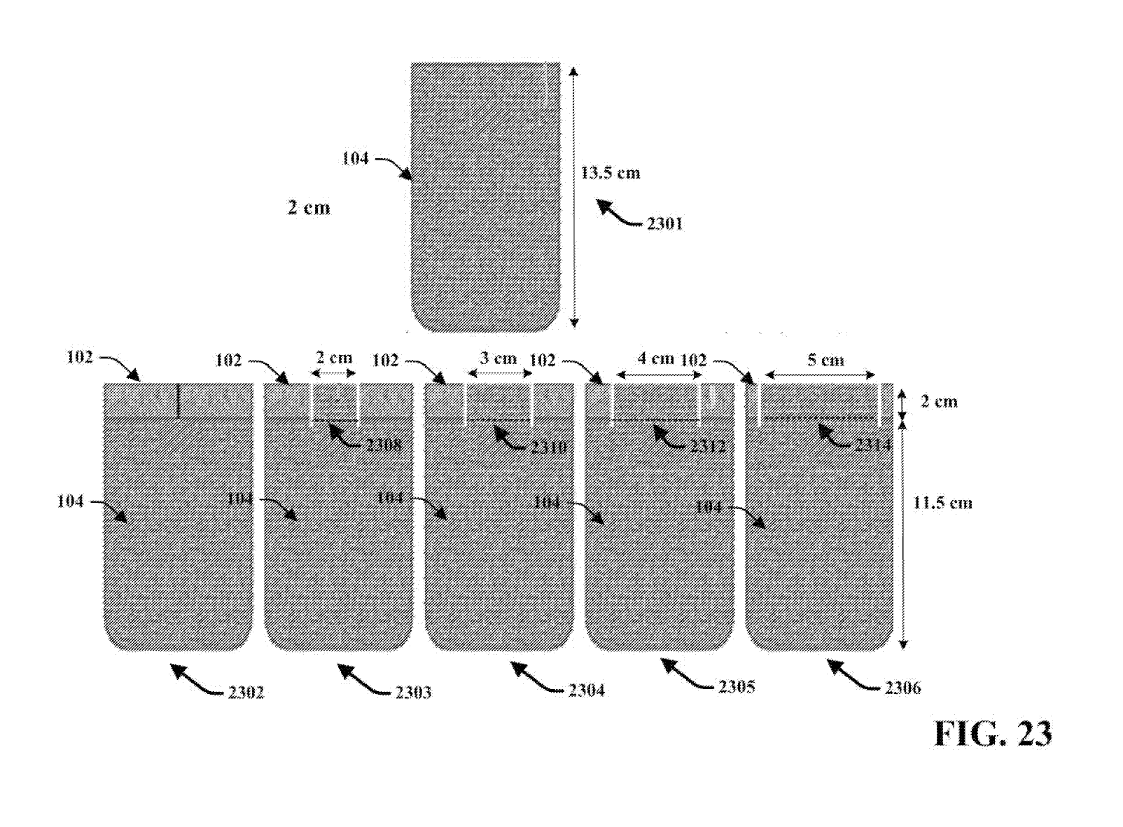

FIGS. 23-26 are related to a second experiment that examined the effect of hydrophobic soil layer coverage on water loss from saturated hydrophilic soil when provided over the saturated hydrophilic soil. The second experiment also aimed to estimate a minimum quantity of hydrophobic soil coverage needed to achieve an optimal or desired reduction in evaporation rate. The second experiment involved applying a layer of hydrophobic soil over different coverage amounts of ordinary soil. For example, as exemplified in FIG. 6, a circular area (e.g., circular area 605) of hydrophobic soil having a diameter d₁ can be formed within a ring of hydrophobic soil. In the second experiment, this circular area of hydrophilic soil is referred to as an ‘island.’ The second experiment particularly examined the effect of island size relative to hydrophobic soil coverage on water retention. The hydrophobic soil used in the second experiment was prepared in the same manner as the hydrophobic soil used in the first experiment.

FIG. 23 provides a pictorial representation of the second experiment. The second experiment was conducted by layering the top surface of ordinary soil (e.g., hydrophilic soil layer 104) with a layer of the hydrophobic soil (e.g., hydrophobic capillary layer 102) in separate glass beakers 2302-2306. A control beaker 2301 was also used that included ordinary soil without a layer of hydrophobic soil thereon. The respective beakers 2301-2306 had a diameter of 8.0 cm and a height of 13.5 cm. A vertical cross-section of the respective beakers taken across the diameters of the respective beakers is depicted in FIG. 23.

Each of the respective beakers included approximately 500 gm of ordinary soil filled to a height of about 11.5 cm from the bottoms of respective beakers 2302-2306. The control beaker 2301 was filled to the brim with ordinary soil. 190 mL of water was poured into each beaker 2301-2306 to saturate the normal soil to a water or moisture content of 38%. Beaker 2302 was then filled with a 2.0 cm thick layer of hydrophobic soil which completely covered the surface of the ordinary soil in beaker 2302. For beakers 2303-2306, circular islands 2308, 2310, 2312, and 2314 of ordinary soil surrounded by rings of hydrophobic soil were respectively formed using circulars molds made out of strips of paper that were respectively formed into rings (e.g., via connecting opposite ends of the strips of paper with an adhesive) having diameters of 2.0 cm, 3.0 cm, 4.0 cm and 5.0 cm, respectively. The molds (i.e., the strips of paper) had a height/width of 3.0 cm. The molds were respectively placed in the center of each beaker 2303-2306 on top of the normal soil. The molds where then filled with 2 cm of normal soil. The spaces on the outside of the molds (e.g., the rings formed by the space between the mold and the inner sides of the beakers) were filled with 2.0 cm of hydrophobic soil. Thereafter, the molds were removed. The respective beakers were then subjected to ambient conditions (e.g., in an external environment exposed to natural sunlight, humidity and temperatures from about 25° C. to about 30° C.) for about 7 days (i.e., 166.7 hours). The above described set up for the second experiment was repeated replicated three times (e.g., three identical or substantially identical replicas of beakers 2301-2306 were formed and tested). The cumulative water loss was then measured for each beaker.

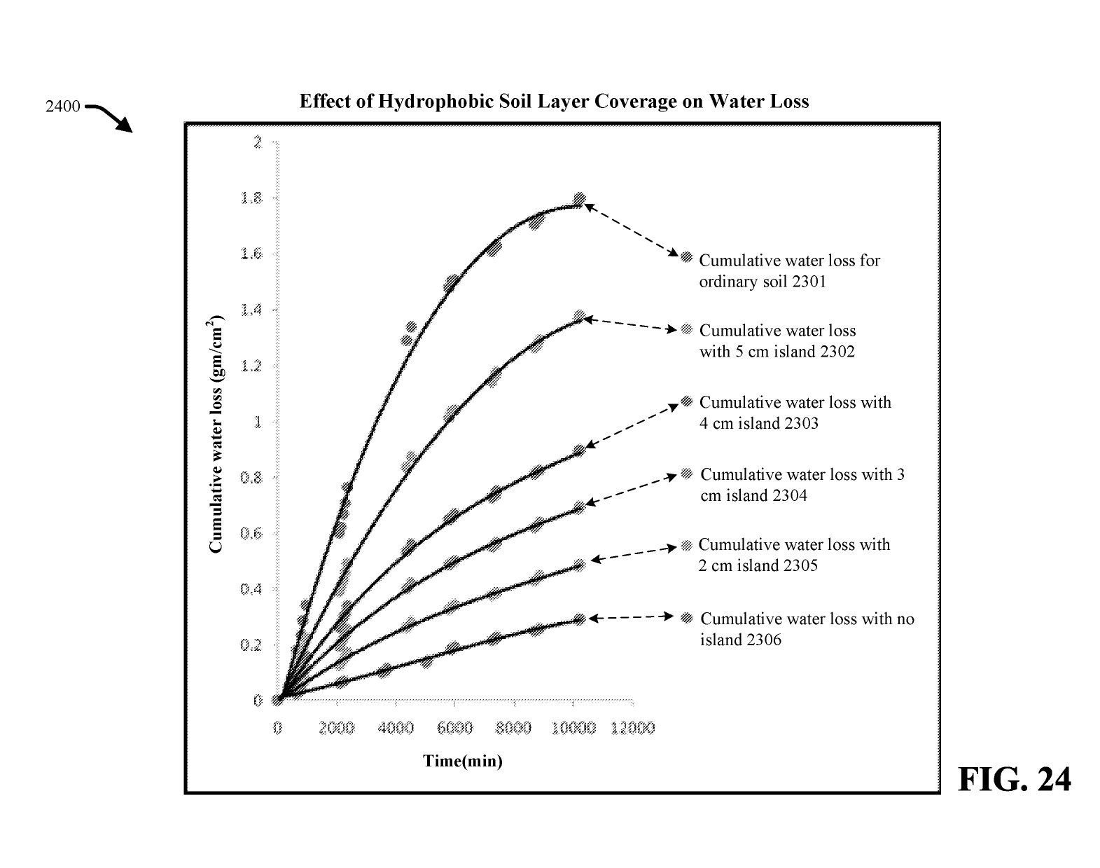

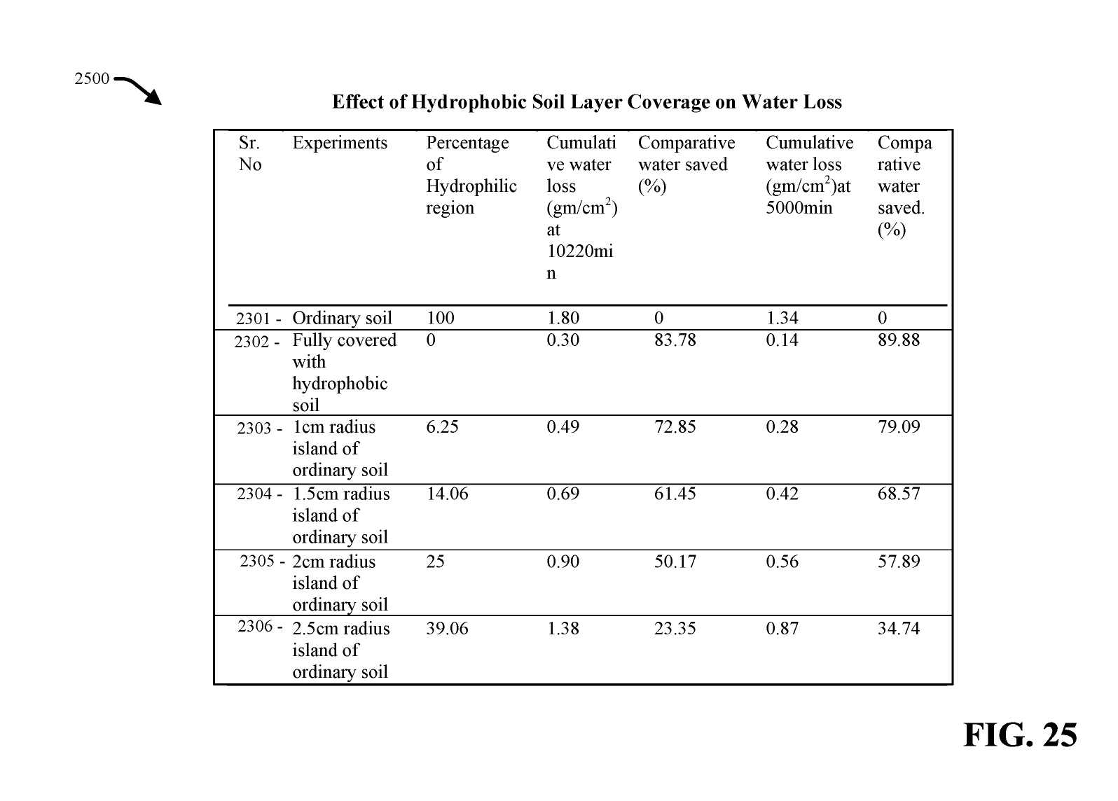

FIG. 24 presents graph 2400, entitled “effect of hydrophobic soil layer coverage on water loss,” presenting the results of the second experiment. The cumulative water loss was measured in terms of gm/cm². FIG. 25 provides a table 2500 with averaged measured parameters for respective beakers 2301-2306 evaluated in the second experiment. As seen in graph 2400 and table 2500, beakers 2302-2006, which included a layer of hydrophobic soil thereon, demonstrated a substantial reduction in amount of water loss relative to the control beaker 2301, which did not include a hydrophobic soil layer. Graph 2400 and table 2500 also demonstrate that the cumulative water loss decreased as the diameter of the respective islands 2314, 2312, 2310, and 2308 decreased.

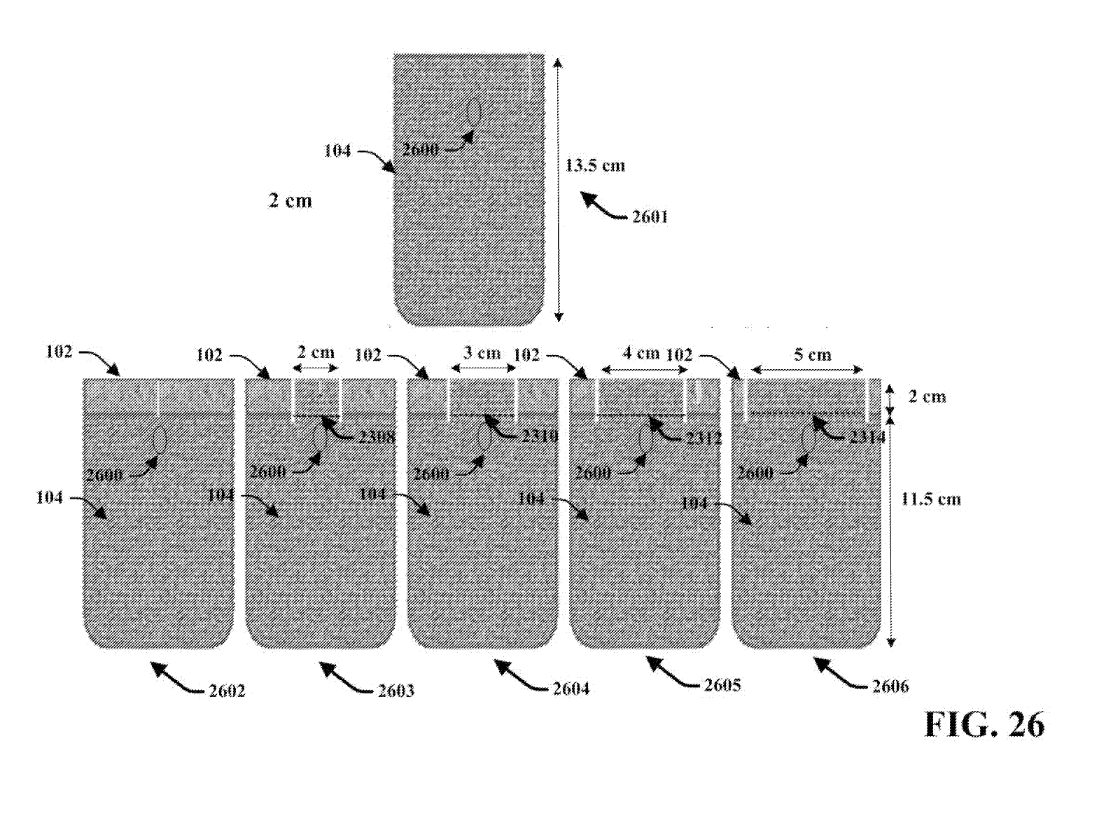

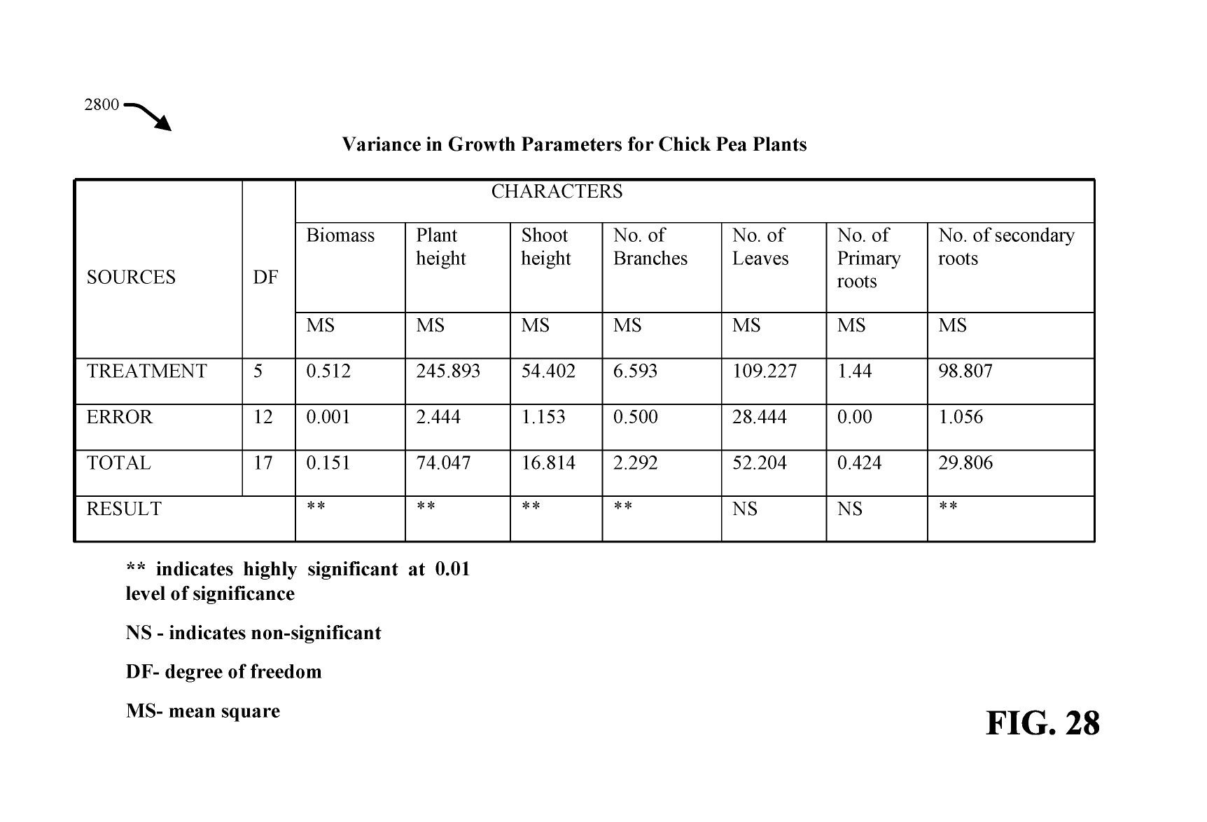

FIGS. 26-28 are related to a third experiment that examined the effect of hydrophobic soil layer coverage over ordinary soil on plant growth. In the third experiment, the influence of restoring more water in soil was extended to study the enhancement in plant growth using a variety of the cicer arietinum plant (otherwise known as the chick pea plant) locally known as Chaffa. The third experiment involved the same or substantially the same materials, parameters, testing conditions and set up as the second experiment with the addition of a cicer arietinum seeds 2600 embedded into the hydrophilic soil layer 104. The islands 2314, 2312, 2310, and 2308 of hydrophilic soil were used to allow for germination of the seeds. It should be appreciated however that many seed types (e.g., corn seeds) can break through a hydrophobic capillary layer (e.g., formed with hydrophobic soil) and thus may not require an island of hydrophilic soil. Repetitive description of like elements employed in the second experiment and the first experiment are omitted for sake of brevity.

FIG. 26 provides a pictorial representation of the third experiment. As with the second experiment, the third experiment was conducted by layering the top surface of ordinary soil (e.g., hydrophilic soil layer 104) with a layer of the hydrophobic soil (e.g., hydrophobic capillary layer 102) in separate beakers 2602-2606. A control beaker 2601 was also used that included ordinary soil without a layer of hydrophobic soil thereon. The beakers 2601-2606 were made of clay having a cylindrical shape which was laid out in completely randomized design (CRD). The respective beakers 2601-2606 had a diameter of 8 cm and a height of 13.5 cm. A vertical cross-section of the respective beakers taken across the diameters of the respective beakers is depicted in FIG. 26.

Each of the respective beakers included approximately 500 gm of ordinary soil filled to a height of about 10.5 cm from the bottoms of respective beakers 2602-2606. Seeds 2600 where then dropped into the respective beakers at the center point or substantially the center point of the respective beakers. 190 mL of water was poured into each beaker 2201-2206 to saturate the normal soil to a water content of 38%. The control beaker 2601 was then filled to the brim with ordinary soil. An additional 1.0 cm layer of normal soil was then deposited over the ordinary soil and the seeds 2600 respectively included in each of the beakers 2602-2606 to bring the normal soil level to 11.5 cm above the bases of the respective beakers.

Beaker 2602 was then filled with a 2.0 cm thick layer of hydrophobic soil which completely covered the surface of the ordinary soil in beaker 2602. For beakers 2603-2606, circular islands 2308, 2310, 2312, and 2314 of ordinary soil surrounded by rings of hydrophobic soil were respectively formed using circulars molds (made out of strips of paper) that were respectively formed into rings having diameters of 2.0 cm, 3.0 cm, 4.0 cm and 5.0 cm, respectively. The molds had a height/width of 3.0 cm. The molds were respectively placed in the center of each beaker 2603-2606 on top of the normal soil. The molds where then filled with 2 cm of normal soil. The spaces on the outside of the molds (e.g., the rings formed by the space between the mold and the inner sides of the beakers) were filled with 2 cm of hydrophobic soil. Thereafter, the molds were removed. The respective beakers beakers were then subjected to ambient conditions for about 6 days. The above described set up for the third experiment was repeated replicated three times (e.g., three identical or substantially identical replicas of beakers 2601-2606 were formed and tested). The cumulative water loss was then measured for each beaker.

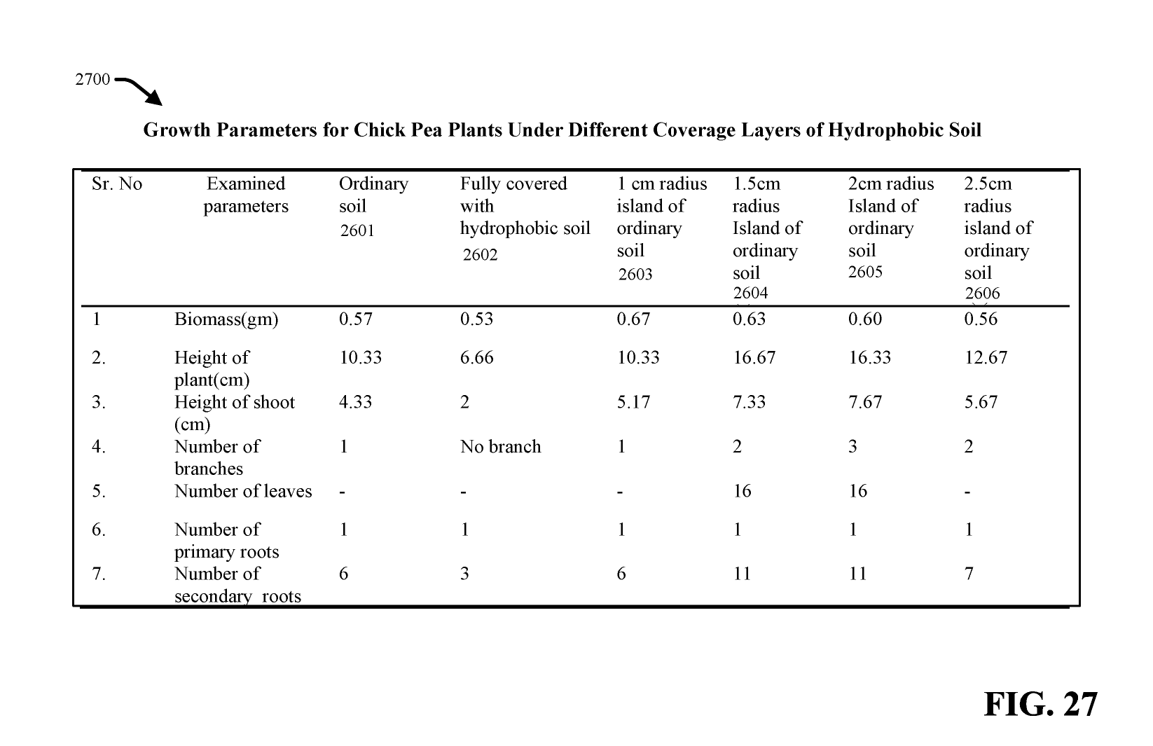

FIG. 27 provides a table 2700 entitled “growth parameters for chick pea plants under different coverage layers of hydrophobic soil.” Table 2700 provides results of the third experiment, including average growth parameters for respective cicer arietinum plants (i.e., chick pea plants) grown from the seeds 2600 planted in beakers 2601-2606 under the conditions of the third experiment. The growth parameters include average biomass of the respective plants, average heights of respective plants, average shoot height of the respective plants, number of branches, number of leaves, number of primary roots, and number of secondary roots. The biomass was reported as green biomass. The height of the plant was reported as the sum of height of shoot and height of root. The height of shoot was reported as length of shoot from seed to the tip of shoot. All the above parameters were reported as the average of the three replications for each beaker 2601-2606.

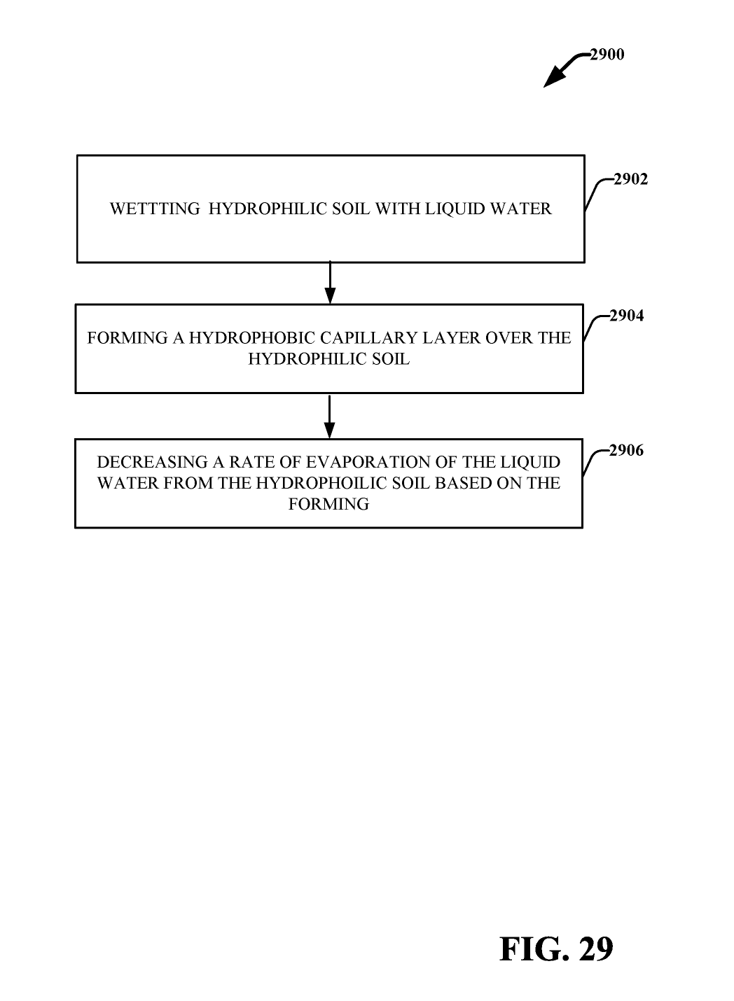

As presented in table 2700, the growth response of the cicer arietinum plant planted in beaker 2601 without the hydrophobic soil layer is significantly lower in comparison to the growth response for the plants in beakers 2602-2606 grown under hydrophobic soil. Considering height of plant, height of shoot, and number of secondary roots, it was found that the growth parameters increased for plants planted in beakers 2602-2605 and thereafter decreased for plants planted in beaker 2606. Considering the number of branches, it was found that there was no branch in sets of beakers with fully covered hydrophobic soil (e.g., beaker 2502) but the number of branches increases for plants planted in beakers 2603-2605. The number of branches decreased for plants planted in beaker 2606. Although the studied growth parameters were reduced for plants grown in beakers 2606, they were still higher than those of the control beaker 2601. Considering biomass of the plant, it was found that the biomass of the plant was higher (as much as 16.5% in a six day interval) for plants grown in beakers 2603-2605 than that of the plants grown in the control beaker 2601. Considering number of primary roots and number of leaves, it was found that there was no significant difference between the test beakers and the control beaker change. However, leaves were found to blossom for plants planted in beakers 2604 and 2605. FIG. 29 provides a table 2900 entitled “variance in growth parameters for chick pea plants.” Table 2900 measurements summarize the variance between plant growth parameters for the respective cicer arietinum plants grown in beakers 2602-2606 in accordance with the third experiment. Experiments similar to the third experiment ware later performed using cicer arietinum plants and corn plants planted in clay pots (as opposed to glass beakers). These experiments demonstrated similar results of enhanced plant growth due to the usage of hydrophobic soil to reduce water evaporation form the hydrophilic soil in which the plants were planted.

In view of the example systems, apparatuses and experiments described herein, example methods that can be implemented in accordance with the disclosed subject matter can be further appreciated with reference to flowcharts in FIGS. 29-34. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. Furthermore, not all illustrated acts may be required to implement a method in accordance with the subject specification. Repetitive description of like elements employed in respective embodiments of systems and methods described herein is omitted for sake of brevity.

FIG. 29 presents a flow diagram of an example method 2900 for reducing a rate of water evaporation from hydrophilic soil in accordance with one or more embodiments described herein. At 2902, hydrophilic soil is wetted with liquid water. For example, a layer of normal or hydrophilic soil (e.g., hydrophilic soil layer 104) can be wetted with water to a suitable level of saturation that facilitates optimal growth of a seed or plant planted within the soil. The moisture or water holding capacity of the hydrophilic soil can vary depending on the physical make up and properties of the hydrophilic soil. In one or more embodiments, the liquid water holding capacity of the hydrophilic soil ranges from about 30% to about 60%.

At 2904, a hydrophobic capillary layer (e.g., hydrophobic capillary layer 102) is formed over the hydrophilic soil. The hydrophobic capillary layer can be formed in various manners and with various materials, as discussed supra with reference to FIG. 1. In an exemplary embodiment, the hydrophobic capillary layer includes a layer of hydrophilic soil particles (e.g., with a thickness from about 3.0 mm to about 30.0 mm) that have been respectively coated with a hydrophobic coating. The hydrophobic coating can include a suitable compound that attaches to the hydrophilic soil particles (e.g., via physical adsorption or chemisorption) and forms a monolayer on respective surfaces of the hydrophilic particles with hydrophobic chains extending away from the surfaces of the hydrophilic particles (e.g., as depicted in via hydrophobic soil 502 of FIG. 5). In one embodiment, the hydrophobic coating includes an organosilane based compound. In another embodiment, the hydrophobic coating includes a biodegradable compound configured to biodegrade within a defined period of time (e.g., about two weeks to sixteen weeks).

At 2906, a rate of evaporation of the liquid water from the hydrophilic soil is decreased based on the forming of the hydrophobic capillary layer. For example, the hydrophobic capillary layer includes a plurality of hydrophobic capillaries configured to inhibit the passage of liquid water there through while being permeable to sunlight, water vapor, oxygen, and other gases. The hydrophobic capillary layer thus serves as a diffusion barrier to water vapor molecules that are released from the surface of the hydrophilic soil. Because the hydrophobic capillary layer increases the diffusion resistance for water vapor molecules from the hydrophilic soil, formation of the hydrophobic capillary layer over the wetted hydrophilic soil decreases the rate of evaporation of liquid water from the hydrophilic soil (e.g., relative to the rate of evaporation of liquid water from soil without the hydrophobic capillary layer thereon).

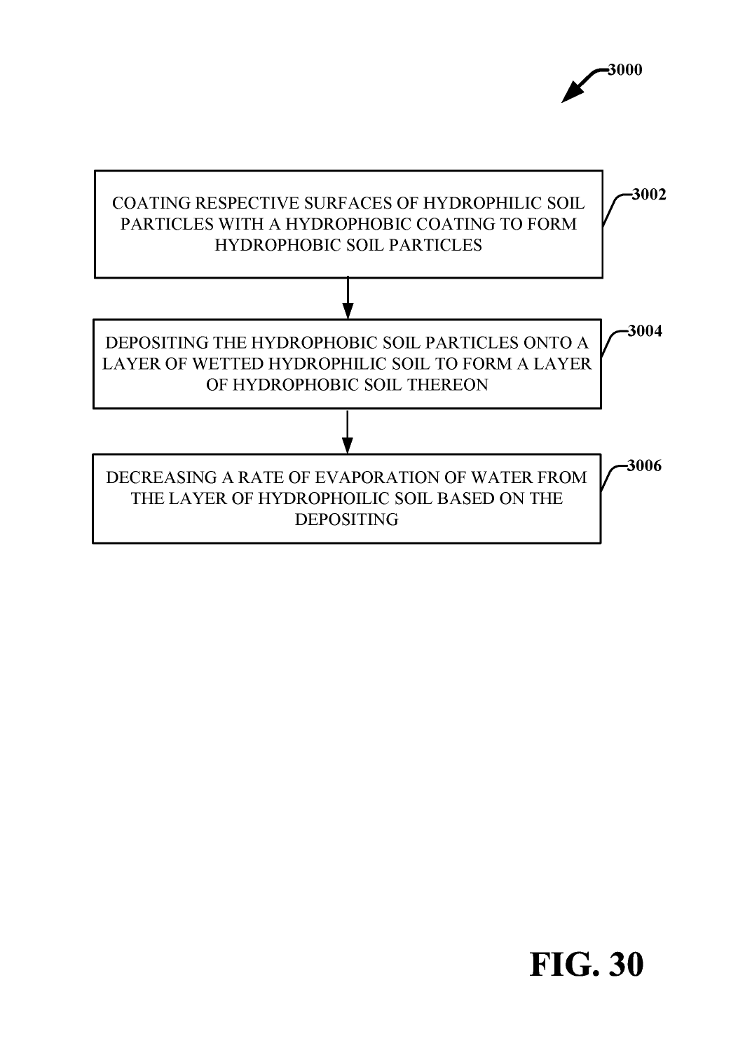

FIG. 30 presents a flow diagram of another example method 3000 for reducing a rate of water evaporation from hydrophilic soil in accordance with one or more embodiments described herein. At 3002, respective surfaces of hydrophilic soil particles (e.g., particles 108) are coated with a hydrophobic coating (e.g., hydrophobic coating 110) to form hydrophobic soil particles (e.g., hydrophobic soil 502). For example, the hydrophobic soil particles can be mixed into a solution or dispersion including a surfactant (e.g., a solution including a surfactant and water at a 1:10 ratio). The un-reacted or un-absorbed portion of the solution can be drained and the coated soil particles dried. The surfactant can include a suitable compound that attaches to the hydrophilic soil particles (e.g., via physical adsorption or chemisorption) and forms a monolayer on respective surfaces of the hydrophilic particles with hydrophobic chains extending away from the surfaces of the hydrophilic particles (e.g., as depicted via hydrophobic soil 502 of FIG. 5). In one embodiment, the surfactant includes an organosilane based compound. In another embodiment, the surfactant includes a biodegradable compound configured to biodegrade within a defined period of time (e.g., about two weeks to sixteen weeks).

At 3004, the hydrophobic soil particles are deposited onto a layer of wetted hydrophilic soil to form a layer of hydrophobic particles thereon (e.g., having a thickness of about 3.0 mm to about 30.0 mm). The size, shape, and texture of the hydrophobic soil particles facilitate the natural formation of a porous soil aggregate structure when the hydrophobic soil particles are deposited. This aggregate structure serves as the hydrophobic capillary layer with the respective pores or channels of the aggregate structure establishing the hydrophobic capillaries. At 3006, a rate of evaporation of water from the hydrophilic soil is decreased based on the depositing of the hydrophobic soil particles.

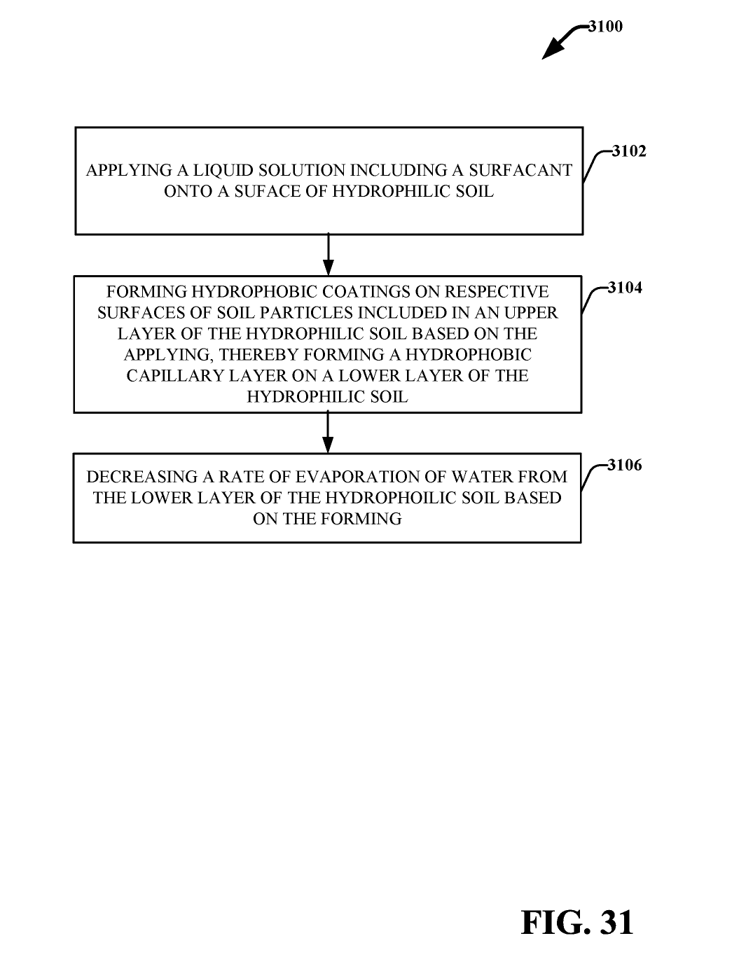

FIG. 31 presents a flow diagram of another example method 3100 for reducing a rate of water evaporation from hydrophilic soil in accordance with one or more embodiments described herein. At 3102, a liquid solution including a surfactant is applied onto a surface of hydrophilic soil (e.g., hydrophilic soil layer 104). For example, a solution including a surfactant and water at a 1:10 ratio can be sprayed or poured onto the hydrophilic soil. The surfactant can include a suitable compound that attaches to the hydrophilic soil particles (e.g., via physical adsorption or chemisorption) and forms a monolayer on respective surfaces of the hydrophilic particles with hydrophobic chains extending away from the surfaces of the hydrophilic particles (e.g., as depicted via hydrophobic soil 502 of FIG. 5). In one embodiment, the surfactant includes an organosilane based compound. In another embodiment, the surfactant includes a biodegradable compound configured to biodegrade within a defined period of time (e.g., about two weeks to sixteen weeks).

At 3104, hydrophobic coatings are formed on respective surfaces of soil particles included in an upper layer of the hydrophilic soil (e.g., the top 3.0 mm to about 30.0 mm of the hydrophilic soil) based on the applying, thereby forming a hydrophobic capillary layer (e.g., hydrophobic capillary layer 102) on a lower layer of the hydrophilic soil (e.g., wherein the lower layer includes all soil particles located under the hydrophobic capillary layer). For example, a suitable amount of the solution can be applied to the hydrophilic soil such that the solution seeps into the hydrophilic soil to a desired depth below the soil air interface. The solution coats surfaces of the soil particles it reaches via physical adsorption or chemisorption. The hydrophobic coatings (e.g., hydrophobic coatings 110) are formed upon drying of the soil particles. At 3106, a rate of evaporation of water from the lower layer of hydrophilic soil is decreased based on the forming.

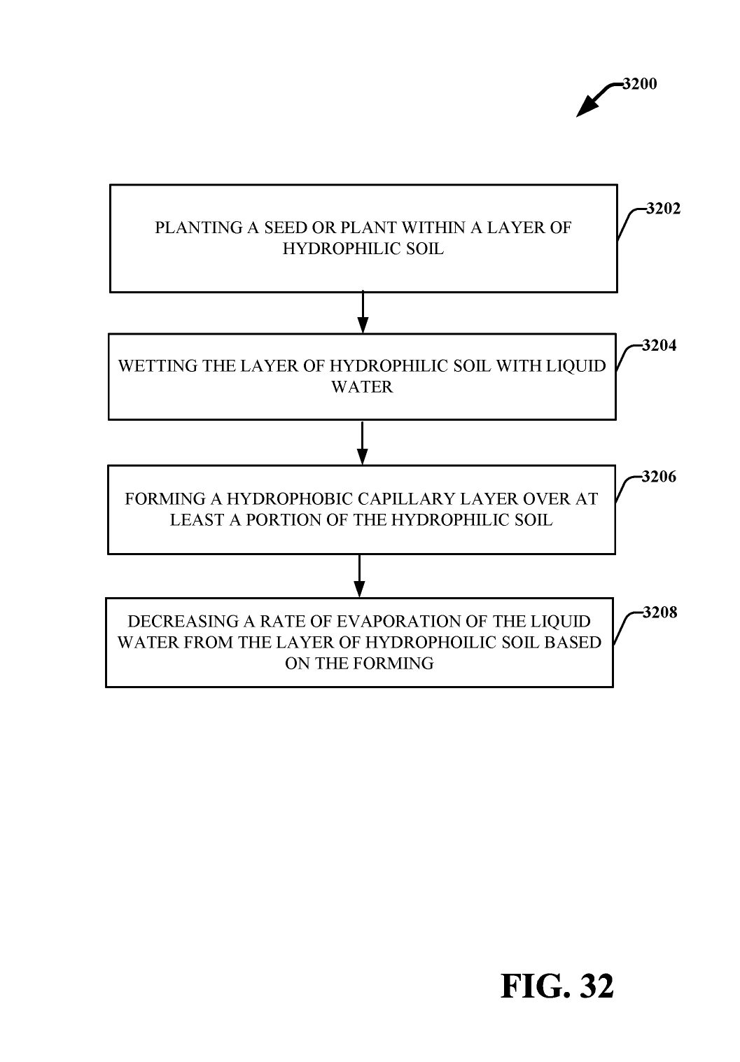

FIG. 32 presents a flow diagram of an example method 3200 for enhancing plant growth using a hydrophobic capillary layer in accordance with one or more embodiments described herein. At 3202, a seed or plant is planted within a layer of hydrophilic soil (e.g., hydrophilic soil layer 104). At 3204, the hydrophilic soil is wetted with liquid water. At 3206, a hydrophobic capillary layer (e.g., hydrophobic capillary layer 102) is formed over at least a portion of the hydrophilic soil. For example, in one embodiment, the hydrophobic capillary layer is formed over the entire surface of the hydrophilic soil. In another embodiment, an exposed area (e.g., circular area 605 and/or islands 2308-2314) of hydrophilic soil can be formed directly over the seed or plant to facilitate germination and/or watering of the seed or plant. The size and shape of the exposed area can vary. In an exemplary embodiment, the exposed area has a circular shape with a diameter between about 2 cm and about 4 cm. The hydrophobic capillary layer can be formed around the exposed area. At 3208, a rate of evaporation of the liquid water from the layer of hydrophilic soil is decreased based on the forming of the hydrophobic capillary layer. As a result, the amount of water retained in the soil is increased, thereby facilitating plant growth when little or no additional water is provided to the hydrophilic soil for a prolonged period of time.

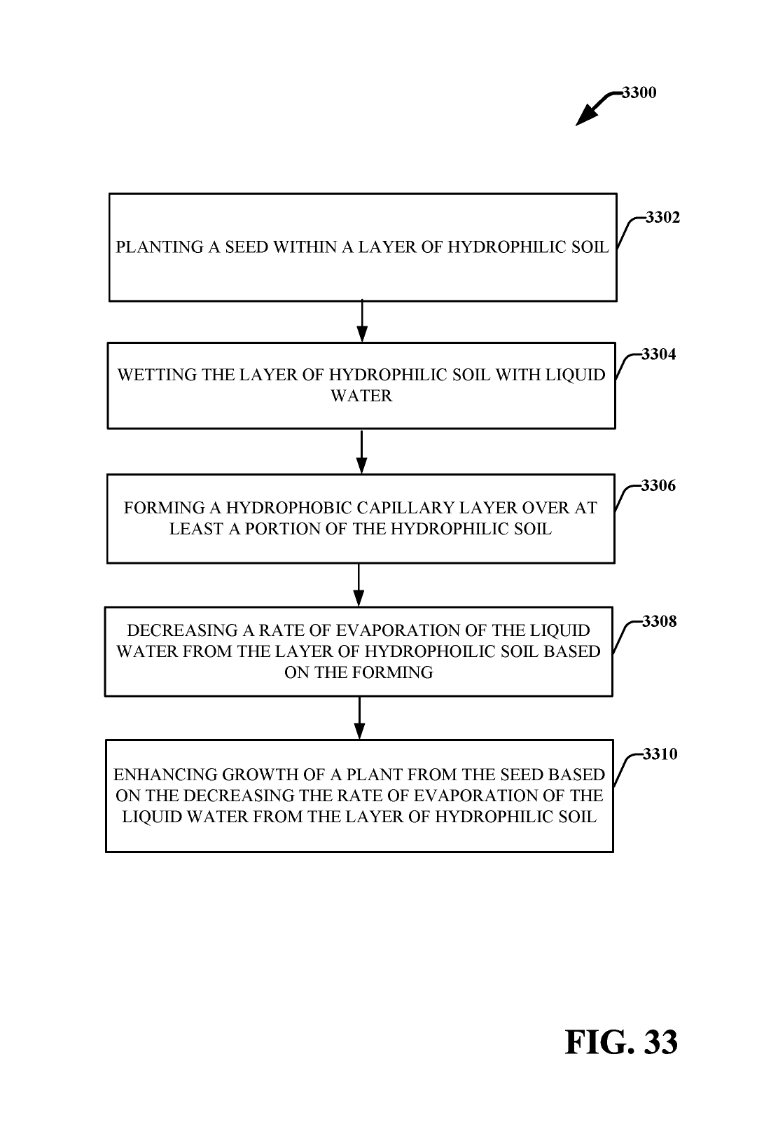

FIG. 33 presents a flow diagram of another example method 3300 for enhancing plant growth using a hydrophobic capillary layer in accordance with one or more embodiments described herein. At 3302, a seed is planted within a layer of hydrophilic soil (e.g., hydrophilic soil layer 104). At 3304, the hydrophilic soil is wetted with liquid water. At 3306, a hydrophobic capillary layer (e.g., hydrophobic capillary layer 102) is formed over at least a portion of the hydrophilic soil. At 3308, a rate of evaporation of the liquid water from the layer of hydrophilic soil is decreased based on the forming of the hydrophobic capillary layer. At 3310, growth of a plant from the seed is enhanced based on the decreasing the rate of liquid water from the layer of hydrophilic soil.

For example, as demonstrated via the third experiment described supra, growth parameters including biomass, plant height, number of leaves, length of roots, height of shoot, number of primary roots, number of secondary roots, are higher for plants planted in soil covered in full or in part with hydrophobic soil in comparison to the same growth parameters observed for plants grown in bare soil. The improvement to the growth parameters is directly attributed a decrease in the rate of evaporation of liquid water from the hydrophilic soil which is directly proportionally to the amount of hydrophilic soil covered with the hydrophobic soil. For example, the greater the amount of surface area of the hydrophilic soil covered with the hydrophobic soil, the greater the amount of reduction to the rate of water evaporation and thus the greater the enhancements to the growth parameters of the plant.

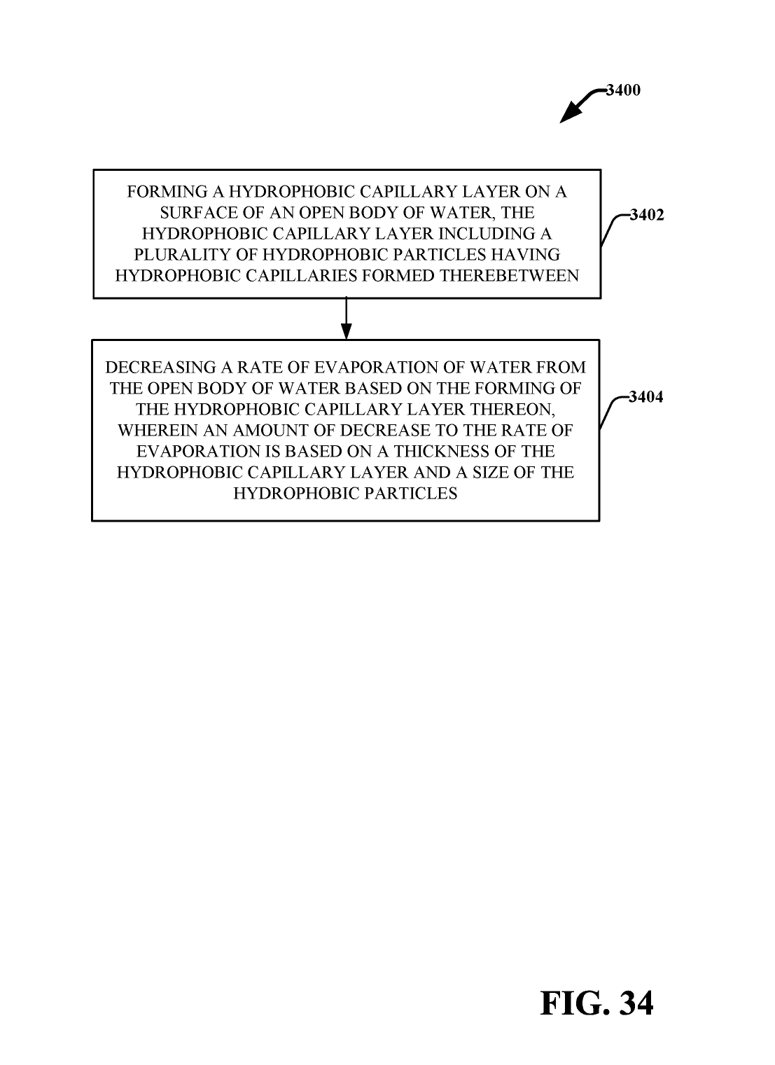

FIG. 34 presents a flow diagram of an example method 3400 for reducing the rate of water evaporation from open bodies of water using a hydrophobic capillary layer in accordance with one or more embodiments described herein. At 3402, a hydrophobic capillary layer is formed on a surface of an open body of water. The hydrophobic capillary layer includes a plurality of hydrophobic particles having hydrophobic capillaries therebetween. For example, the hydrophobic particles can include spherical particles formed via a synthetic hydrophobic material (e.g., PTFE or PMMA). In another example, the hydrophobic particles can be formed via a hydrophilic material (e.g., soil particles, cellulose based particles, etc.) and respectively coated with a hydrophobic monolayer coating. The hydrophobic particles can be configured to float on the surface of the body of water and cluster together and establish the hydrophobic capillaries via small spaces or channels that remain between the respective hydrophobic particles. In an exemplary embodiment, the hydrophobic particles have a density less than 1.0 g/mL. At 3404, a rate of evaporation of water from the open body of water is decreased based on the forming of the hydrophobic capillary layer thereon. An amount of decrease to the rate of evaporation is based on a thickness of the hydrophobic capillary layer and a size (e.g., diameter) of the hydrophobic particles. For example, the rate of evaporation of water from an open body of water having a hydrophobic capillary layer thereon is decreased as the length the capillaries is increased, and the tortuosity of the capillaries is increased. The length of the hydrophobic capillaries can be increased as the thickness of the hydrophobic layer is increased and the tortuosity of the hydrophobic capillaries can be increased as the size of the hydrophobic particles in is decreased.

What has been described above includes various example embodiments of techniques for reducing water evaporation from soil and other fresh water mediums by forming a hydrophobic capillary layer thereon. Water one of the basic component of life has undergone a drastic ecological challenge. As a result a wide scarcity of fresh water has been observed from last few decades in many parts of the world. Importing water from other areas is not always economically feasible. Hence the judicious use of water is the need of the time.

To lower the water loss from soil, a hydrophobic soil layer can be formed over the soil. As demonstrated via the first experiment described with reference to FIGS. 21-22, a hydrophobic soil layer having a 2.0 cm thickness decreases the amount of water evaporation from normal soil by about 90% after 3.5 days under ambient condition. When the usage of hydrophobic soil to decrease water evaporation is extended to enhance plant growth, as exemplified in the third experiment described with reference to FIGS. 25-27, growth parameters of plants are substantially improved. For example, growth parameters including biomass, plant height, number of leaves, length of roots, height of shoot, number of primary roots, number of secondary roots, are higher for plants planted in soil covered in full or in part with hydrophobic soil in comparison to the same growth parameters observed for plants grown in bare soil. A theoretical model based on diffusion as governing process for water transport can account for the experimental results considering tortuosity of the capillaries in porous soil.

The subject techniques provide a new approach for enhancing plant growth in many agricultural applications. Usage of the disclosed hydrophobic capillary layer to reduce the rate of water evaporation from soil can be applied to enhance the growth of a variety of crops from grains (e.g., corn, wheat, rice, soybean etc.), fruits (e.g., lemon, oranges, berries, etc.), and flowers, in natural external environments, greenhouses, and aqua farms. For example, the subject techniques enable harvesting semi-arid regions previously unsuitable for sustaining plant growth due to water scarcity. The subject techniques are also excellent for conserving water in association with crops grown undergrounds such as potatoes, groundnut, and other similar crops. The subject techniques can also be extended to for plants grown in residential buildings, public buildings and green houses.

It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In this regard, with respect to any figure or numerical range for a given characteristic, a figure or a parameter from one range may be combined with another figure or a parameter from a different range for the same characteristic to generate a numerical range. Other than in the operating examples, or where otherwise indicated, all numbers, values and/or expressions referring to quantities of ingredients, reaction conditions, etc., used in the specification and claims are to be understood as modified in all instances by the term “about.”

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A hydrophobic soil, comprising:
soil particles; and
hydrophobic monolayer coatings formed on respective surfaces of the soil particles.

2. The hydrophobic soil of claim 1, wherein the hydrophobic monolayer coatings are formed on the respective surfaces of the soil particles via physical adsorption or chemisorption of a surfactant.

3. The hydrophobic soil of claim 1, wherein the hydrophobic monolayer coatings comprise an alkyl silane compound.

4. The hydrophobic soil of claim 1, wherein the hydrophobic monolayer coatings comprise a biodegradable compound.

5. The hydrophobic soil of claim 4, wherein the biodegradable compound is configured to biodegrade after about two weeks to about twelve weeks.

6. The hydrophobic soil of claim 4, wherein the hydrophobic monolayer coatings comprise hydrophobic chains directed away from the respective surfaces of the soil particles.

7. The hydrophobic soil of claim 1, wherein the soil particles comprise at least one of: coarse sand particles, fine sand particles, silt particles, or clay particles.

8. The hydrophobic soil of claim 1, wherein the soil particles comprise about 2% to about 10% coarse sand particles, about 50% to about 90% fine sand particles, about 5% to about 20% silt particles, and about 2% to about 15% clay particles.

9. The hydrophobic soil of claim 1, wherein the soil particles comprise a liquid water holding capacity of about 30% to about 60%.

10. A method for increasing liquid water retention by hydrophilic soil, comprising:
wetting the hydrophilic soil with liquid water; and
forming a hydrophobic capillary layer over the hydrophilic soil.

11. The method of claim 10, further comprising:
decreasing a rate of evaporation of the liquid water from the hydrophilic soil based on the forming the hydrophobic capillary layer over the hydrophilic soil.

12. The method of claim 11, wherein an amount of the rate of evaporation that is decreased is based on a thickness of the hydrophobic capillary layer and a size of respective hydrophobic particles of the hydrophobic capillary layer.

13. The method of claim 10, wherein the forming comprises:
coating respective surfaces of hydrophilic soil particles with a hydrophobic coating to form hydrophobic soil particles; and
depositing the hydrophobic soil particles on the hydrophilic soil.

14. The method of claim 10, wherein the forming comprises:
applying an aqueous solution comprising a surfactant onto a surface of the hydrophilic soil; and
forming hydrophobic coatings on respective surfaces of soil particles included in an upper layer of the hydrophilic soil based on the applying and drying of the of the aqueous solution.

15. The method of claim 10, wherein the hydrophobic capillary layer comprises hydrophobic capillaries that are permeable to gases including oxygen and water vapor.

16. The method of claim 10, further comprising, after the wetting and the forming:
exposing the hydrophilic soil and the hydrophobic capillary layer to natural conditions of temperature, humidity and sunlight; and
in response to the exposing, reducing a rate of evaporation of the liquid water from the hydrophilic soil without the hydrophobic capillary layer formed thereon based on the forming the hydrophobic capillary layer over the hydrophilic soil.

17. The method of claim 16, wherein the reducing comprises reducing the rate of evaporation by about 90%.

18. The method of claim 10, wherein the hydrophobic capillary layer comprises hydrophilic particles respectively comprising hydrophobic monolayers formed on respective surfaces of hydrophilic particles.

19. The method of claim 18, wherein the hydrophobic monolayers comprise an alkyl silane compound.

20. The method of claim 18, wherein the hydrophobic monolayers comprise a biodegradable compound.

21. The method of claim 18, wherein the hydrophilic particles comprise at least one of: coarse sand particles, fine sand particles, silt particles, or clay particles.

22. The method of claim 10, wherein the hydrophobic capillary layer comprises a thickness between about 3.0 mm to about 30.0 mm.

23. An agriculture system, comprising:
a layer of hydrophilic subsoil;
a seed or plant planted within the layer of hydrophilic subsoil; and
a layer of hydrophobic topsoil formed over the layer of hydrophilic subsoil.

24. The agriculture system of claim 23, wherein a portion of the layer of hydrophilic subsoil is not covered by the layer of hydrophobic topsoil.

25. The agriculture system of claim 24, wherein the portion of the layer of hydrophilic subsoil that is not covered by the layer of hydrophobic topsoil comprises the seed or the plant.

26. The agriculture system of claim 23, wherein a thickness of the layer of hydrophobic topsoil varies.

27. The agriculture system of claim 23, wherein a thickness of the layer of hydrophobic topsoil varies.

28. The agriculture system of claim 23, wherein an increase to a thickness of the layer of hydrophobic topsoil and a decrease to a size of soil particles included in the hydrophobic topsoil facilitates a decrease in water evaporation from the hydrophilic soil layer.

29. The agriculture system of claim 23, further comprising:
an irrigation device formed within the layer of hydrophobic topsoil or a region of the layer of hydrophilic subsoil not covered with the layer of hydrophobic topsoil, wherein the irrigation device reaches the layer of hydrophilic subsoil and allows for passage of liquid water to the layer of hydrophilic subsoil.

30. The agriculture system of claim 29, wherein the irrigation device comprises a funnel.

31. The agriculture system of claim 24, wherein the layer of hydrophobic topsoil comprises hydrophilic particles respectively comprising hydrophobic monolayers formed on respective surfaces of the hydrophilic particles.

32. The agriculture system of claim 31, wherein the hydrophobic monolayers comprise an alkyl silane compound.

33. The agriculture system of claim 31, wherein the hydrophobic monolayers comprise a biodegradable compound.

34. The agriculture system of claim 31, wherein the hydrophilic particles comprise at least one of: coarse sand particles, fine sand particles, silt particles, or clay particles.

35. The agriculture system of claim 23, wherein the layer of hydrophobic topsoil comprises a thickness between about 3.0 mm to about 30.0 mm.

36. The agriculture system of claim 23, wherein the layer of hydrophobic topsoil comprises hydrophobic capillaries that are permeable to gases including oxygen and water vapor.

37. An agriculture system, comprising:
a terrain having a non-planar surface topology characterized by regions of high ground separated by regions of low ground having a lower altitude than the regions of high ground, wherein the regions of high ground and the regions of low ground are joined by sloping regions, wherein the terrain comprises:
a layer of hydrophilic subsoil, and
a layer of hydrophobic topsoil formed over a region of the layer of hydrophilic subsoil located at or near the regions of high ground;
seeds or plants planted within the regions of the layer of hydrophilic subsoil located at or near the regions of high ground; and
one or more irrigation devices located at or near the regions of low ground and configured to provide liquid water to the regions of the layer of hydrophilic subsoil located under the regions of high ground.

38. The agriculture system of claim 37, wherein the one or more irrigation devices comprise a funnel comprising a first opening at an outer surface area of the regions of low ground and a second opening at an inner surface area of the regions of low ground and reaching the layer of hydrophilic subsoil.

39. The agriculture system of claim 38, wherein the regions of high ground comprise four regions of high ground respectively arranged in a rectangular configuration, and wherein the region of the regions of low ground is located at or near a center point of the rectangular configuration.

40. The agriculture system of claim 37, wherein the layer of hydrophobic topsoil comprises hydrophilic soil particles respectively coated with a hydrophobic monolayer coating, and hydrophobic capillaries formed between the hydrophilic soil particles, wherein the hydrophobic capillaries are permeable to gases including oxygen and water vapor.

41. A method for reducing water evaporation from an open body of water, comprising:
forming a hydrophobic capillary layer on a surface of the open body of water, the hydrophobic capillary layer comprising a plurality of hydrophobic capillaries.

42. The method of claim 41, wherein the forming the hydrophobic capillary layer comprises depositing a layer of particles respectively coated with a hydrophobic coating on the surface of the open body of water, wherein the plurality of hydrophobic capillaries are formed via spaces between the particles.

43. The method of claim 41, wherein the forming the hydrophobic capillary layer comprises depositing a layer of hydrophobic particles on the surface of the open body of water, wherein the hydrophobic particles have a density less than 1.0 g/mL, and wherein the plurality of hydrophobic capillaries are formed via spaces between the hydrophobic particles.

44. The method of claim 41, wherein the forming the hydrophobic capillary layer comprises depositing a layer of hydrophobic particles comprising least one of poly-tetrafluoroethylene, poly-methyl methacrylate, or another hydrophobic particle material having a diameter less than about 1.0 mm, on the surface of the open body of water, wherein the plurality of hydrophobic capillaries are formed via spaces between the hydrophobic particles.

45. The method of claim 41, wherein the forming the hydrophobic capillary layer comprises depositing a layer of hydrophobic particles on the surface of the open body of water, wherein the plurality of hydrophobic capillaries are formed via spaces between the hydrophobic particles, the method further comprising:
reducing a rate of the water evaporation from the open body of water based on the forming, wherein an amount of reduction to the rate of the water evaporation is based on a thickness of the hydrophobic capillary layer and size of the hydrophobic particles.

46. The method of claim 41, wherein the forming the hydrophobic capillary layer comprises applying a sheet of material comprising the plurality of hydrophobic capillaries on the surface of the open body of water, wherein the sheet is configured to float on the surface of the open body of water and the sheet is permeable to water vapor, oxygen, and other gases.
